(19) United States
(12) Patent Application Publication
(10) Pub. No.: US 2026/0071025 A1
(43) Pub. Date: Mar. 12, 2026

(54) SPIRO LACTIDE BASED COPOLYMERS

(71) Applicant: THE REGENTS OF THE UNIVERSITY OF MICHIGAN, Ann Arbor, MI (US)

(72) Inventors: Peter X. Ma, Ann Arbor, MI (US); Tongqing Zhou, Ann Arbor, MI (US)

(21) Appl. No.: 19/317,981

(22) Filed: Sep. 3, 2025

Related U.S. Application Data
(60) Provisional application No. 63/692,447, filed on Sep. 9, 2024.

(51) Int. Cl. C08G 63/91; C08G 63/08; C08G 63/78

(52) U.S. Cl. CPC C08G 63/91; C08G 63/78; C08G 63/08

(57) ABSTRACT

An example of a block or graft copolymer includes a random copolymer including a first monomer:

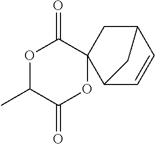

and a second monomer; and i) a homopolymer including a third monomer, wherein the third monomer is any monomer other than the first monomer, or ii) a second random copolymer other than the random copolymer. The random copolymer can also be part of a star-shaped copolymer. Any of the copolymers may be incorporated into a composition or used as a coating on a medical device.

### CROSS-REFERENCE TO RELATED APPLICATIONS

This application claims the benefit of U.S. Provisional Application Ser. No. 63/692,447, filed Sep. 9, 2024, the content of which is incorporated by reference herein in its entirety.

### STATEMENT REGARDING FEDERALLY SPONSORED RESEARCH OR DEVELOPMENT

This invention was made with government support under AR075770 and DE027662 awarded by the National Institutes of Health and under W81XWH-20-1-0572 awarded by the Defense Health Agency, Medical Research and Development Branch. The government has certain rights in the invention.

### BACKGROUND

Tissue engineering and regenerative medicine are important research areas that aim to achieve regenerative alternatives to harvested tissues for transplantation. Synthesized biomaterials have been shown to be useful for engineering tissue regeneration and repair, at least in part because they recapitulate the physical characteristics of the biological tissue environment. For example, synthetic biomaterials have been generated with physical architecture that mimics the extracellular matrix (ECM). These biomaterials have been used as drug carriers and/or tissue engineering scaffolds. However, many of the available synthetic biomaterials have inadequate properties or are not able to deliver the biochemical cues of the natural ECM. For example, many synthetic biomaterials lack reactive sites for the presentation of a desirable biochemical stimulus.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A depicts the chemical synthesis of an example random copolymer, poly(spiro[6-methyl-1,4-dioxane-2,5-dione-3,2′-bicyclo[2.2.1]hept[5]ene]-co-L-lactide) (PSLA), and an example of a block copolymer including the random copolymer (PSLA) and a homopolymer poly(L-lactide) (PLLA).

FIG. 1B schematically depicts the structure of the random copolymer based on the formula, (SL)ₓ(M2)_{y}, and the real structure of the random copolymer where the respective units, SL and M2, are of random lengths and are randomly interspersed throughout the copolymer chain length;

FIG. 1C schematically depicts the structure of an example of the block copolymer based on the formula, (B1)ₓ(B2)_{y}, and the real structure of the block copolymer where the respective units, SL and M2, in the random copolymer portion are of random lengths and are randomly interspersed throughout the copolymer chain length;

FIG. 1D schematically depicts the structure of an example graft copolymer where the random copolymer forms the main chain;

FIG. 1E schematically depicts the structure of an example graft copolymer where the random copolymer forms the side chains;

FIG. 1F depicts the chemical synthesis of a combined block and graft copolymer;

FIG. 1G schematically depicts an example of the structure of a combination block and graft copolymer where the block copolymer forms the main chain.

FIG. 1H schematically depicts a star-shaped copolymer including the random copolymer disclosed herein.

FIG. 2A is a schematic illustration of one example of a polymeric structure, in the form of a microsphere, for use in the composition disclosed herein.

FIG. 2B is a schematic illustration of another example of a polymeric structure, in the form of a nanofibrous film, for use in the composition disclosed herein.

FIG. 2C is a schematic illustration of yet another example of a polymeric structure, in the form of a scaffold, for use in the composition disclosed herein.

FIG. 2D is a schematic illustration of yet another example of a polymeric structure, in the form of a single-layer tubular scaffold, for use in the composition disclosed herein.

FIG. 2E is a schematic and top view of yet another example of a polymeric structure, in the form of a multi-layer tubular scaffold, for use in the composition disclosed herein.

FIG. 2F is a schematic and perspective view of the multi-layer tubular scaffold, where a portion of the inner layer is depicted without the outer layer, and where the inset illustrates the nanofibrous structure of the inner layer.

FIG. 2G is a schematic illustration of a medical device disclosed herein.

FIG. 3A through FIG. 3C are proton nuclear magnetic resonance (H NMR) spectra of relevant compounds in the synthesis of PSLA-b-PLLA (A through C data was generated with purified polymers). Number 1 in the notation “PSLA #1-b-PLLA #2” indicates the feeding ratio of the reactants in PSLA. Number 2 in the same notation is the feeding ratio of PSLA to La. As an example, PSLA4060-b-PLLA16 means that the Spiro-la to La weight ratio is 40:60 when PSLA is synthesized, and that the PSLA to La weight ratio is 1:16 when the PSLA-b-PLLA is synthesized.

FIG. 3D through FIG. 3F are Fourier Transform Infrared Spectroscopy (FTIR) spectra of relevant compounds in the synthesis of PSLA-b-PLLA (where D and E data was generated with purified polymers, and F data was generated by covalently conjugating P24 peptide with 20 nmol/mg feeding on nanofibrous PSLA4060-b-PLLA16 films).

FIG. 4 is a graph depicting the relationship of the feed ratio of Spiro-La and L-lactide (X axis, mol %) and the monomer ratio in the resulting random copolymer PSLA (Y axis, mol %).

FIG. 5A is a bar graph depicting the relationship between the triazabicyclodecene (TBD) concentration (X axis, as a mol % of monomers used during the synthesis of PSLA) and the molecular weight of the resulting PSLA (Y axis, kg/mol).

FIG. 5B is a bar graph depicting the relationship between L-lactide feeding ratio used during the formation of PSLA-b-PLLA (X axis, as a wt % of PSLA block) and the molecular weight of the resulting PLLA block (Y axis, kg/mol), where PSLA4060 with 258 kg/mol was used as the first block.

FIG. 6A and FIG. 6B illustrate the effect of PSLA-b-PLLA composition on morphology of nanofibrous films, where FIG. 6A includes scanning electron microscope images (SEM images) of the morphology changes across different groups (Scalebar=10 μm), and FIG. 6B is a graph illustrating the summary of the relationship between the composition and the surface morphologies.

FIG. 7A through FIG. 7C illustrate the effect of PSLA-b-PLLA composition on nanofibrous film stress-strain properties (tensile tests), including modulus, strain at break, ultimate tensile strength, and toughness (N=3), where FIG. 7A is a stress (MPa, Y axis)-strain (%, X axis) curve depicting the effect of the PLLA block length (where the L-lactide weight ratio to PSLA block ranged from 2:1 to 16:1), and PSLA2080 (268k) was used as the PSLA block), FIG. 7B is a stress (MPa, Y axis)-strain (%, X axis) curve depicting the effect of the PSLA block composition (where the Spiro-la to L-lactide feeding ratio was fixed at 1:16 and the TBD concentration was fixed at 0.1 mol % of monomer), and FIG. 7C is a stress (MPa, Y axis)-strain (%, X axis) curve depicting the effect of the PSLA block length (where the Spiro-la to L-lactide feeding ratio was fixed at 1:16 and the PSLA block composition was fixed at 20:80).

FIG. 8A includes schematic and SEM images of PSLA-b-PLLA and PLLA nanofibrous films before and after partial hydrolysis, where the arrows mark the parts with faster hydrolysis speed (scale bar=100 nm and PSLA-b-PLLA composition: PSLA4060(258k)-b-PLLA16).

FIG. 8B is a graph of the X-ray diffraction (XRD) spectra of PSLA-b-PLLA and PLLA nanofibrous films.

FIG. 8C includes schematic and SEM images of PSLA-b-PLLA and PLLA nanofibrous films after tensile tests, where the schematics demonstrated the hypothesized elongation mechanism inside a nanofiber (scale bar=100 nm, and PSLA-b-PLLA composition: PSLA4060(258k)-b-PLLA16).

FIG. 9 is a bar graph depicting the melting enthalpy (Y axis, J/g) of PSLA4060 (Mn 258k) with different second (PLLA) block lengths calculated from Differential Scanning Calorimetry (DSC). The X axis depicts the L-lactide feed for the PLLA block as a wt % of the PSLA block, where ‘0’ stands for PSLA block only without the PLLA block. 5 mg to 10 mg of nanofibrous film samples were used for DSC testing.

FIG. 10A and FIG. 10B are bar graphs illustrating the effect of the PSLA-b-PLLA composition on peptide conjugation density (N=3), where FIG. 10A depicts the peptide conjugated (Y axis, nmol/mg scaffold) versus the PSLA block L-lactide feed (X axis, as a wt % of the PSLA block), and FIG. 10B depicts the peptide conjugated (Y axis, nmol/mg scaffold) versus the PSLA block composition (X axis, copolymer type). Disc-shaped 3D porous scaffolds with 1 mm in thickness and 5 mm in diameter were used for conjugation density evaluation.

FIG. 11 includes SEM images of PLLA and PLSA-b-PLLA, illustrating nanofiber shapes before and after tensile tests were performed (PSLA-b-PLLA film composition: PSLA4060(258k)-b-PLLA16, scale bar=1 μm).

FIG. 12A and FIG. 12B depict the degradation of PSLA-b-PLLA 3D scaffolds, where FIG. 12A includes SEM images of porous structure and nanofibrous morphologies after degradation in phosphate buffered saline (PBS) at 37° C. (scale bar=10 μm), and FIG. 12B depicts the weight loss (Y axis, remaining wt %) after degradation in PBS at 37° C. (X axis, weeks) (N=3) (PSLA-b-PLLA composition: PSLA4060(258k)-b-PLLA16).

FIG. 13 is a bar graph depicting contact angle measurements (Y axis, degrees) before and after peptide conjugation (N=3) (Film composition: PSLA4060(258k)-b-PLLA16. Peptide conjugated: 0.1 mg P24 peptide).

FIG. 14A through FIG. 14C depict peptide conjugation properties, where FIG. 14A includes graphs of peptide conjugation amounts (Y axis, nmol/mg scaffold) at different peptide feeds (X axis, nmol/mg scaffold) (P24 peptide, N=3); FIG. 14B are fluorescence images (reproduced in black and white) depicting the visualization of P24 binding (7 nmol/mg feeding) on PSLA4060-b-PLLA16 3D scaffold surface by conjugation with FITC labeled peptides (scale bar=100 μm); and FIG. 14C is a bar graph depicting the contact angle (Y axis, degrees) for nanofibrous films before and after P24 conjugation (15 nmol/mg P24 peptide fed on each film, N=3, p<0.05).

FIG. 15A and FIG. 15B depict, respectively, micro-CT images (reproduced in black and white) and a bar graph of the bone volume (Y axis, mm³) analysis of 4-week and 8-week mouse critical-sized calvarial defect repair with P24-conjugated cell-free PSLA-b-PLLA 3D scaffolds (P24) and control PLLA scaffolds (CTL) (scaffold dimensions: 5 mm in diameter, 1 mm in thickness, with pore size of 250-425 μm). Each group had 6 male mice aged 3-6 months. The label “P24” refers to the PSLA-b-PLLA 3D scaffolds, each with 100 μg, 0.1 mg/ml P24 peptide/PBS solution for conjugation. The label “CTL” refers to the PSLA-b-PLLA 3D scaffolds with no peptide conjugation (PBS was used instead of P24/PBS solution to treat scaffolds).

FIG. 16 depicts H&E staining and Masson's trichrome staining images (reproduced in black and white) of 4-week and 8-week mouse critical-sized calvarial defect repair with P24-conjugated cell-free PSLA-b-PLLA 3D scaffolds and control PLLA scaffolds (scale bar: 0.5 mm for low magnification, 0.2 mm for high magnification, and cartilage-like structures are marked with circles).

FIG. 17A, FIG. 17B, and FIG. 17C depict immunofluorescence (IF) staining (reproduced in black and white) for, respectively, A) CD31, B) Runx2, and C) VWF in cell-free PSLA-b-PLLA 3D scaffolds with or without peptide conjugation and harvested at 4 weeks or 8 weeks after implantation in mouse critical-sized calvarial defects. CD31 was stained green (AlexaFluor 488), Runx2 was stained red (AlexaFluor 594), VWF was stained red (AlexaFluor 594), and cell nuclei were stained blue (DAPI). Bright field images were superimposed on the IF staining images, and are produced in row 3 of each of FIG. 17A, FIG. 17B, and FIG. 17C. Row 4 in each of FIG. 17A, FIG. 17B, and FIG. 17C is a higher magnification of the images of row 3 in the boxed areas) (scale bar=100 μm).

FIG. 18A through FIG. 18C depict the NMR and Gel Permeation Chromatography (GPC) characterization of block copolymers, where FIG. 18A is for PCL-b-PSLA2080, FIG. 18B is for PLLA-b-PSLA2080-b-PLLA, and FIG. 18C is for PCL-b-PSLA2080-b-PLLA.

FIG. 19 is a graph depicting a stress (MPa, Y axis)-strain (%, X axis) curve of an ABC triblock copolymer, PCL-b-PSLA2080-b-PLLA, compared to pure PLLA.

FIG. 20 is a SEM image of the nanofibrous surface morphology of the ABC triblock copolymer, PCL-b-PSLA2080-b-PLLA, (scale bar=10 μm).

FIG. 21A through FIG. 21D are SEM images of electrospun tubular scaffolds formed using different PCL-b-PSLA-b-PLLA triblock copolymers.

FIG. 22 is a SEM image of an electrospun tubular scaffold formed using a PSLA-b-PLLA diblock copolymer.

FIG. 23A through FIG. 23D are SEM images of TIPS films formed using different PCL-b-PSLA-b-PLLA triblock copolymers.

FIG. 24A and FIG. 24B are SEM images of electrospun tubular scaffolds formed using a grafted copolymer and a combination block and graft copolymer.

FIG. 25A and FIG. 25B are SEM images of TIPS films formed using a grafted copolymer and a combination block and graft copolymer.

FIG. 26 is a SEM image of an electrospun tubular scaffold formed using a star-shaped copolymer.

FIG. 27 is a SEM image of a TIPS film formed using a star-shaped copolymer.

FIG. 28 depicts Safranin-O/fast green staining (reproduced in black and white) of regenerated fibrocartilage in rat TMJs) with hollow microspheres made of PSLA-b-PLLA diblock copolymer.

FIG. 29A is an SEM image depicting a multi-layer tubular scaffold from a top view.

FIG. 29B are SEM images (at low and high magnifications) of the outer layer and the inner layer of the multi-layer tubular scaffold of FIG. 29A.

### DETAILED DESCRIPTION

Block, graft, and star-shaped copolymers are disclosed herein that include a random copolymer of a first monomer:

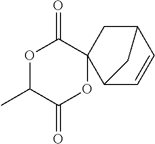

(spiro[6-methyl-1,4-dioxane-2,5-dione-3,2′-bicyclo[2.2.1]hept[5]ene] (Spiro-la)) and a second monomer. The block copolymer includes the random copolymer as one block and includes another homopolymer or copolymer as another block. The graft copolymer includes the random copolymer as the main chain or the side chain. The star-shaped copolymer includes the random copolymer in at least some of the arms that extend from its core. Several variations of each of these copolymers will be described in further detail.

The block, graft, and star-shaped copolymers can be used to form a variety of structures that can be used in a variety of biomedical applications. The random copolymer, alone or in combination with the other homopolymer or copolymer, renders the block, graft, and star-shaped copolymers particularly suitable for tissue engineering applications because the mechanical properties, degradation rates, and/or conjugated bioactive molecule type and densities can be tuned for a particular application by altering the random copolymer and/or the other homopolymer or copolymer.

Throughout this disclosure, the terms first, second, etc. are not meant to imply a specific orientation or order, but rather are used to distinguish one component from another. For example, the (co)polymers of the first and second blocks of a block polymer may be arranged in any order, depending, in part, upon the synthesis used to generate the block copolymer.

Some of the copolymers disclosed herein include the random copolymer including the first monomer:

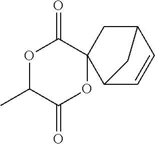

(spiro[6-methyl-1,4-dioxane-2,5-dione-3,2′-bicyclo[2.2.1]hept[5]ene] (Spiro-la)) and the second monomer; and either: a homopolymer of a third monomer, wherein the third monomer is any monomer other than the first monomer, or a second random copolymer other than the random copolymer. These copolymers may be block or graft copolymers.

Other examples of the copolymers are star-shaped copolymers. The star-shaped copolymer includes a core having from 2 to 128 polymerization initiating functional groups; and arms extending from at least some of the polymerization initiating functional groups, the arms including a random copolymer of a first monomer:

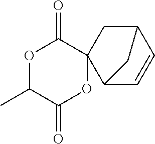

and a second monomer that is different from the first monomer.

As mentioned, each of the block, graft, and star-shaped copolymers disclosed herein includes the random copolymer 10 as one component. As mentioned, the random copolymer 10 includes Spiro-la as the first monomer and a different second monomer.

The first monomer:

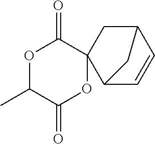

of the random copolymer 10 includes a plurality of a functional group (e.g., double bonded carbons) that is capable of attaching to a biologically functional molecule.

The second monomer may be any other monomer, and may be selected to impart suitable properties to the random copolymer 10. In some instances, the second monomer is selected to impart enhanced mechanical properties (e.g., tensile strength) to the resulting random copolymer 10, and thus to any structure or coating formed therefrom. As examples, the second monomer may be an ester monomer, such as L-lactide or D-lactide to increase elongation and modulus of the product, glycolide to increase degradation speed, or caprolactone to decrease degradation speed and increase elongation.

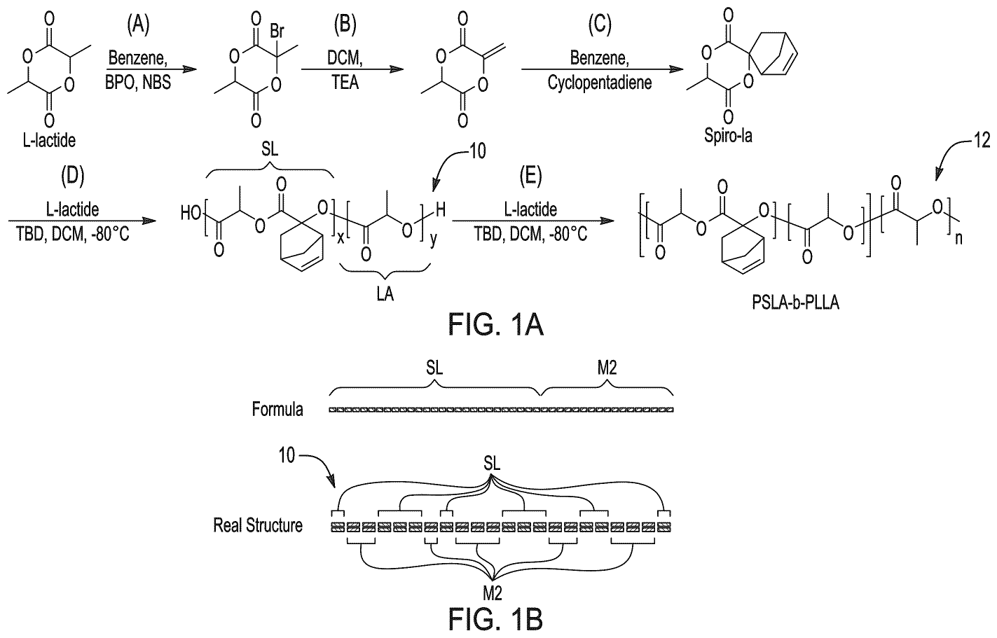

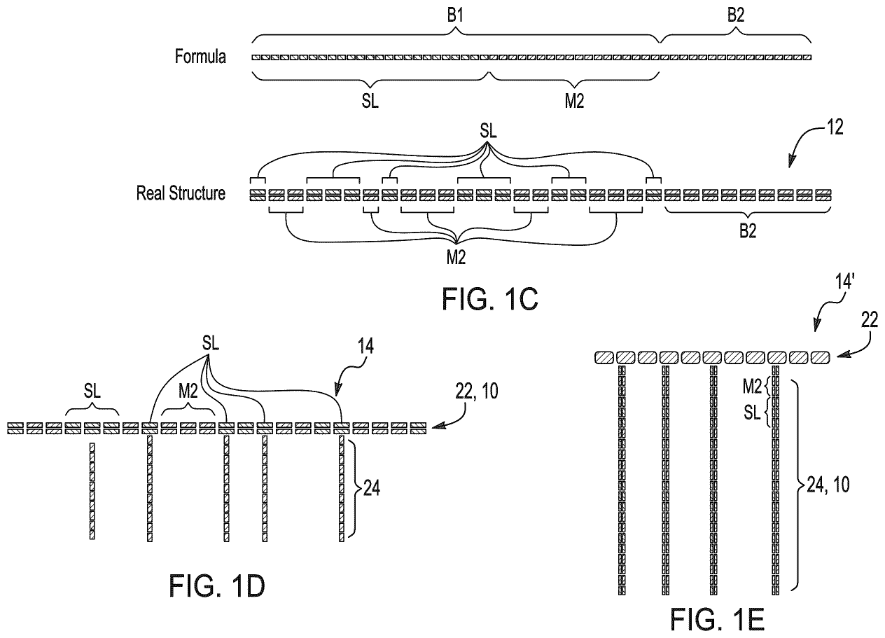

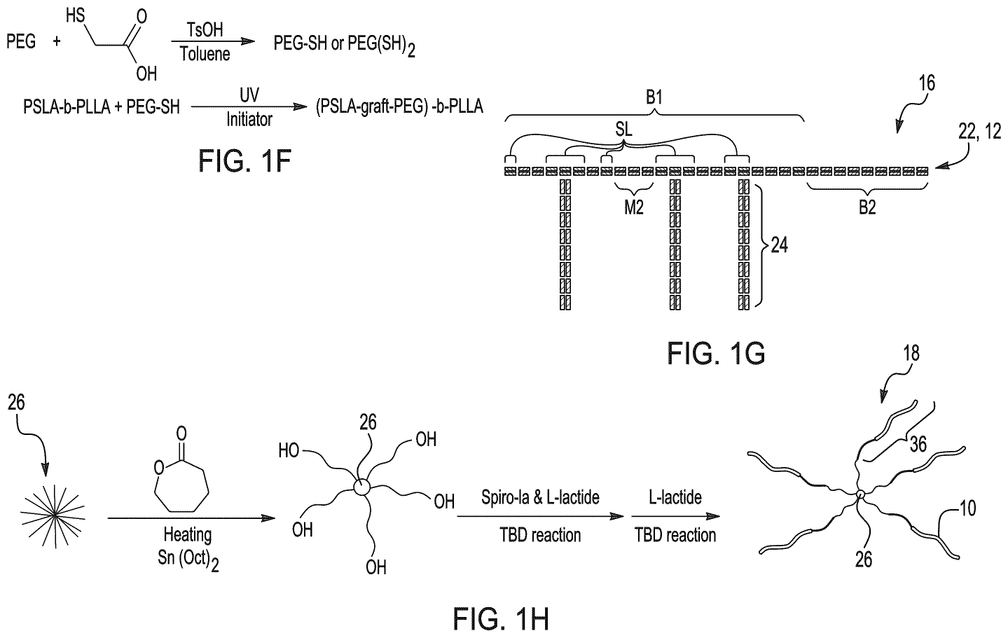

FIG. 1A depicts, in part, a reaction scheme illustrating i) the synthesis of Spiro-la, a modified L-lactide based monomer, where (A) is a substitution reaction, (B) is an elimination reaction, and (C) is a Diels-Alder reaction; and ii) the copolymerization of Spiro-la and the second monomer (which, in this example, is L-lactide), where (D) is the synthesis of the random copolymer 10 (which, in this example is PSLA).

In the example shown in FIG. 1A, L-lactide, N-Bromosuccinimide (NBS), and benzene are mixed and heated. The mixture may include the NBS at 110 mol % of the L-lactide and benzene at a 5:1 volume/weight (v/w) ratio with the L-lactide. Heating may be performed at a temperature ranging from about 60° C. to about 100° C. (e.g., ˜80° C.). Benzoyl peroxide (BPO), at an amount ranging from about 0.05 mol % to about 5.0 mol % of the L-lactide, e.g., 2 mol % of the L-lactide, is dissolved in benzene at a 5:1 v/w ratio, and this solution is introduced into the mixture. The combined mixture/solution is allowed to react for about 8 hours to about 72 hours, e.g., 48 hours at the heated temperature, and then the solid La—Br product can be recovered. La—Br is shown between (A) and (B) in FIG. 1A.

The La—Br is dissolved in dimethyl sulfoxide (DCM) or another suitable solvent at a concentration of 20 w/v %. The solution is cooled and triethylamine (TEA) is added in an amount ranging from about 80 mol % to about 500 mol % of the La—Br, e.g., about 110 mol % of the La—Br. Cooling may be performed for about 1 hour, followed by allowing the reaction mixture to reach temperature. This reaction forms (6S)-3-Methyl-6-methyl-1,4-dioxane-2,5-dione, as shown between (B) and (C) in FIG. 1A. During this elimination reaction, a double bond is formed and the bromine and methyl substituents are eliminated.

(6S)-3-Methyl-6-methyl-1,4-dioxane-2,5-dione and cyclopentadiene are dissolved in a suitable solvent, such as benzene, at a concentration ranging from 1% to 30%, e.g., 20%. The cyclopentadiene may be included in an amount ranging from about 100 mol % to about 500 mol % of the (6S)-3-Methyl-6-methyl-1,4-dioxane-2,5-dione, e.g., 200 mol % of the (6S)-3-Methyl-6-methyl-1,4-dioxane-2,5-dione, and the benzene is at a 10:1 v/w ratio with the (6S)-3-Methyl-6-methyl-1,4-dioxane-2,5-dione. The solution may be heated to a temperature ranging from about 60° C. to about 100° C. about 80° C. until reflux occurs, and then refluxing may be continued for a time period ranging from about 6 to about 72 hours, e.g., 12 hours. Excess solvent can be removed, and the resulting product is the Spiro-la.

When forming the random copolymer 10, different weight ratios of Spiro-la and the second monomer may be used. As examples, the Spiro-la:second monomer weight ratio may range from 99:1 to 1:99. In specific examples, the Spiro-la:second monomer weight ratio may range from about 1:99 to about 99:1, or from about 5:95 to about 95:5, or from about 20:80 to about 60:40. An increased amount of the Spiro-la can increase the peptide conjugation capability of the random copolymer 10. An increased amount of the second monomer, such as L-lactide, can alter the mechanical properties of the random copolymer 10, and thus of the resulting block, graft, or star-shaped copolymer.

The desired weight ratio of Spiro-la and the second monomer (e.g., L-lactide) are added together and dissolved or dispersed in a suitable solvent, such as 10 w/v % in DCM. The solution is cooled down to a temperature ranging from about −20° C. to about −200° C., e.g., −80° C., for a time period ranging from about 15 minutes to about 2 hours, e.g., 1 hour. A solution of triazabicyclodecene (TBD) in DCM, having a concentration ranging from about 2 mg/ml to about 16 mg/ml, is prepared and added to the cooled solution. The solutions are mixed and then maintained at the cold temperature for a time period ranging from about 10 minutes to about 240 hours, e.g., 48 hours. This reaction forms the random copolymer 10, as shown between (D) and (E) in FIG. 1A. The specific example of the random copolymer 10 in FIG. 1A is PSLA, where the block formed from Spiro-la is identified as “SL” and the block formed from L-lactide is identified as “La.”

FIG. 1B schematically depicts the random copolymer 10 based on the formula, (SL)ₓ(M2)_{y}, where M2 is the block formed from the second monomer, and x and y are dependent upon the Spiro-la:second monomer weight ratio used during the synthesis. FIG. 1B also schematically depicts the random copolymer 10 based on its real structure, where the respective units, SL and M2, are of random lengths and are randomly interspersed through the copolymer chain length.

The random copolymer 10 is one component of the block copolymer(s), the graft copolymer(s), and the star-shaped copolymer(s) disclosed herein. The block copolymer 12 is described in reference to FIG. 1C, the graft copolymers 14, 14′ are described in reference to FIG. 1D and FIG. 1E, a combination block and graft copolymer 16 is described in reference to FIG. 1G, and the star-shaped copolymer is described in reference to FIG. 1H.

The block copolymer 12 includes a first block B1 of the random copolymer 10 including the first monomer:

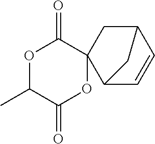

and the second monomer; and a second block B2 including i) a homopolymer of a third monomer, wherein the third monomer is any monomer other than the first monomer or ii) a second random copolymer that is any random copolymer other than the random copolymer 10 of the first block B1.

Any example of the random copolymer 10 may be used in the block copolymer 12. In one example of the block copolymer 12, the weight ratio of the first monomer to the second monomer ranges in the random copolymer 10, and thus in the first block B1, ranges from 1:99 to 99:1.

When the second block B2 is a homopolymer, any homopolymer or third monomer (used to form the homopolymer of the second block B2) may be used. In one example, the homopolymer of the second block B2 is a non-degradable polymer selected from the group consisting of polyethylene terephthalate (PET), polystyrene, a silicone polymer, a polyurethane, polyetherether ketone (PEEK), a polyamide, polycarbonate, polyethylene glycol (PEG), and polyvinyl alcohol (PVA). These materials may be particularly suitable for medical device applications. In another example, the homopolymer of the second block B2 is a biodegradable polymer selected from the group consisting of poly(L-lactide) (PLLA), polyglycolic acid (PGA), poly(lactide-co-glycolide) (PLGA), poly(D-lactide) (PDLA), poly(D, L-lactide) (PDLLA), polyanhydrides, poly(ortho ethers), poly(ε-caprolactone) (PCL), poly(glycerol sebacate), poly(hydroxy butyrate) (PHB), poly(propylene fumarate) (PPF), polyphosphoesters (PPE), polyphosphazenes, polycarbonates (PC), polyurethane, poly(trimethylene carbonate) (PTMC), collagen, gelatin, elastin, alginate, chitin, chitosan, and pectin. The corresponding monomers of any of these homopolymers may be used as the third monomer to form the second block B2. The monomeric unit of the homopolymer may be selected to impart a particular morphology and/or particular mechanical properties to the block copolymer 12. As examples, the third monomer may be an ester monomer, such as L-lactide, D-lactide, glycolide, caprolactone, carbonate, or glycerol sebacate; an ether monomer, such as ethylene glycol, tetrahydrofuran, or propylene glycol; or an ester urethane monomer.

When the second block B2 is another random copolymer, any random copolymer that is different in monomer type, ratio and/or degree of polymerization from the random copolymer 10 may be used. The monomers of the second random copolymer may be selected to impart particular mechanical properties to the block copolymer 12. As examples, the second random copolymer may be poly(lactide-co-glycolide) (PLGA) for tunable degradation speed, or PSLA with a different monomer ratio than the first block to increase conjugation density. The other random copolymer can provide the block copolymer 12 with an amorphous and softer segment (than when the homopolymer segment is formed of the crystalline or semicrystalline homopolymer that enables nanofiber formation) and the block copolymer 12 can be shaped into a suitable structure (e.g., microsphere, film, or scaffold).

In some examples, the second block B2 is formed of a crystalline or semi-crystalline homopolymer or copolymer. The crystalline or semi-crystalline homopolymer or copolymer portion of the block copolymer 12 is selected to introduce mechanical strength to the copolymer 12 and any structure formed therefrom. The crystalline or semi-crystalline homopolymer or copolymer portion can also impart a nanofibrous architecture to the structure formed by the block copolymer 12. A nanofibrous architecture mimics the extracellular matrix (ECM) in both fiber diameter and geometry, which enhances bone regeneration. In this example, the walls of the structure formed with the block copolymer 12 are made up of interconnected nanofibers, where each nanofiber has a diameter ranging from about 1 nm to about 1000 nm. In an example, the second monomer (of the random copolymer 10) is L-lactide; and the second block B2 is crystalline or semi-crystalline, and is selected from the group consisting of poly(L-lactide), poly(D-lactide), poly(ε-caprolactone), poly(glycerol sebacate), poly(glycolic acid), poly(3-hydroxybutyrate), poly(3-hydroxyvalerate), poly(ethylene terephthalate), mixtures thereof, and random copolymers thereof.

In other examples, the second block B2 may be selected so that the block copolymer 12 forms a structure that has a solid architecture. In this example, the walls of the structure formed with the block copolymer 12 are solid with some pores formed therein. Examples of non-nanofibrous forming homopolymers that may be used for the second block B2 include poly(lactide-co-glycolide) or poly(D, L-lactide). The second block B2 can have a weight ratio that ranges from 10% of the first block to 50 times the first block, e.g., between 10 times and 20 times the first block, to balance mechanical performance and functional group density.

In one example method to form the block copolymer 12, the random copolymer 10 is mixed with either the monomer that will form the homopolymer, or with monomers that will form the second random copolymer, and polymerization is initiated. In another example method to form the block copolymer 12, the random copolymer 10 is mixed with an already formed second random copolymer, and the two are covalently bonded. The monomer(s) or second random copolymer is present at a weight that ranges from 5% to 5000% with respect to the weight of the random copolymer 10. In other words, the weight ratio of the monomer(s) or the second random copolymer to the random copolymer 10 ranges from 1:20 to 50:1. The solid mixture is then cooled down via exposure to a temperature ranging from about −20° C. to about −200° C., e.g., about −80° C. for a time period ranging from about 10 minutes to about 2 hours, e.g., 1 hour. The solution of triazabicyclodecene (TBD) in DCM, having a concentration ranging from about 0.1 mg/mL to about 50 mg/ml, e.g., 1 mg/ml, is prepared and added to the cooled mixture. The components are mixed and then maintained at the cold temperature for a time period ranging from about 10 minutes to about 240 hours, e.g., 48 hours. This reaction forms the block copolymer 12, as shown after (E) in FIG. 1A. The specific example of the block copolymer 12 shown in FIG. 1A is PSLA-b-PLLA.

FIG. 1C schematically depicts the block copolymer 12 based on the formula, (B1)ₓ(B2)_{y}, B1 and B2 are the respective blocks and where x and y are dependent upon the random copolymer 10: third monomer/homopolymer/second random copolymer weight ratio used during the synthesis. FIG. 1C also schematically depicts the block copolymer 12 based on its real structure, where the respective units, SL and M2, of the random copolymer 10 of the first block B1 are of random lengths and are randomly interspersed through the copolymer chain length, and the homopolymer of the second block B2 is positioned at an end of the first block B1. In other examples of the block copolymer 12, the homopolymer of the second block B2 will be replaced with the second random copolymer. The respective units of this second random copolymer will also be of random lengths and randomly interspersed through the chain length of the second random copolymer.

In another example method to form the block copolymer 12, one block (similar to second block B2 of FIG. 1C) is formed with a terminal hydroxyl group, and then the random copolymer 10 is polymerized from the terminal hydroxyl group. As examples, the polymer with the terminal hydroxyl group may be a polyether, such as poly(ethylene glycol), poly(tetrahydrofuran) (PTHF), or poly(propylene glycol) (PPG); or a polyester, such as poly(caprolactone), poly(L-lactide), poly(glycolide), poly(lactic-co-glycolic acid), polycarbonate, or poly(glycerol sebacate); or a poly(ester)urethane, and their copolymers. In this example, a mixture of the polymer with the terminal hydroxyl group and the PSM2 generating monomers (i.e., Spiro-la and the second monomer at any ratio between <100:>0 to >0:<100) is generated. The weight ratio of the polymer to the PSM2 generating monomers ranges from about 20:1 to 1:20. The mixed components are dissolved in a suitable solvent (e.g., DCM) so that the total concentration ranges from about 1% to about 20%. The solution is cooled down via exposure to a temperature ranging from about −20° C. to about −200° C., e.g., about −80° C., for a time period ranging from about 10 minutes to about 2 hours, e.g., 1 hour. The solution of triazabicyclodecene (TBD) in DCM is prepared and added to the cooled mixture at 0.05 mol % to about 1 mol % of the total sum of the Spiro-la and second monomers present. The components are mixed and then maintained at the cold temperature for about 10 minutes to about 240 hours, e.g., 48 hours. In this example, the blocks B1, B2 will be dependent upon the weight ratio of the polymer with the terminal hydroxyl group and the Spiro-la and second monomers used during the synthesis.

One specific example of the block copolymer 12 disclosed herein is poly(spiro[6-methyl-1,4-dioxane-2,5-dione-3,2′-bicyclo[2.2.1]hept[5]ene]-co-L-lactide)-block-poly(L-lactide) (i.e., PSLA-b-PLLA) with the PSLA to PLLA weight ratio ranging from 1:2 to 1:16. A weight ratio with a higher amount of PSLA may be used, although the architecture may be less nanofibrous as the PSLA content increases.

While the block copolymer 12 is shown in FIG. 1A and FIG. 1C as a di-block copolymer, any other number of blocks may be added. In an example, the block copolymer further includes a third block including a second homopolymer of a fourth monomer, wherein the fourth monomer is any monomer other than the first monomer. This example is formed via further polymerization of the block copolymer 12, and would form an “ABC” type of tri-block copolymer. In this tri-block copolymer, each of the three blocks is different. One example of the ABC type of tri-block copolymer is PCL-b-PSLA-b-PLLA, where poly(caprolactone) and poly(L-lactide) make up the blocks respectively positioned at opposed ends of the random copolymer 10. For this example, the second monomer is L-lactide and the homopolymers are poly(caprolactone) and poly(L-lactide). In another example of the ABC type of tri-block copolymer, the second monomer is L-lactide, the second block is poly(caprolactone); and the third block comprises a polylactide selected from the group consisting of poly(L-lactide), poly(D-lactide), and stereocomplexes thereof.

In one example method to generate the ABC type copolymer, the AB portion may be formed using the method described immediately above that starts with the polymer with the terminal hydroxyl group (A of the ABC triblock copolymer) and forms the random copolymer 10 (B of the ABC triblock copolymer) thereon. The third block (C of the ABC triblock copolymer) may be formed by mixing the AB portion and the fourth monomer. The weight ratio of the AB portion to the fourth monomer ranges from about 20:1 to 1:20. The mixed components are dissolved in a suitable solvent (e.g., DCM) so that the total concentration ranges from about 1% to about 20%. The solution is cooled down via exposure to a temperature ranging from about −20° C. to about −200° C., e.g., −80° C., for a time period ranging from about 10 minutes to about 2 hours, e.g., 1 hour. The solution of triazabicyclodecene (TBD) in DCM is prepared and added to the cooled mixture at 0.05 mol % to about 1 mol % of the fourth monomer. The components are mixed and then maintained at the cold temperature for a time period ranging from about 10 minutes to 240 hours, e.g., 48 hours.

Alternatively, the tri-block copolymer may be of the “ABA” type. In one example, the random copolymer 10 is “B” and the homopolymer of the second block B2 is “A.” To form this tri-block copolymer, an initiator may be used during the formation of the random copolymer 10. An example of a suitable initiator is ethylene glycol. The mole ratio of the initiator to the total monomers (Spiro-la+second monomer present in any suitable ratio disclosed herein) ranges from about 1:10 to about 1:10000. The initiator is dissolved with the monomers before the TBD solution is added. This will generate reactive groups at each terminal end of the random copolymer 10 so that the homopolymer (e.g., PLLA) can form as separate blocks sandwiching the random copolymer 10.

It is to be understood that the mechanical properties, such as modulus, strength, elongation, and/or toughness, of any example of the block copolymers, e.g., 12., disclosed herein may be altered by changing the polymer and/or random copolymer 10 in one or more of the blocks, e.g., B1, B2. By changing the polymer composition, the morphology and tensile strength of the structure formed with the block copolymer 12 may be altered. Additionally, the surface conjugation ability can also be adjusted by changing the percentage and composition of the block containing the random copolymer 10.

As mentioned, the random copolymer 10 may be incorporated into a graft copolymer 14, 14′, examples of which are respectively shown in FIG. 1D and FIG. 1E. Generally, the graft copolymer 14, 14′ includes a main chain 22; and at least one side chain 24 covalently attached to the main chain 22, wherein at least one of the main chain 22 or the side chain 24 includes the random copolymer 10 of the first monomer

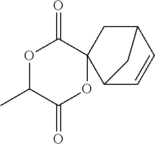

and the second monomer that is different from the first monomer.

In one example of the graft copolymer, the main chain is the random copolymer 10 or a block copolymer 12 including the random copolymer 10 as one block; and the side chain 24 is a homopolymer. The example including the block copolymer 12 as the main chain 22 is shown and described in reference to FIG. 1G.

One example of the graft copolymer 14 is shown in FIG. 1D and includes the random copolymer 10 as the main chain 22; and at least one side chain 24 attached to the main chain 22, the at least one side chain 24 including a homopolymer of a third monomer, wherein the third monomer is any monomer other than the first monomer.

In this example, the third monomer (used to form the side chains 24) may be any monomer that can react with the double bond in the random copolymer 10. This reaction may be a thiol-ene click reaction, a radical/cationic/anionic grafting reaction, or a ring-opening reaction. Grafting on the main chain 22 can be done by polymerization with a plurality of the third monomer or by covalently linking the homopolymer of the third monomer to the double bond in the random copolymer 10. One example method includes poly(ethylene glycol) with thiol terminal groups (PEG-SH) as the homopolymer for the side chain 24, which is grafted to PSLA of the main chain 22.

In another example of the graft copolymer 14′, the main chain 24 is a homopolymer, and the side chain 24 is the random copolymer 10 or a block copolymer 12 including the random copolymer 10 as one block.

One example of this graft copolymer 14′ is shown in FIG. 1E. This example includes the homopolymer as the main chain 22 and the random copolymer 10 as the side chains 24. In this example, the main chain 22 may be any polymer with a functional group, which can initialize the polymerization of copolymer 10. The grafting reaction may be a thiol-ene click reaction, a radical/cationic/anionic reaction, or a ring-opening reaction.

Yet another example of the graft copolymer is similar to the graft copolymer 14′ shown in FIG. 1E, but includes the block polymer 12 instead of the random copolymer 10 as the side chain 24.

Still another example of the graft copolymer is similar to the graft copolymer 14′ shown in FIG. 1E, but includes another random copolymer instead of the homopolymer as the main chain 22. As such, this graft copolymer includes a main chain 22 of a first random copolymer; and at least one side chain 24 attached to the main chain 22, the at least one side chain 24 including a second random copolymer (copolymer 10) of a first monomer:

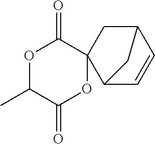

and a second monomer, wherein the first and second random copolymers are different.

In this example, the random copolymer of the main chain 22 may include at least one functional group that can i) initiate the polymerization of monomers, including Spiro-la, such as a hydroxyl group, or ii) covalently link to copolymers containing Spiro-la, such as a thiol group. The grafting reaction on the main chain 22 may be a thiol-ene click reaction, a radical/cationic/anionic grafting reaction, or a ring-opening reaction.

With any of the graft copolymers 14, 14′, the graft density can be changed by varying the ratio of functional groups that undergo the reaction. Such modifications allow for systematic tuning of the graft copolymer's physical, chemical and mechanical properties. In particular, the grafted side chains 22 can influence the crystallinity, solubility, degradation speed, melting point, and glass transition temperature of the base random copolymer 10 (i.e., the PSLA copolymer). Any additional functional groups on the grafted side chain 22 can introduce additional covalent modifications. This, in turn, affects the performance of products fabricated from the copolymers, such as the thermally induced phase separation (TIPS) films, the TIPS 3D scaffolds, and the electrospun tubular scaffolds described herein. For example, the introduction of rubbery graft chains may enhance flexibility and compliance of those products, the introduction of hydrophilic chains can improve the degradation speed and wettability of those products, and the introduction of additional functional groups, such as double bonds, can be used for crosslinking the graft copolymer to form structures such as gels or thermosets.

Still another example copolymer disclosed herein is a combination block and graft copolymer 16. This example is shown in FIG. 1G. This example includes the block copolymer 12 as the main chain 22; and at least one side chain 24 attached to the random copolymer 10 of main chain 22. In other words, the block copolymer 12 further includes a homopolymer chain (e.g., side chain 24) grafted to the first block B1.

In one example, the main chain 22 is the block copolymer 12 including the random copolymer 10 as one block; and the side chain 24 (the previously mentioned homopolymer chain) is selected from the group consisting of polyhydroxyalkanoates, polylactides (e.g., poly(L-lactide), poly(D, L-lactide), etc.), poly(glycolic acid), poly(ε-caprolactone), poly(glycerol sebacate), poly(3-hydroxybutyrate), poly(3-hydroxyvalerate), poly(propylene fumarate), polyphosphoesters, polyphosphazenes, polycarbonates, polyethylene glycol, polyvinyl alcohol, polyurethanes, polyanhydrides, poly(ortho ethers), poly(trimethylene carbonate), collagen, gelatin, elastin, alginate, chitin, chitosan, and pectin. In another example, the homopolymer chain (side chain 24) is a non-degradable polymer selected from the group consisting of polyethylene terephthalate, polystyrene, a silicone polymer, a polyurethane, polyetherether ketone, a polyamide, and polycarbonate. While several examples have been provided, it is to be understood that the monomer used to form the homopolymer (of the side chain 24) may be any monomer that can react with the double bond in the random copolymer 10 of the block copolymer 12.

This reaction may be a thiol-ene click reaction, a radical/cationic/anionic grafting reaction, or a ring-opening reaction. Grafting on the main chain 22 can be done by polymerization with a plurality of the monomers or by covalently linking the homopolymer of the monomer to the double bond in the random copolymer 10.

One example method for forming the combination block and graft copolymer 16 is shown in FIG. 1F, where poly(ethylene glycol) (PEG) is the homopolymer that is grafted to PSLA (the random copolymer 10) of the PSLA-PLLA block copolymer 12. In this example, a thiol-ene reaction is conducted in a 1 wt % to a 20 wt % solvent solution, e.g., a 10 wt % solvent solution, with from about 0.01 wt % to about 2 wt %, e.g., 1 wt %, of a catalyst, and a ratio of the main chain:the graft chain ranging from 1:0.1 to 1:10, e.g., 1:2. The solution is exposed to ultraviolet (UV) light for about 30 minutes. This exposure is followed by solvent evaporation and washing. The resulting combination block-graft copolymer 16 can be freeze-dried.

Still another example copolymer disclosed herein is a star-shaped copolymer 18. This example is shown in FIG. 1H. The star-shaped copolymer 18 includes a multi-functional core molecule 26 (i.e., a core having from 2 to 128 polymerization initiating functional groups), and arms 36 extending from at least some of the polymerization initiating functional groups, the arms 36 including the random copolymer 10.

The polymerization initiating functional groups may be hydroxyl groups, including hydroxyl groups on a multi-functional core, and on polymers such as poly((hydroxyethyl) methacrylate). Examples of suitable multi-functional core molecules 26 include pentaerythritol, N,N,N′,N′-tetra(2,3-dihydroxpropyl)ethane-1,2-diamine, poly(amidoamine) dendrimers modified to have surface hydroxyl groups, or a hyperbranched aliphatic polyester. In one example, the core 26 is a poly(amidoamine) dendrimer.

If the multi-functional core molecule 26 initially includes hydroxyl groups, the random copolymer 10 may be polymerized at one or more of the hydroxyl groups. In this example, additional blocks may also be incorporated before or after the random copolymer 10. Thus, in one example, the arms 36 include a block copolymer 12, wherein the block copolymer 12 includes, in any order, the random copolymer 10 as one block and a homopolymer or another random copolymer as another block.

If the multi-functional core molecule 26 does not initially include hydroxyl groups, the hydroxyl groups may be added, and then the random copolymer 10 may be polymerized at one or more of the hydroxyl groups. In this example, additional blocks may also be incorporated before or after the random copolymer 10.

In an example, the hydroxyl group containing core molecule 26 is mixed with a mixture of Spiro-la and any example of the second monomer described herein in a suitable solvent. The total concentration of molecule 26 and monomer(s) may range from about 1% to about 20%. The molecule 26 and monomer mixture can be combined so that the ratio of functional groups to monomers ranges from 20:1 to 1:20. When the molecule 26 is a star-shaped polymer, the ratio of functional groups and monomer(s) should be calculated based on the amount of monomer per functional group, where 1:20 functional group to monomer in a X-armed core means 1:20X core to monomer mole ratio.

Once the molecule 26 and Spiro-la and the second monomers are dissolved, the cold polymerization process using the TBD solution described herein may be performed. The reaction conditions described for the block copolymer 12 may be used.

As mentioned, before or after the random copolymer 10 is formed at two or more of the polymerization initiating functional groups of the molecule 26, additional block(s) may also be incorporated. If these additional block(s) are to undergo subsequent reactions, the block(s) should have terminal hydroxyl groups. Example of polymers that are suitable for the additional block(s) include polyethers, such as PEG (poly(ethylene glycol)), PTHF (poly(tetrahydrofuran)), and PPG (poly(propylene glycol)); polyesters, such as PCL (polycaprolactone), PLA (poly(L-lactide)), PLGA (poly(lactic-co-glycolic acid)), PGA (poly(glycolic acid)), PC (polycarbonate), PGS (poly(glycerol sebacate)); poly(ester)urethane; and copolymers of any of these polymers. The additional block(s) may be polymerized in situ with the core molecule 26 (with or without the PSM2 block attached thereto) from suitable monomers, or the additional block may be formed by covalently attaching a pre-formed polymer to the core molecule 26 (with or without the PSM2 block attached thereto). When the additional block(s) is/are polymerized in situ, the cold polymerization process using the TBD solution described herein may be performed. The reaction conditions described for the block copolymer 12 may be used.

FIG. 1H schematically illustrates one example method for forming the star-shaped polymer. In this example, the core molecule 26 with multiple non-hydroxyl functional groups, such as a poly(amidoamine) dendrimer, is used to initiate the ring-opening polymerization of caprolactone or another suitable molecule to incorporate hydroxyl groups at the terminal ends of the core molecule 26. Then, the hydroxyl-group modified core molecule is mixed with both Spiro-la and La (which are present at any ratio between <100:>0 to >0:<100). The cold polymerization process using the TBD solution described herein is performed to generate the random copolymer 10 (e.g., PSLA) block. Then, the core molecule with the PSLA block is mixed with the monomers for generating the next block. In the example shown in FIG. 1H, that additional block is PLLA, and thus L-lactide is used. The additional monomers may be used in excess of the core molecule with the PSLA block. In one example, the amount of L-lactic ranges from about 1 time to about 20 times, e.g., 16 times, the total weight of the core molecule with the PSLA block. The cold polymerization process using the TBD solution described herein is performed to generate the PLLA block.

Example methods for forming the block, graft, and star-shaped copolymers 12, 14, 14′, 16′, 18 have been described herein. Generally, each method includes incorporating the random copolymer 10 including the first monomer;

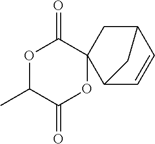

and the second monomer into the block copolymer 12, 16 or the graft copolymer 14, 14′, 16 or the star-shaped copolymer 18.

Prior to incorporating the random copolymer 10 into the block copolymer 12, the random copolymer 10 is formed via cold polymerization between the first monomer and the second monomer; and incorporating the random copolymer 10 into the block copolymer 12 involves polymerizing a third monomer in the presence of the random copolymer. This method may further include grafting at least one additional side chain, e.g., 24, to the random copolymer 10.

Incorporating the random copolymer 10 into the graft copolymer 14, 14′ involves one of: i) covalently linking a main chain 22 and a side chain 24, wherein the main chain 22 includes the random copolymer 10 and the side chain 24 and the side chain 24 is selected from the group consisting of a polymer containing one or more thiol groups per structural unit, a synthetic polymer with a terminal thiol group, a natural compound with thiol functionality or a thiol-modified derivative, a peptide including at least one cysteine residue, a polypeptide including at least one cysteine residue, a thiol-containing compound, an inorganic compound with a thiol group, and an organosilane compound with a thiol group; or ii) performing cold polymerization of the first and second monomers in the presence of a hydroxyl-group-containing polymer, thereby growing side chains of the random copolymer from activation sites of the hydroxyl-group-containing polymer; or iii) initiating polymerization of a third monomer at a double bond of the random copolymer 10. The thiol-containing compound may be any non-polymer thiol-containing organic compound.

Incorporating the random copolymer 10 into the star-shaped copolymer 18 involves copolymerizing the first monomer and the second monomer in the presence of a star-shaped initiator or a star-shaped polymer.

Any of the block, graft, or star-shaped copolymers 12, 14, 14′, 16, 18 disclosed herein may be used to form compositions that are particularly useful for tissue, and in particular bone and cartilage, development and regeneration. The compositions include a structure selected from the group consisting of a scaffold, a film, and a microsphere, wherein the structure is at least partially composed of the block, graft, or star-shaped copolymer 12, 14, 14′, 16, 18. The structure alone can be used. Alternatively, the composition includes the structure and a biologically functional molecule attached to the random copolymer 10 of the block, graft, or star-shaped copolymer 12, 14, 14′, 16, 18.

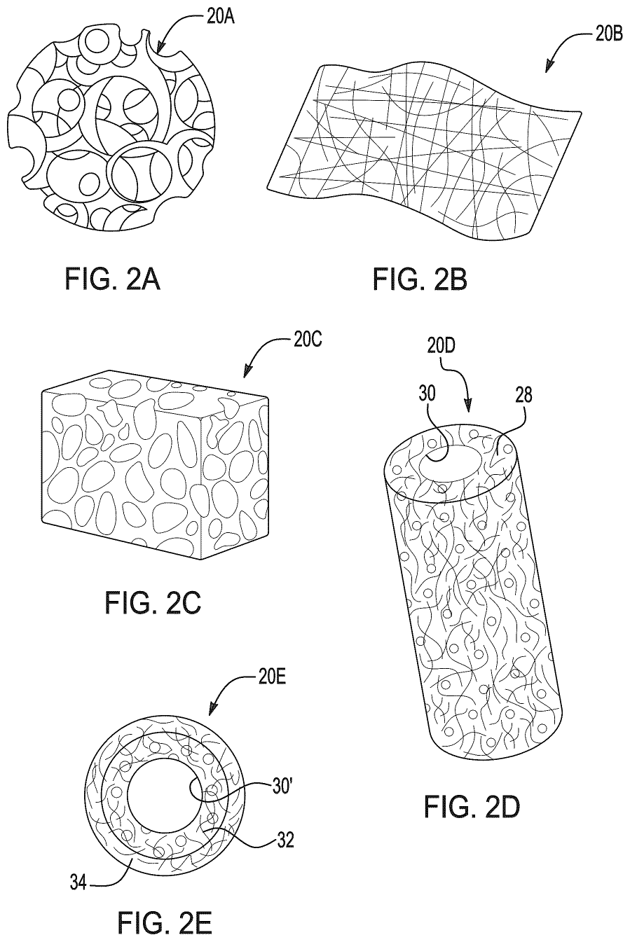

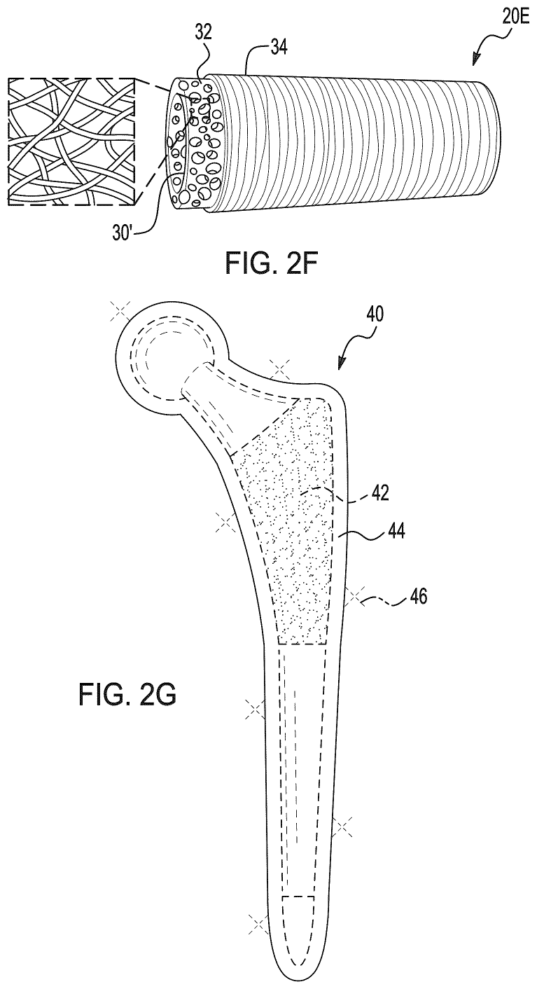

In some instances, the copolymer 12, 14, 14′, 16, 18 of the composition is manufactured into a microsphere 20A (see FIG. 2A), a film 20B (see FIG. 2B), or a scaffold 20C (see FIG. 2C), or another implantable medical device. The scaffolds may take on any shape or configuration that is suitable for a particular application. As examples, the scaffolds may be a single-layered tubular scaffold 20D (see FIG. 2D) or a multi-layered tubular scaffold 20E (see FIG. 2E and FIG. 2F), in which each layer may have different pore structures, fiber orientations, and/or chemical compositions.

The microsphere 20A may be a nanofibrous hollow microsphere (NF-HMS), a nanofibrous microsphere (NF-MS), or a nanofibrous spongy microsphere (NF-SMS).

A nanofibrous hollow microsphere (NF-HMS) is characterized as a hollow structure having a single hollow core surrounded by a nanofibrous shell, and one or more openings formed in the nanofibrous shell. The entire hollow structure has a diameter ranging from about m to about 1000 m. The diameter of the opening in the center of the nanofibrous shell ranges from about 5 m to about 500 m. The nanofibrous shell 20A includes nanofibers and spaces (less than 2 m in diameter) that are present between the nanofibers.

A nanofibrous microsphere (NF-MS) is characterized as a structure composed of nanofibers. The NF-MS includes spaces (less than 2 m in diameter) between the nanofibers, but does not include any larger openings. The entire structure has a diameter ranging from about 5 m to about 1000 am.

Spongy microspheres also include a nanofibrous architecture and have a diameter D ranging from about 5 m to about 1000 am. These microspheres are also spongy (i.e., nanofibrous spongy microspheres or NF-SMS). By “spongy,” it is meant that the NF-SMS have a sponge-like architecture throughout the entirety of the microsphere. The sponge-like architecture includes interconnected porous walls and micro-scale pores formed among the interconnected porous walls. The spongy microsphere is schematically depicted in FIG. 2A, although the fibrous architecture of the microsphere walls is not shown for clarity.

FIG. 2B depicts an example of the film 20B, which is made up of a plurality of nanofibers. The film 20B is a thin layer having dimensions suitable for the application in which it is to be used. The thickness of the film may range from about 1 nm to about 1 mm.

FIG. 2C depicts an example of the scaffold 20C. The scaffold 20C is formed of a plurality of nanofibers aggregated together and pores defined between at least some of the nanofibers. In FIG. 2C, the fibrous architecture of the scaffold walls is not shown for clarity. The nanofibrous scaffold is characterized as a multi-level porous structure with regular spherical macro-scale pores (ranging from about 10 μm to about 1000 μm in diameter depending on their applications), micro-scale interpore openings (i.e., openings that connect one macro-scale pore to another macro-scale pore) of about 100 m, and spaces (less than 2 m across) between the nanofibers. While the pores of the scaffold 20C are on the macro-scale or smaller, the scaffold itself has larger dimensions. For example, the thickness of the scaffold 20C may be 0.2 mm or more, and the length and/or width of the scaffold 20C may be 3 mm or more.

FIG. 2D, FIG. 2E, and FIG. 2F depict two different tubular scaffolds 20D, 20E. The example shown in FIG. 2D is a single-layered tubular scaffold 20D formed using electrospinning, and the example shown in FIG. 2E and FIG. 2F is a multi-layered tubular scaffold 20E formed using a two-step process. Tubular scaffolds are particularly suitable for regenerating tubular tissues, including blood vessels, intestines, colon, trachea, esophagus, nerve conduits, and other similar structures.

The single-layered tubular scaffold 20D includes a layer 28 and a hollow portion 30 that is defined by the layer 28. The morphology of the layer 28 will depend upon the composition of the copolymer that is used to form the layer 28. As examples, the layers 28 formed with PCL-b-PSLA-PLLA triblock copolymers or PSLA-b-PLLA diblock copolymers include porous fibers. The pores of each of these types of fibers is on the sub-micron scale. The fibers formed with the tri-block copolymer are rough, while the fibers formed with the diblock copolymer are smooth. As additional examples, the layers 28 formed with PSLA-g-PEG graft copolymers or (PSLA-g-PEG)-b-PLLA features a combination of thinner nanofibers and thicker fibers, with wider fiber size dispersity compared to those made from PCL-b-PSLA-PLLA triblock copolymers or PSLA-b-PLLA diblock copolymers. As still further examples, the layers 28 formed with ss-PCL-b-PSLA-b-PLLA star-shaped copolymers include both fibers and porous sheets.

As will be described in detail below, the diameter of the hollow portion 30 will depend upon the core rod that is used to make the tubular scaffold 20D.

The multi-layered tubular scaffold 20E includes an inner layer 32 having a nanofibrous and porous structure; a hollow portion 30′ defined by the inner layer 32; and an outer layer 34 positioned on the inner layer 32, the outer layer 34 including electrospun fibers; wherein at least one of the inner layer 32 and the outer layer 34 is formed of the block copolymer 12, the graft copolymer 14, 14′, the combined block and graft copolymer 16, or the star-shaped copolymer 18.

A top view of the multi-layered tubular scaffold 20E is shown in FIG. 2E. A perspective view of the multi-layered tubular scaffold 20E, with a portion of the outer later 34 removed, is shown in FIG. 2F. As shown in FIG. 2F, the inner layer 32 is more porous, which can accommodate cells, and the fibers are largely randomly oriented (as shown in the inset). Also as shown in FIG. 2F, the outer layer 34 is denser and the fibers are more oriented in a single direction. In this particular example, the inner layer 32 includes walls with a random nanofibrous structure and interconnected pores, which is particularly suitable for adding in anticoagulation. Also in this particular example, the outer layer 34 includes walls with an oriented nanofibrous structure, which enables it to have high burst pressure, high compliance, and be suturable. The example in FIG. 2F is suitable for blood vessel regeneration. For other applications, structural variations may be made to the multi-layered tubular scaffold 20E.

The pores of the inner layer 32 can be of a controlled size ranging from 10 microns to 1000 microns, typically 63 micron to 125 microns, depending on the porogen used to form this layer 32. The morphology of the fibers of the inner layer 32 is nanofibrous, and thus the copolymer 12, 14, 14′, 16, 18 should include a nanofiber-forming homopolymer.

As noted above, the morphology of the outer layer 34 will depend upon the copolymer 12, 14, 14′, 16, 18 that is used for electrospinning.

Depending upon the biologically functional molecule that is included, the compositions provide biocompatibility, biodegradability, regenerative activity (such as osteogenic or vasculogenic activity), adequate mechanical properties to maintain the three-dimensional shape for tissue regeneration (such as bone or blood vessel regeneration), and a porous structure to enhance micro-vascularization.

The biologically functional molecule may be a protein, a peptide, a lipid, a polysaccharide, a sugar, a nucleic acid (e.g., DNA or RNA), an ion, or the like. As specific examples, the biologically functional molecule is a growth factor derived peptide (such as a peptide derived from a bone morphogenetic protein (BMP)), a fibroblast growth factor, a vascular endothelial growth factor, a transforming growth factor, an insulin-like growth factor, a cell adhesion peptide (such as RGD, an integrin binding peptide, or a discoidin domain receptor (DDR2) binding peptide), a hormone or hormone-derived peptide (such as parathyroid hormone derived peptides), and the like. As other examples, the biologically functional molecule may be physically functional, such as a molecule that responds to light, temperature, pressure, sound, electricity, magnetic wave, air, gas, humidity, solvent, or combinations thereof.

In some of the examples disclosed herein, the biologically functional molecule is attached to the copolymer 12, 14, 14′, 16, 18. The attachment may be via bonding (e.g., covalent, ionic, or hydrogen) or via Van der Walls interactions. In one example, the peptide (P24) is attached covalently to the copolymer 12, 14, 14′, 16, 18. In another example, the peptide is attached via physical absorption to the surface of the copolymer 12, 14, 14′, 16, 18.

The composition may also be manufactured into a medical device. As examples, the composition may be used to fill bone defects, join two or more vertebrae (spinal section), to form artificial hips and joints, and bone fixation devices for long bones, ribs and craniofacial bones, such as screws, bolts, plates, rods and the like.

In some examples, the composition is used as a coating on at least a portion of a medical device. An example medical device 40 is shown in FIG. 2F. The medical device 30 includes a core structure 42, a coating 44 positioned on at least a portion of the core structure 42, wherein the coating 44 is composed of the copolymer 12, 14, 14′, 16′, 18 disclosed herein, and, in some instances, a biologically functional molecule 46 attached to the random copolymer 10 of the copolymer 12, 14, 14′, 16′, 18.

The core structure 42 is selected from the group consisting of a metal, a ceramic, an inorganic material, and a polymeric material. As examples, the core structure 42 may be a titanium hip replacement, joint replacement, spine replacement or fixture, or a dental implant. In the example shown in FIG. 2F, the medical device 40 includes a metal hip replacement as the core structure 42.

One example method to form the composition (that includes the biologically functional molecule) includes attaching a biologically functional molecule to the random copolymer 10 of the block or graft or star-shaped copolymer 12, 14, 14′, 16, 18. In some examples, the method includes forming the random copolymer 10; forming the copolymer 12, 14, 14′, 16, 18 including the random copolymer 10 and a homopolymer or another random copolymer; and attaching the biologically functional molecule to a surface of the copolymer 12, 14, 14′, 16, 18. Attachment may be via covalent attachment or physical absorption. Other attachment mechanisms, such as ionic bonding or hydrogen bonding may also be used.

In one example, the copolymer 12, 14, 14′, 16, 18 is in the form of microsphere 20A; and forming the microsphere 20A involves an emulsion technique. With emulsion techniques, the sequence in which a polymer solution and a non-solvent are combined significantly influences the internal structure of the resulting microspheres 20A.

With emulsion techniques, one or more PSM2-containing copolymers 12, 14, 14′, 16, 18 are dissolved in an organic solvent selected from the group consisting of chloroform, dichloromethane (DCM), tetrahydrofuran (THF), hexafluoroisopropanol (HFIP), pyridine, formic acid, and mixtures thereof. The concentration of this solution ranges from about 0 wt % to about 50 wt %. Moderate heat may be applied to dissolve the copolymer 12, 14, 14′, 16, 18. This polymer solution is then dispersed into another liquid phase of a non-solvent for the polymer, such as, glycerol, an aqueous polyvinyl alcohol (PVA) solution, or other suitable solvent or solution with lower polymer solubility, such as a mixture of tetrahydrofuran (THF) and ethanol which can only dissolve the copolymers at low concentration, e.g., <5 wt % and at a higher temperature, e.g., ranging from about 60° C. to about 80° C.

The dispersion of the polymer solution into the non-solvent can be achieved through a variety of techniques, including ultrasonication, magnetic or mechanical stirring, syringe-pump injection, or microfluidic device procedures. Any ratio of the two phases (>0:<100 to <100:>0) can be applied as long as the emulsion is uniform under dispersion. The selection of the dispersion method influences the size distribution of the resulting microspheres 20A, enabling control over particle diameters across a broad range from nanometers to several micrometers.

When the polymer solution is introduced into the non-solvent phase, the process typically yields solid microspheres. Conversely, when the non-solvent is gradually added to the polymer solution, the resulting microspheres tend to exhibit a hollow or porous internal morphology.

Alternatively, a water-oil-water emulsion can be used, where the combination sequence is to uniformly mix an inner water or non-solvent phase into the polymer solution, and then uniformly mix the resulting emulsion with an outer non-solvent phase. This procedure can be used for drug release purposes.

Once the emulsion is formed, the polymer droplets are solidified through methods such as solvent evaporation (for smooth surface) or rapid quenching (for rough or nanofibrous morphologies). Rapid quenching can be achieved by snap-freezing in a conventional freezer or by pouring the emulsion in a low temperature media such as liquid nitrogen or dry ice bath. Following solidification, the size of microspheres 10A can be further selected by sieving. The residual impurities can be washed away with solvents, such as ethanol, methanol, hexane and water.

Nanofibrous hollow microspheres and nanofibrous microspheres may also be formed by phase separation and template leaching techniques or emulsification techniques. Examples of methods that may be used to form the nanofibrous spongy microspheres are described in U.S. patent application Ser. No. 14/507,523, entitled “Nanofibrous Spongy Microspheres”, which is incorporated herein by reference in its entirety.

In another example, the copolymer 12, 14, 14′, 16, 18 is in the form of the film 10B, and forming the film 20B involves thermally induced phase separation or electrospinning. With thermally induced phase separation (i.e., temperature induced phase separation or TIPS), the copolymer 12, 14, 14′, 16, 18 is dissolved in a solvent, and then poured into a mold and sealed. The sealed mold is frozen for a predetermined amount of time to induce phase separation. The mold is then submerged in an ice-water bath or non-solvent bath while returning it to room temperature. Examples of non-solvent include methanol, ethyl acetate, ethyl ether, ethanol and hexane. The solidified film is then dried. With electrospinning, the copolymer 12, 14, 14′, 16, 18 is dissolved or suspended in a solvent, such as chloroform, dichloromethane (DCM), THF, hexafluoroisopropanol (HFIP), formic acid, and mixtures thereof. Then, the solution/suspension is electrospun onto a collector from which the resulting film 20B can be removed. During electrospinning, a syringe pump is used to extrude the copolymer solution or suspension. High voltage is applied between the syringe nozzle and the collector (in this example, a plate or other regular or irregularly shaped temporary substrate). The distance between the collector and the nozzle is 10 cm or less to avoid fibers flying around before being collected. In some examples, a rotor can be connected to the collector, allowing uniform fiber collection in all directions. The extruded copolymers are then dried and removed from the collector. The concentration of the solution, solvent composition, distance between the nozzle and the collector, extrusion speed, voltage, and potentially rotor speed can be adjusted to change the thickness and connectivity of the fibers that are formed. The following are suitable conditions for the electrospinning process: solution concentration ranging from about 1 wt % to about 30 wt %; a distance between the nozzle and the collector ranging from about 2 cm to about 100 cm; an extruder speed ranging from about 0.01 ml per minute to about 5 ml per minute; a voltage ranging from about 1 kV to about 100 kV; and a rotor speed ranging from about 10 rpm to about 1000 rpm.

In still another example, the copolymer 12, 14, 14′, 16, 18 is in the form of the scaffold 20C. One example for forming the scaffold 20C is a reverse-3D printing method, where the copolymer solution is cast into a removable mold (printed with materials such as wax and/or polysaccharide), which is later removed to obtain a complex structure. An example of this method includes first generating a negative replica (porogen or mold) of a scaffold by: introducing sugar (e.g., fructose) spheres and a non-solvent thereof into a mold; annealing the sugar spheres, thereby causing the sugar spheres to interconnect; and removing the non-solvent; and then generating the scaffold 20C by: casting a copolymer solution into the mold and onto the negative replica of the scaffold 20C; performing temperature induced phase separation of the polymer solution; and removing the negative replica of the scaffold 20C. Because the negative replica is formed of sugar, it can be removed via water.

Other suitable techniques for forming scaffolds 20C of a variety of shapes include additive manufacturing, or 3D printing, techniques. Physical printing methods, such as fused deposition modeling, selective laser sintering, and melt electro writing can all be used the copolymer 12, 14, 14′, 16, 18. Since the copolymer 12, 14, 14′, 16, 18 contains double bonds, crosslink-based methods, such as stereolithography, digital light processing, and two-photon 3D printing, can also be used.

In still another example, the copolymer 12, 14, 14′, 16, 18 is in the form of the scaffold 20D. One example for forming the scaffold 20D utilizes the electrospinning technique described herein. This involves dissolving or suspending the copolymer 12, 14, 14′, 16, 18 in a solvent. The solution/suspension is electrospun onto a collector from which the resulting tubular scaffold 20C can be removed. In this example, the collector is a metal rod, the diameter of which dictates the diameter of the hollow center 30. Electrospinning may be performed as described herein for a predetermined amount of time to achieve a suitable thickness for the layer 28. The layer 28 is then dried. The layer 28 can be cut and removed from the rods to acquire the tubular scaffolds 20D.

In still another example, the copolymer 12, 14, 14′, 16, 18 is in the form of the multi-layer scaffold 20E. One example for forming the multi-layer scaffold 20E is a two-step procedure. The first layer 32 can be fabricated using a mold with a center rod positioned therein. Sugar spheres are used as a porogen. The sugar spheres are added into the mold between the interior surface and the center rod and are dried so they are at least partially annealed. The mold can then be removed, leaving the rod and partially annealed sugar spheres exposed. The structure is then soaked in a copolymer solution (e.g., using THF or another suitable solvent) and undergoes thermally induced phase separation as described herein. After TIPS, the structure is soaked in hexane or another suitable wash solvent to remove solvent of the copolymer solution. The resulting polymer-fructose-rod structure is then exposed to electrospinning as described herein. After the electrospinning, the structure is washed, e.g., with water to remove the porogen, and the rod is extracted from the structure.

In any example method, the copolymer 12, 14, 14′, 16, 18 may be selected to achieve the nanofibrous architecture in accordance with the factors outlines in the Example section. The following factors may be adjusted to ensure both nanofiber formation and biologically functional molecule attachment: molecular weight of the PSLA chain and/or the crystalline polymer chain, the length of the PSLA and/or the crystalline polymer, and the feed ratio of the PSLA and the crystalline polymer during copolymer formation.

After the copolymer 12, 14, 14′, 16, 18 is formed, the biologically functional molecule(s) may be attached to a surface of the copolymer 12, 14, 14′, 16, 18 (e.g., via functional group(s) of the PSLA random copolymer 10 portion). The process for attaching may result in covalent, ionic, or hydrogen bonding between the biologically functional molecule(s) and the functional groups of the copolymer 10, or physical absorption (Van der Walls interactions) of the biologically functional molecule(s) at the surface of the copolymer 12, 14, 14′, 16, 18. When covalent attachment is desired, the method involves wetting the copolymer (e.g., polymeric structure 20A, 20B, 20C, 20D, 20E); exposing the wetted copolymer to the biologically functional molecule, thereby forming a precursor structure; and exposing the precursor structure to ultraviolet light and a relevant catalyst. When physical absorption is desired, the method involves incubating, at a predetermined temperature and for a predetermined time, the copolymer (e.g., polymeric structure 20A, 20B, 20C, 20D, 20E) in a solution containing the biologically functional molecule.

In other example methods, the composition is formed as described herein (i.e., the biologically functional molecule(s) is/are attached to the copolymer 12, 14, 14′, 16′, 18), and then is coated on at least a portion of a medical device 40.

Any suitable deposition technique may be used, such as painting, spray coating, liquid deposition, electrodeposition, or vapor deposition. Alternatively, the copolymer 12, 14, 14′, 16′, 18 may be coated on at least a portion of the medical device, and then the peptide(s) or other biologically functional molecule(s) may be attached (e.g., covalently, ionically, via hydrogen bonding, or via Van der Walls interactions) to the coating as described herein.

The compositions disclosed herein can be used in in vitro and in vivo regeneration of structural tissues such as bone, articular cartilage, fibrous cartilage, meniscus, bone/cartilage composite, ligament, tendon, cementum, dentin, enamel, temporomandibular joint (TMJ) tissues, intervertebral disc, and so on.

To further illustrate the present disclosure, examples are given herein. It is to be understood that these examples are provided for illustrative purposes and are not to be construed as limiting the scope of the present disclosure.

### EXAMPLES

These examples describe the formulation and testing of various copolymers formed with PSLA. In some examples, the naming system includes the following short hand: PSLAx, where “x” is a number representing the feeding ratio of the components used to form the PSLA random copolymer chain (e.g., PSLA4060 means the feeding weight ratio of spiro[6-methyl-1,4-dioxane-2,5-dione-3,2′-bicyclo[2.2.1]hept[5]ene] (Spiro-la) to L-lactide was 40:60); “b” is block; CPy, where “CP” represents the abbreviation of the crystalline polymer that is used for the second block, and “y” is a number representing the weight ratio of PSLA to CP when synthesizing the CP block (e.g., PSLA4060-b-PLLA16 means that CP is poly(L-lactide) and that the PSLA/L-lactide ratio is 1:16). Also in some examples, the molecular weight of each chain is labeled in the nomenclature. For example, PSLA4060(258k)-b-PLLA(361k) means that the PSLA chain had a number average molecular weight (Mn) of 258k g/mol (obtained using GPC), while the PLLA block had a number average molecular weight of 361k (calculated from the difference between Mn of the entire block copolymer and Mn of PSLA chain).

### Example 1

### Polymer, Film, and Scaffold Preparation

Several PSLA-b-PLLA copolymers were prepared following the synthesis set forth in FIG. 1A. As described herein, FIG. 1A depicts a reaction scheme illustrating i) the synthesis of Spiro-la, a modified L-lactide based monomer where (A) is a substitution reaction, (B) is an elimination reaction, and (C) is a Diels-Alder reaction; and ii) the copolymerization of Spiro-la and L-lactide, where (D) is the synthesis of the random copolymer PSLA and (E) is the synthesis of the block copolymer PSLA-b-PLLA. FIG. 1A as it was performed in this example will now be described in more detail.

L-lactide (recrystallized from 35 wt % ethyl acetate solution), NBS (at 110 mol % of the total L-lactide) and benzene (at 5:1 v/w of the total L-lactide) were added to a flask and heated to 80° C. until reflux occurred. BPO (at 2 mol % of the total L-lactide, recrystallized from 2 wt % ethanol solution) was dissolved in benzene at 5 w/v % and the solution was added into the flask drop-wise. The flask was kept at 80° C. for 48 hours. The solution was washed with 2 mol/L Na₂S₂O₃ three times and 6M NaCl once, followed by drying over anhydrous sodium sulfate for 30 minutes. The solvent was removed on a rotary evaporator under vacuum at 50° C. and the product (La—Br) was recrystallized into a slightly yellow crystal.

La—Br was dissolved in DCM at a concentration of 20 w/v %. The solution was placed on an ice bath and TEA (at 110 mol % of the total La—Br) was added dropwise to the flask while stirring. The flask was kept in the ice bath for 1 hour and kept at room temperature for another hour. The reaction mixture was washed with 0.1M HCl 3 times and 6M NaCl once, followed by drying over anhydrous sodium sulfate for 30 minutes. The solvent was removed on a rotary evaporator under vacuum and the product, (6S)-3-Methyl-6-methyl-1,4-dioxane-2,5-dione, was recrystallized into a slightly yellow crystal.

The (6S)-3-Methyl-6-methyl-1,4-dioxane-2,5-dione product and cyclopentadiene (at 200 mol % of the (6S)-3-Methyl-6-methyl-1,4-dioxane-2,5-dione product, prepared by distillation of commercial dicyclopentadiene at 180° C. and collecting distillate) was dissolved in benzene (at 10:1 v/w of the (6S)-3-Methyl-6-methyl-1,4-dioxane-2,5-dione product) and the container was purged with argon for 20 minutes and sealed. The flask was then heated until the contents refluxed at 80° C. Refluxing was maintained for another 12 hours. Benzene and excess amounts of cyclopentadiene were removed on a rotary evaporator under vacuum at 50° C. for 12 hours. The resulting solid (Spiro-la) was purified in a silica gel column using hexane first to remove dicyclopentadiene, then DCM to collect the Spiro-la product. DCM was removed on a rotary evaporator under vacuum at room temperature and the resulting solid was recrystallized in ethyl acetate.

20 ml glass vials with molecular sieves were purged with nitrogen for 10 minutes and sealed before the reaction. Different ratios of La and Spiro-la (10 w/v % in DCM, dried over anhydrous sodium sulfate) were added to the vials. A TBD solution (2 mg/ml-16 mg/ml in DCM, dried over anhydrous sodium sulfate) was loaded in 1 ml syringes with filters and fixed on the rubber seal. The vials were cooled down to −80° C. for an hour before the TBD solution was injected into each vial. The vials were then shaken briefly and kept at −80° C. for 48 hours. At the end of the reaction, the viscous reaction mixture was put on a rotary evaporator to remove DCM. The product was washed off from the molecular sieve using an excess amount of DCM and dried in a vacuum to remove DCM. Unreacted monomer(s) were washed away with ethyl acetate 2 times before the product was dried to form a transparent film of PSLA.

Solid PSLA was weighed, added into a 20 ml glass vial together with molecular sieves, purged with nitrogen for 10 minutes, and sealed before the reaction. L-lactide, at a 100% to 1600% weight ratio of the PSLA, was added into the vials. Another TBD solution (1 mg/ml in DCM, dried over anhydrous sodium sulfate) was loaded in 1 ml syringes with filters and fixed on the rubber seal. The vials were cooled down at −80° C. for an hour before the TBD solution was injected into each vial. The vials were then shaken briefly and kept at −80° C. for 48 hours. At the end of the reaction, the viscous reaction mixture was put on a rotary evaporator to remove DCM. The product was washed off from the molecular sieve using an excess amount of DCM and dried in a vacuum to remove DCM. Excess L-lactide was washed away with ethyl acetate 2 times before the product was dried to form a transparent film of PSLA-b-PLLA.

Nanofibrous films were prepared. PSLA-b-PLLA solution (10 wt % of the block copolymer in THF) was heated to 60° C. until the solution became transparent. To reduce degradation, the dissolving process was finished within 30 minutes. For examples of the PSLA-b-PLLA block copolymers with higher molecular weight, a 5 wt % THF solution was made first, and THF was evaporated at 60° C. until the solution concentration reached 10 wt %. The viscous polymer solution was dropped onto a 0.5-mm-thick glass mold with a silicon wafer as the inner surface to ensure film flatness. The mold was immediately sealed afterward, and was placed into a −80° C. freezer for 2 days to induce phase separation. The mold was then unsealed and submerged in an ice-water bath to exchange THF. The solidified film was then dried between paper towels on a benchtop for two days and stored in a vacuum until further experiments.

Nanofibrous 3D scaffolds were prepared using a combination method of thermally induced phase separation (TIPS) and porogen leaching. Fructose templates used for 3D pores were formed by cooling down a fructose/mineral oil emulsion from 120° C. in an ice-water bath and collecting fructose spheres with diameters of 250 μm to 425 μm using stainless steel sieves. The fructose spheres were soaked in hexane, moved to a vial, and annealed at 37° C. to form a connected fructose template. The template was then vacuum-dried for one hour to remove hexane. PSLA-b-PLLA solution (10 wt % of the block copolymer in THF) was prepared as described herein. The viscous solution was added to the fructose template. A brief vacuum was used to remove air in the fructose template and allow the polymer solution to fill in. The vial was then sealed and placed in an −80° C. freezer for 2 days. Afterwards, the vial was unsealed, soaked into hexane to remove THF, and then soaked into the water to remove the fructose template. The porous 3D nanofibrous scaffold was collected, cut into desired shapes, and freeze-dried.

The following provides a brief overview of the tests and processes used in this example.

### Polymer, Film, and Scaffold Characterizations

H¹ Nuclear Magnetic Resonance (H NMR): Polymer samples were dissolved in d-chloroform for a concentration of 5 w/v % and NMR spectrum was acquired on Varian Inova 500 (500 MHz), with 32 scans per sample, 9-second acquisition time, and 5-second relax time between scans.

Fourier-Transform Infrared spectroscopy (FTIR): Polymer samples (powder or film) were placed on a diamond crystal accessory of Thermo-Nicolet IS-50 instrument, and FTIR spectrum was acquired with a wavenumber range of 500 cm⁻¹ to 4000 cm⁻¹.

Gel Permeation Chromatography (GPC): 0.1 mg/ml-0.5 mg/ml THF solution of polymer samples were filtered and tested on Shimadzu GPC to obtain relative molecular weight distribution (polystyrene standard).

Scanning Electron Microscopy (SEM): After the TIPS procedure, film and scaffold samples were wet with ethanol for 30 minutes, dried on a bench at room temperature to undergo gold coating, and were observed under a JEOL JSM-7800FLV SEM instrument.

Differential Scanning Calorimetry (DSC): A Perkin-Elmer DSC-7 Differential Scanning Calorimeter was used to obtain DSC data. From about 5 mg to about 10 mg of nanofibrous polymer films were added in an aluminum sample holder and were heated at temperatures ranging from 50° C. to 190° C. at a speed of 20° C. per minute. Melting enthalpy was calculated using the build-in instrument program.

Film mechanical properties and morphology: Nanofibrous film samples were cut into sheets with 2 mm width and 20 mm length. The dimensions of individual specimens were measured by a caliper. A GT-UA03 Single Column Tensile Test Machine with a 50 N loading cell was used for all mechanical tests. The samples were fixed on a small force film holder with a 10 mm gauge length and pulled at a speed of 0.5 mm/min. Tensile modulus, strain at break, ultimate tensile strength, and toughness were obtained from the stress-strain curve. The samples after tensile tests were observed under SEM using the same sample preparation methods mentioned above.

Contact angle: Nanofibrous film samples were cut into sheets of 2 cm width and 2.5 cm length. The films were fixed on a glass slide with tape and dried under vacuum. A Rame-Hart 200-Fl contact angle goniometer was used to measure contact angle by taking pictures while dropping Milli-Q water on top of the film.

Nanofibrous film surface erosion: Rectangular-shaped nanofibrous films (1 cm×1 cm) were wet in 5 ml ethanol for 30 minutes. The ethanol was replaced by 5 ml 0.25 mol/L NaOH solution (preheated at 50° C.) and held for 2 minutes. The soaked films were taken out from the NaOH solution and put in Milli-Q water (50 ml per film) for 2 hours with water exchanged three times. The films were then washed once with ethanol and dried on a benchtop, before SEM imaging.

### Covalent Surface Conjugation of P24 Peptide

A piece of 5-mm-diameter 3D porous scaffold was weighed to calculate P24 peptide conjugation amount per mass. The piece was wet with ethanol in a cell culture plate for 30 minutes before the reaction. 1 wt % IRGACURE® 2959/methanol and from about 0.1 mg/ml to about 1 mg/ml peptide/PBS solution were added to the wetted scaffolds in a 1:1 volume ratio, for a total of 0.2 ml per piece. The plate was moved under a UV lamp and exposed to UV light for 15 minutes. Supernatant before and after reaction was collected for peptide consumption measurements and the 3D scaffolds were washed with ethanol 3 times and PBS 3 times for 30 minutes each and stored at −80° C. until further experiments. Alternatively, a piece of 5-mm-diameter film underwent the same procedure for peptide conjugation comparison, FTIR, or contact angle measurement purposes.

### Peptide Conjugation Density and Conjugation Percentage

Peptide conjugation was tested by collecting peptide solution before and after the peptide attachment reaction, as well as the supernatant from washing. To compare peptide conjugation density on multiple polymer compositions, 0.3 ml of 1 mg/ml P24 peptide in PBS solution was used per nanofibrous film (5 mm in diameter, 0.2 mm thickness, around 100 nmol/mg feeding concentration) in the conjugation test reaction. To acquire the relationship for 3D scaffold peptide feeding and conjugation, various amounts of 1 mg/ml P24 peptide in PBS solution were used per 3D nanofibrous scaffold (5 mm in diameter, 1 mm thickness, various feeding up to 150 nmol/mg). The peptide conjugated on films or scaffolds was tested following the protocol provided by PIERCE™ Quantitative Peptide Assays (Thermo Fisher Scientific) and was converted to mole amounts of peptide. The amount of conjugated peptide (nmol peptide per mg film or scaffold) was determined by subtracting the remaining peptide and wash-away peptide from the total feeding peptide. The conjugation percentage was given by the ratio of conjugated peptides to total feeding peptides.

### Visualization of Peptide Conjugation

A fluorescein isothiocyanate isomer I (FITC, excitation/emission wavelengths: 495/519 nm) labeling method was used for fluorescence imaging. Briefly, P24 peptide and FITC dye was dissolved in pH 9.0 phosphate buffer and stirred for 12 hours, followed by dialysis purification with MWCO 1k dialysis bag to remove buffer and unreacted dye. The FITC-labeled peptide was then conjugated to 3D scaffolds using the same procedure described herein. A control group of physically absorbed peptides was conducted by soaking a scaffold in the same peptide solution without initiator or UV exposure for 15 minutes. Both groups were washed extensively after conjugation by using 10 ml ethanol to wash for 30 minutes 3 times and 10 ml PBS solution to wash for 30 minutes 3 times, followed by placing in 50 ml PBS solution at 4° C. overnight. A Leica Thunder microscope was used to acquire bright field as well as fluorescence images at corresponding wavelengths.

### Degradation of 3D Scaffolds

3D porous scaffolds were cut into disks with diameters of 18 mm and thickness of 2 mm and soaked in PBS at 37° C. for up to 8 weeks. 2-3 disks were used for each replicate and 3 replicates at each timepoint were used for the weight loss experiment. SEM images were taken for 4 time points: before incubation (0 week), after 2 weeks of incubation, after 4 weeks of incubation, and after 8 weeks of incubation, to analyze scaffold morphology changes.

In Vivo Bone Regeneration with Cell-Free PSLA-b-PLLA 3D Scaffolds on a Mouse Critical-Sized Calvarial Defect Regeneration Model

Male C57BL/6J mice aged 5 to 6 months were pre-injected with 5 mg/kg carprofen and anesthetized with isoflurane. The skull area was shaved and cleaned with iodine and saline solution. A 5-6 mm incision was made at the center line of the skull and a 5 mm-diameter trephine bur was used to carefully remove a round piece of bone. A cell-free PSLA-b-PLLA scaffold with or without P24 peptide conjugation (100 pg peptide feed per scaffold, or around 7 nmol/mg scaffold) wetted with saline was placed in the defect and silk suture was used to close the incision. Mice were sacrificed at 4-week or 8-week time points. Skull samples were collected, underwent fixation in 4% paraformaldehyde at 4° C. for 24 hours, and stored in 70% ethanol before further experiments.

### Bone Volume Analysis

A micro-CT system (μCT100 Scanco Medical, Bassersdorf, Switzerland) was used to scan the samples under voxel size 18 μm, 70 kVp, 114 μA, 0.5 mm AL filter, and integration time 500 ms. Results were processed using the Dragonfly software and bone volume in the defect was calculated from a lower threshold of 18% and an upper threshold of 100%.

### Histology Analysis

Samples after the micro-Ct scan were cleaned and soft tissue was removed. The central part of the skull was then demineralized in 14 wt % EDTA solution (pH=7.4) for 14 days, with the solution changed every two days. The samples were then embedded in paraffin, sliced with 10-micron thickness, and stained following the standard protocol of hematoxylin and eosin (H&E) staining and Masson's trichrome staining.

### Immunofluorescence (IF) Staining and Analysis of Implant

Samples after the micro-Ct scan were cleaned and soft tissue was removed. The central part of the skull was then demineralized in 14 wt % EDTA solution (pH=7.4) for 14 days, with the solution changed every two days. The samples were then embedded in paraffin wax and sectioned using a microtome with a 10-micron thickness per section. The section slides were hydrated with xylene, 100% ethanol, 95% ethanol, 70% ethanol, and PBS soaking in order, 2 times for 3 minutes each. 10% formalin was used to fix samples for 10 minutes, and the samples were incubated with 3% H₂O₂/PBS solution for 5 minutes, followed by DIVA decloaker solution soaking at 60° C. overnight. The samples were washed with PBS at room temperature 4 times, 5 minutes each wash. A PBS solution containing 0.1% Triton, 0.1% BSA, and 2% NDS was used as a blocking solution by soaking for 1 hour. Primary rabbit antibodies including CD31, VWF, and Runx2 antibodies were dissolved in PBS solution containing 0.1% of triton (0.1% PBST) with 1:100 dilution and dropped on the sample slides, which were kept under moisture at 4° C. overnight. Unbonded antibodies were then washed away with PBS 4 times and 5 minutes each wash, and Donkey-anti-rabbit secondary antibodies (with fluorescence Alexa Flour 594 or 488, 1:1000 in 0.1% PBST) were dropped on the samples and incubated at room temperature for 2 hours. Excess secondary antibodies were washed away with PBS 4 times and 5 minutes each wash. A DAPI mounting solution was dropped on the slides before a cover glass was placed on the top. Images were acquired using a Leica Thunder microscope, overlaying the bright field image and fluorescence channels.

### Copolymer Characterization

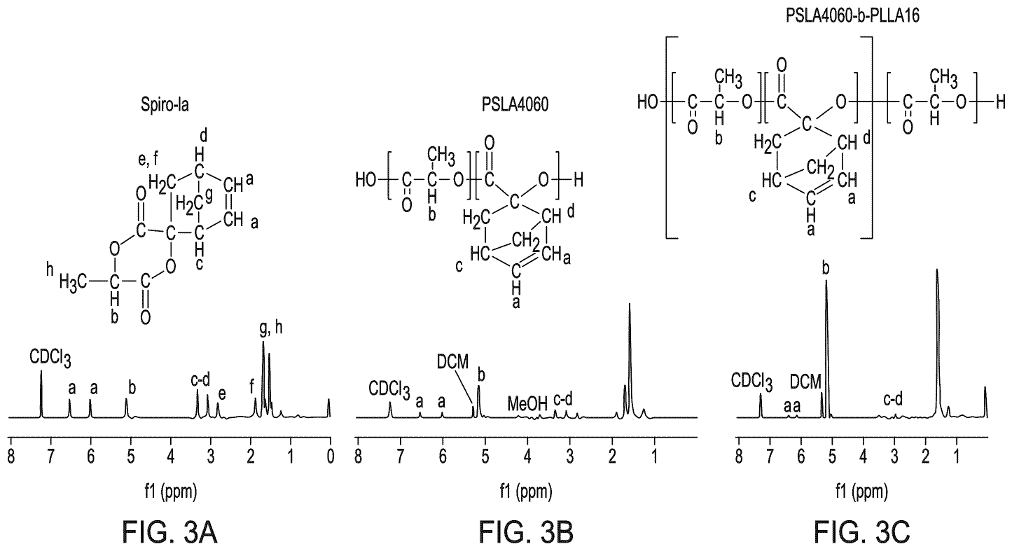

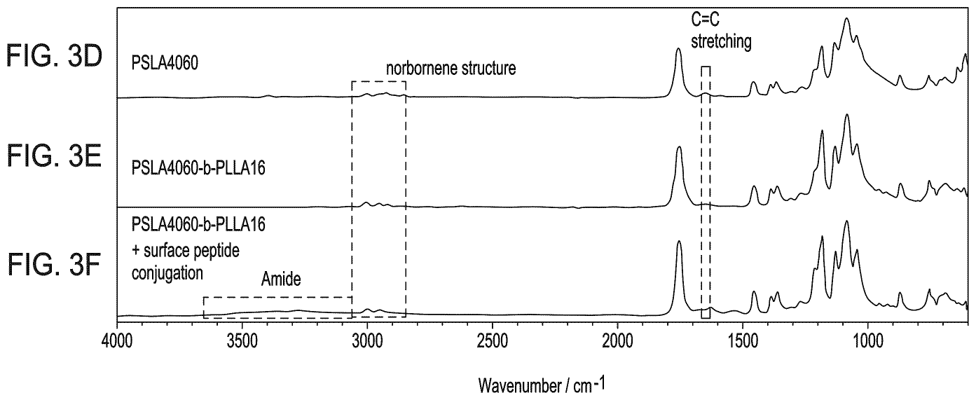

PSLA-b-PLLA was successfully synthesized using the cold polymerization method described herein between Spiro-la and L-lactide, followed by the second step of adding L-lactide to the PSLA chain after the purification of the PSLA. The double bond in PSLA-b-PLLA was confirmed by double bond H shift at 6.1 and 6.3 in the H NMR spectrum (see FIG. 3A through FIG. 3C). From the FTIR spectrum, C═C stretching near 1645 cm⁻¹ and the group of peaks around 3000 cm⁻¹ resembling norbornene-like structure suggested the Spiro-la repeating unit in the polymer (FIG. 3D and FIG. 3E). After peptide conjugation, the double bond peak substantially decreased, and the amide broad peak at 3300 cm⁻¹ appeared, suggesting covalent peptide conjugation (FIG. 3F).

### Mechanism Study of the Copolymerization of Spiro-La and L-Lactide

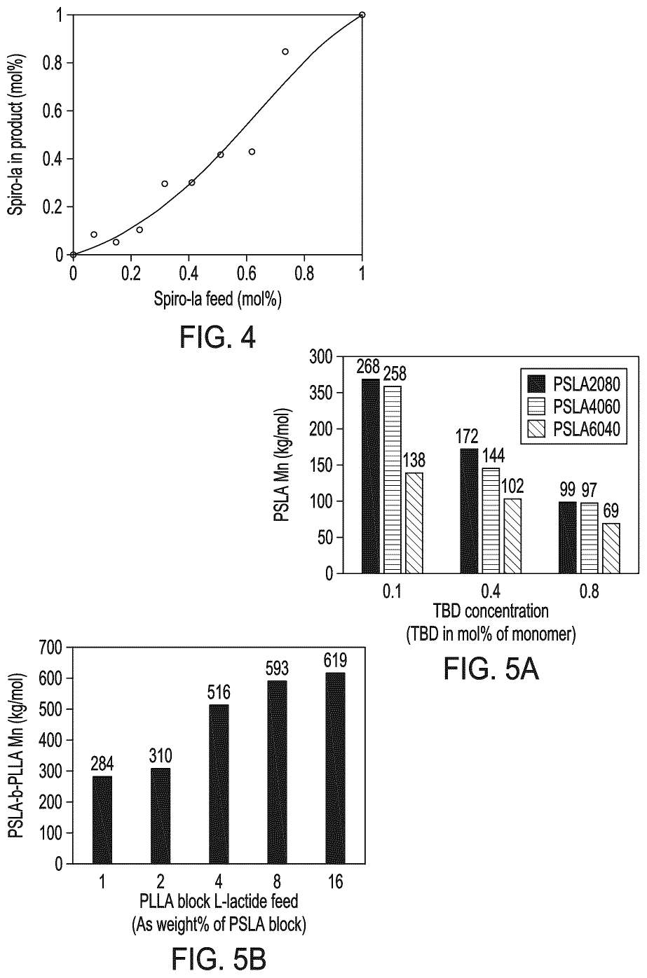

To fit the relationship between monomer feed and polymer composition to the Mayo-Lewis's equation, low conversion was required. 5 wt % DCM solution of Spiro-la and L-lactide were mixed with 0.8 mol % of triazabicyclodecene (TBD) and the samples were collected after 12 hour reactions at −80° C. The percentages of the two repeating units in the products were quantified by the NMR peak of double bond and the quartet peak from the tertiary carbon. The fitting was done with MATLAB optimization tool using Mayo-Lewis's equation, which yielded a reactivity ratio of rₛₚᵢᵣₒ₋ₗₐ=1.43 and r_{L-lactide}=2.40 (FIG. 4). These results suggest that the PSLA copolymer sequence was a random copolymer.

### Molecular Weight Control of the PSLA Chain and the PSLA-b-PLLA Block Copolymer

The monomer feed ratio between 20:80 to 60:40 was tested. As shown in FIG. 5A, different monomer feed ratios led to different molecular weights when other conditions were the same. It was also observed that a higher percentage of Spiro-la feeding led to lower molecular weight. This was likely because the lower reactivity of Spiro-la compared to L-lactide. When the feeding ratio of the monomers was constant, the molecular weight of the PSLA block was controlled by TBD concentration. It was found that reducing TBD concentration increased molecular weight (FIG. 5A). There is an increased number of reaction sites when the TBD concentration is increased, which led to decreased chain length.

The block of PLLA was added to the PSLA chain by using the PSLA as a macro-initiator. The length of the PLLA block was controlled by the amount of L-lactide added per mass of PSLA. A higher ratio of L-lactide to PSLA led to higher product molecular weight or longer PLLA blocks, as shown in FIG. 5B. The ratio of increment of PSLA-b-PLLA molecular weight to PSLA was always lower than the feed weight ratio. This was due to the hydrodynamic volume difference between PSLA and PLLA blocks, causing a non-linear relationship between the real molecular weight and the relative molecular weight. Nonetheless, the comparison between different feed ratios was valid, and GPC data could be used to quantitatively compare the length when the PSLA block was identical.

### The Effect of PSLA-b-PLLA Composition on its Morphology

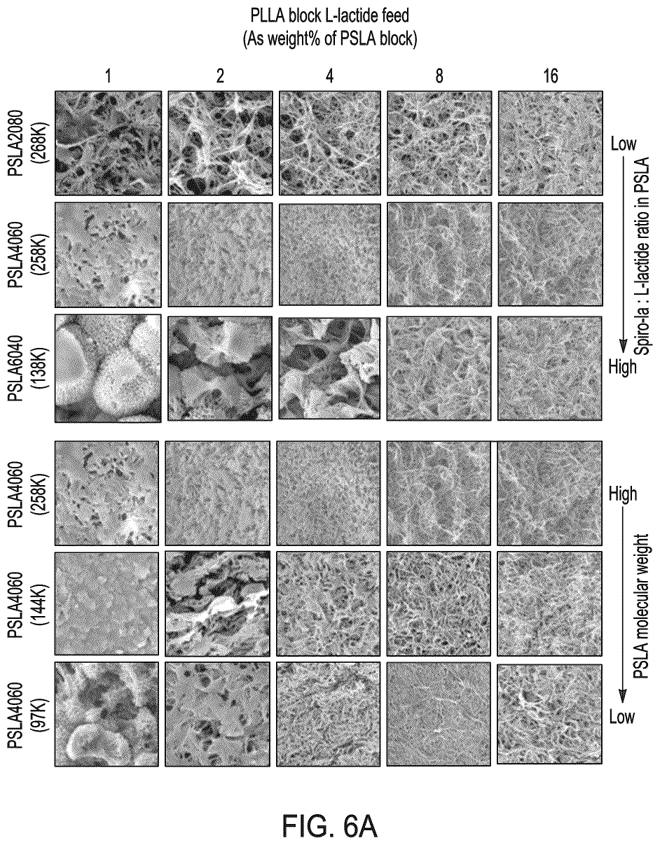

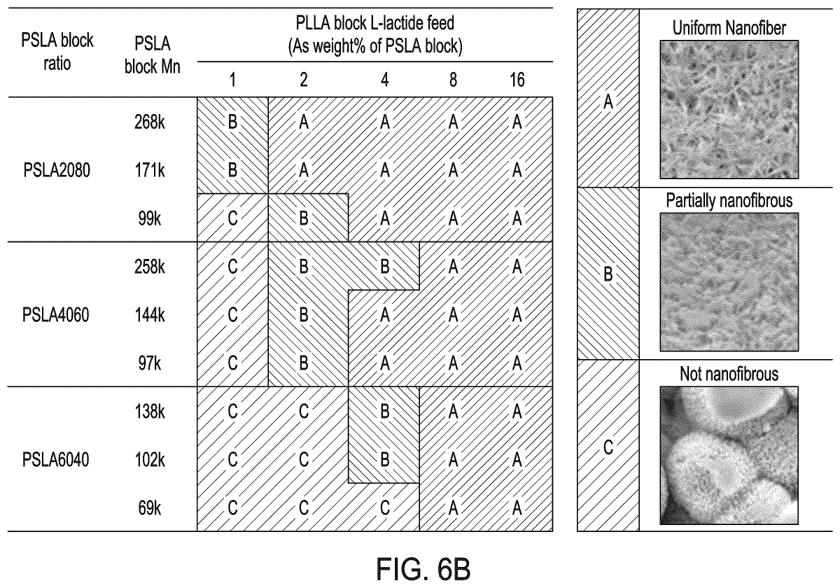

The composition of PSLA-b-PLLA controls formation of nanofibrous structures. Increasing the PLLA portion in the block copolymer was beneficial for uniform nanofiber formation, as shown in polymer films with the same PSLA composition (FIG. 6A). Reducing the Spiro-la portion in PSLA was also beneficial for nanofiber formation (FIG. 6A and FIG. 6B). These results may be explained by the increase of the L-lactide repeating unit, approaching PLLA-like behavior. Among these effects, the length of the PLLA portion was more dominant than the effect of the PSLA chain length or the PSLA block ratio. At a higher PLLA ratio, nanofibers were formed (see FIG. 6B).

Two different morphologies of non-nanofibrous films were discovered. One morphology showed a decrease of fiber length where the fiber shrank and formed a structure like a broccoli stem, and eventually turned into separate particles when the PLLA portion was reduced (PSLA6040, Mn 138k in FIG. 6A). The other morphology showed a micro-phase-separation where a solid non-nanofibrous domain formed among nanofibers, and eventually turned into smooth films when the PLLA portion was reduced (PSLA4060, Mn 258k in FIG. 6A). These results suggested that both a low Spiro-la ratio and long PLLA chain length were necessary for PLLA-like nanofiber formation.

### The Effect of PSLA-b-PLLA Composition on its Mechanical Properties

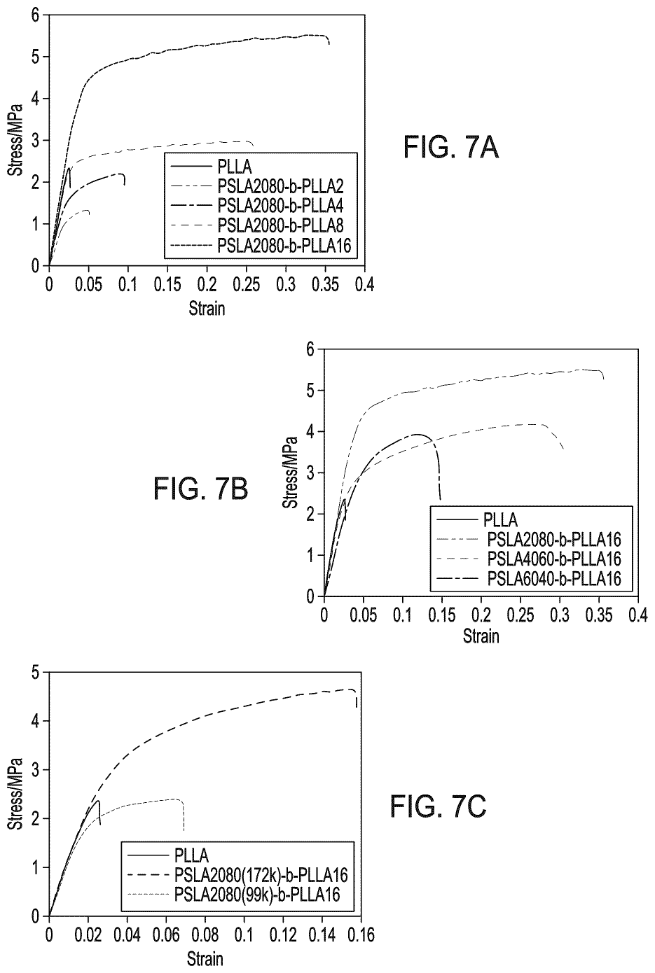

The mechanical properties of nanofibrous PSLA-b-PLLA films changed with compositions (FIG. 7A through FIG. 7C and Tables 1A-1C and 2). Nanofibrous films made of commercial PLLA (RESOMER® L 207 S, referred to as ‘PLLA’ below) were used as a reference. Samples without nanofibrous morphology or very weak (ultimate strength less than 0.07 MPa) were skipped since they were not candidates for 3D scaffold fabrication.

For a fixed PSLA block, a longer PLLA block greatly increased all mechanical properties, including tensile modulus, strain at break, ultimate strength, and toughness). When using PSLA2080 (Mn 268k) as the PSLA block and the 16:1 L-lactide feeding ratio to synthesize the PLLA block, a tensile modulus of 118%, strain at break of 1213%, the ultimate strength of 209%, and the toughness of 35.1 times that of PLLA nanofibrous films were achieved (FIG. 7A and Table 1A). This difference was a result of increased molecular weight of the block copolymer, where the PLLA block was longer than pure PLLA (Mn 176k).

TABLE 1A
The effect of PLLA Block Length

| | PSLA | PLLA | | | | |
|---|---|---|---|---|---|---|
| | block | block | Tensile | | Ultimate | relative |
| | Mn | Mn | modulus*/ | Strain at | strength*/ | toughness |
| Polymer | (g/mol) | (g/mol) | MPa | break* | MPa | to PLLA ** |
| PSLA2080-b-PLLA2 | 268k | 37k | 51 ± 7 | 4.2% ± 1.1% | 1.2 ± 0.3 | 0.9 ± 0.4 |
| PSLA2080-b-PLLA4 | 268k | 46k | 84 ± 3 | 7.7% ± 2.2% | 2.5 ± 0.3 | 3.1 ± 0.8 |
| PSLA2080-b-PLLA8 | 268k | 74k | 108 ± 2 | 20.4% ± 7.4% | 3.1 ± 0.4 | 13.3 ± 6.1 |
| PSLA2080-b-PLLA16 | 268k | 235k | 130 ± 8 | 36.4% ± 2.2% | 4.8 ± 0.8 | 35.1 ± 2.5 |
| Pure PLLA | NA | 176k | 110 ± 4 | 3.0% ± 0.4% | 2.3 ± 0.6 | 1 |

When the PLLA block was longer than pure PLLA, decreasing the Spiro-la ratio in the PSLA block improved the overall mechanical properties of PSLA-b-PLLA, particularly elongation and toughness (FIG. 7B and Table 1B). Spiro-la was a bigger monomer than L-lactide and a higher ratio of Spiro-la likely disrupted the PLLA crystalline structure, reducing modulus for nanofibers. PSLA6040 as the PSLA block cannot reach the PLLA-level of tensile modulus even with a 16:1 L-lactide feeding ratio. Samples with lower modulus than PLLA still had higher strain at break, ultimate tensile strength, and toughness than PLLA (PSLA6040-b-PLLA16 in FIG. 7B and Table 1B), which was likely contributed by the overall high length of the polymer from both the PSLA block and the PLLA block.

TABLE 1B
The effect of PSLA block composition (spiro-la and L-lactide ratio)

| | | PLLA | Tensile | | Ultimate | relative |
|---|---|---|---|---|---|---|
| | PSLA block | block Mn | modulus*/ | Strain at | strength*/ | toughness to |
| Polymer | Mn (g/mol) | (g/mol) | MPa | break* | MPa | PLLA ** |
| PSLA2080-b-PLLA16 | 268k | 235k | 130 ± 8 | 36.4% ± 2.2% | 4.8 ± 0.8 | 35.1 ± 2.5 |
| PSLA4060-b-PLLA16 | 258k | 361k | 113 ± 8 | 28.1% ± 4.6% | 4.4 ± 0.4 | 25.4 ± 4.2 |
| PSLA6040-b-PLLA16 | 138k | 386k | 85 ± 2 | 11.9% ± 1.2% | 3.9 ± 0.6 | 8.9 ± 1.2 |
| Pure PLLA | NA | 176k | 110 ± 4 | 3.0% ± 0.4% | 2.3 ± 0.6 | 1 |

When the PLLA block was at a similar length to pure PLLA and the PSLA chain with a Spiro-la to L-lactide ratio of 20:80 was used, increasing the PSLA block length had minimal effect on tensile modulus and ultimate strength. However, it increased strain at break and toughness dramatically (FIG. 7C and Table 1C). Compared to FIG. 7A and Table 1A, the change was mainly contributed by the PSLA block. Thus, the length of the PSLA block was another important factor in achieving good mechanical properties.

TABLE 1C
The effect of PSLA block length

| | | PLLA | Tensile | | Ultimate | relative |
|---|---|---|---|---|---|---|
| | PSLA block | block Mn | modulus*/ | Strain at | strength*/ | toughness to |
| Polymer | Mn (g/mol) | (g/mol) | MPa | break* | MPa | PLLA ** |
| PSLA2080(99k)-b-PLLA16 | 99k | 169k | 121 ± 13 | 5.8% ± 1.3% | 2.5 ± 0.2 | 2.7 ± 0.6 |
| PSLA2080(172k)-b-PLLA16 | 172k | 182k | 111 ± 2 | 16.8% ± 1.3% | 4.6 ± 0.4 | 13.4 ± 0.4 |
| Pure PLLA | NA | 176k | 110 ± 4 | 3.0% ± 0.4% | 2.3 ± 0.6 | 1 |

Overall, the mechanical properties of nanofibrous films were highly dependent on all compositional parameters. While the nanofibrous morphologies were similar among many compositions, the stiffness and elongation of the nanofibrous films varied (see the FIGS. 6 and 7 series). The long PLLA block brought by increasing L-lactide feeding during polymerization contributed to both elongation and modulus, while the long PSLA block contributed to elongation. The range of mechanical properties can be useful when designing a nanofibrous tissue engineering scaffold of different mechanical properties based on the applications (see the FIG. 7 series and Tables 1A-1C and 2).

TABLE 2
Synthesis and characterization of various PSLA-b-PLLA compositions

| | Synthesis | | | | | | Characterization | | |
|---|---|---|---|---|---|---|---|---|---|
| | Catalyst | PLLA block | | | | | | Peptide | |
| | concentration | L-lactide | PSLA block | | PSLA-b- | Tensile | | conjugation | Ultimate |
| PSLA block | (mol % to | feed ratio to | Mn | Nanofiber | PLLA Mn | modulus | Strain at | density | Strength |
| composition | monomer) | PSLA block | (kg/mol(PDI)) | quality | (kg/mol) | (MPa) | break | (nmol/mg) | (MPa) |
| PSLA2080- | 0.80 | 1 | 99(1.66) | C | — | | Weak film | | |
| b-PLLA1 | | | | | | | | | |
| PSLA2080- | 0.80 | 2 | 99(1.66) | B | — | | Weak film | | |
| b-PLLA2 | | | | | | | | | |
| PSLA2080- | 0.80 | 4 | 99(1.66) | A | 165 | 4.6 ± 2.5 | 1.5% ± 0.2% | 44.5 ± 3.4 | 0.08 ± 0.03 |
| b-PLLA4 | | | | | | | | | |
| PSLA2080- | 0.80 | 8 | 99(1.66) | A | 226 | 29.8 ± 7.8 | 3.9% ± 3.2% | 32.6 ± 1.8 | 1.40 ± 1.00 |
| b-PLLA8 | | | | | | | | | |
| PSLA2080- | 0.80 | 16 | 99(1.66) | A | 268 | 121.1 ± 13.2 | 5.8% ± 1.3% | 23.5 ± 4.7 | 2.48 ± 0.16 |
| b-PLLA16 | | | | | | | | | |
| PSLA2080- | 0.40 | 1 | 172(1.39) | B | — | | Weak film | | |
| b-PLLA1 | | | | | | | | | |
| PSLA2080- | 0.40 | 2 | 172(1.39) | A | 204 | 23.4 ± 8.4 | 2.1% ± 0.9% | 48.0 ± 1.1 | 0.43 ± 0.07 |
| b-PLLA2 | | | | | | | | | |
| PSLA2080- | 0.40 | 4 | 172(1.39) | A | 216 | 23.0 ± 4.5 | 2.0% ± 0.8% | 43.7 ± 2.2 | 0.41 ± 0.13 |
| b-PLLA4 | | | | | | | | | |
| PSLA2080- | 0.40 | 8 | 172(1.39) | A | 247 | 90.5 ± 18.3 | 4.9% ± 1.0% | 30.1 ± 2.0 | 2.90 ± 0.72 |
| b-PLLA8 | | | | | | | | | |
| PSLA2080- | 0.40 | 16 | 172(1.39) | A | 354 | 111.0 ± 1.6 | 16.8% ± 1.3% | 13.2 ± 1.4 | 4.58 ± 0.38 |
| b-PLLA16 | | | | | | | | | |
| PSLA2080- | 0.10 | 1 | 268(1.67) | B | — | | Weak film | | |
| b-PLLA1 | | | | | | | | | |
| PSLA2080- | 0.10 | 2 | 268(1.67) | A | 305 | 50.8 ± 6.6 | 4.2% ± 1.1% | 31.1 ± 6.2 | 1.22 ± 0.26 |
| b-PLLA2 | | | | | | | | | |
| PSLA2080- | 0.10 | 4 | 268(1.67) | A | 314 | 84.4 ± 2.8 | 7.7% ± 2.2% | 21.0 ± 2.1 | 2.51 ± 0.26 |
| b-PLLA4 | | | | | | | | | |
| PSLA2080- | 0.10 | 8 | 268(1.67) | A | 342 | 108.3 ± 1.5 | 20.4% ± 7.4% | 22.1 ± 5.2 | 3.12 ± 0.39 |
| b-PLLA8 | | | | | | | | | |
| PSLA2080- | 0.10 | 16 | 268(1.67) | A | 503 | 130.0 ± 7.6 | 36.4% ± 2.2% | 10.9 ± 0.6 | 4.83 ± 0.76 |
| b-PLLA16 | | | | | | | | | |
| PSLA2080 | 0.05 | 0 | 339(1.48) | B | 339 | | Weak film | | |
| PSLA4060- | 0.80 | 1 | 97(1.33) | C | — | | Weak film | | |
| b-PLLA1 | | | | | | | | | |
| PSLA4060- | 0.80 | 2 | 97(1.33) | B | — | | Weak film | | |
| b-PLLA2 | | | | | | | | | |
| PSLA4060- | 0.80 | 4 | 97(1.33) | A | 299 | 43.9 ± 2.4 | 3.3% ± 1.3% | 73.3 ± 2.2 | 1.03 ± 0.36 |
| b-PLLA4 | | | | | | | | | |
| PSLA4060- | 0.80 | 8 | 97(1.33) | A | 328 | 95.2 ± 13.2 | 4.4% ± 0.8% | 67.3 ± 12.8 | 4.00 ± 1.59 |
| b-PLLA8 | | | | | | | | | |
| PSLA4060- | 0.80 | 16 | 97(1.33) | A | 435 | 88.5 ± 1.4 | 15.6% ± 2.2% | 50.0 ± 2.1 | 2.70 ± 0.13 |
| b-PLLA16 | | | | | | | | | |
| PSLA4060- | 0.40 | 1 | 144(1.44) | C | — | | Weak film | | |
| b-PLLA1 | | | | | | | | | |
| PSLA4060- | 0.40 | 2 | 144(1.44) | B | — | | Weak film | | |
| b-PLLA2 | | | | | | | | | |
| PSLA4060- | 0.40 | 4 | 144(1.44) | A | 332 | 35.4 ± 5.2 | 4.8% ± 1.0% | 64.7 ± 2.3 | 1.24 ± 0.09 |
| b-PLLA4 | | | | | | | | | |
| PSLA4060- | 0.40 | 8 | 144(1.44) | A | 346 | 56.8 ± 3.5 | 6.8% ± 0.5% | 54.0 ± 2.6 | 1.90 ± 0.09 |
| b-PLLA8 | | | | | | | | | |
| PSLA4060- | 0.40 | 16 | 144(1.44) | A | 605 | 91.6 ± 2.9 | 12.9% ± 2.4% | 58.2 ± 6.6 | 2.38 ± 0.04 |
| b-PLLA16 | | | | | | | | | |
| PSLA4060- | 0.10 | 1 | 258(1.34) | C | 284 | | Weak film | | |
| b-PLLA1 | | | | | | | | | |
| PSLA4060- | 0.10 | 2 | 258(1.34) | B | 310 | | Weak film | | |
| b-PLLA2 | | | | | | | | | |
| PSLA4060- | 0.10 | 4 | 258(1.34) | B | 516 | | Weak film | | |
| b-PLLA4 | | | | | | | | | |
| PSLA4060- | 0.10 | 8 | 258(1.34) | A | 593 | 101.3 ± 10.7 | 21.5% ± 3.3% | 29.4 ± 2.5 | 5.88 ± 1.67 |
| b-PLLA8 | | | | | | | | | |
| PSLA4060- | 0.10 | 16 | 258(1.34) | A | 619 | 113.5 ± 8.0 | 28.1% ± 4.6% | 21.6 ± 1.4 | 4.37 ± 0.40 |
| b-PLLA16 | | | | | | | | | |
| PSLA4060- | 0.80 | 1 | 69(1.29) | C | — | | Weak film | | |
| b-PLLA1 | | | | | | | | | |
| PSLA4060- | 0.80 | 2 | 69(1.29) | C | — | | Weak film | | |
| b-PLLA2 | | | | | | | | | |
| PSLA4060- | 0.80 | 4 | 69(1.29) | C | — | | Weak film | | |
| b-PLLA4 | | | | | | | | | |
| PSLA4060- | 0.80 | 8 | 69(1.29) | A | 345 | 65.2 ± 4.0 | 3.2% ± 1.1% | 48.6 ± 6.1 | 1.58 ± 0.44 |
| b-PLLA8 | | | | | | | | | |
| PSLA4060- | 0.80 | 16 | 69(1.29) | A | 373 | 72.8 ± 11.4 | 5.9% ± 1.4% | 48.5 ± 1.7 | 2.21 ± 0.24 |
| b-PLLA16 | | | | | | | | | |
| PSLA4060- | 0.40 | 1 | 102(1.27) | C | — | | Weak film | | |
| b-PLLA1 | | | | | | | | | |
| PSLA4060- | 0.40 | 2 | 102(1.27) | C | — | | Weak film | | |
| b-PLLA2 | | | | | | | | | |
| PSLA4060- | 0.40 | 4 | 102(1.27) | B | — | | Weak film | | |
| b-PLLA4 | | | | | | | | | |
| PSLA4060- | 0.40 | 8 | 102(1.27) | A | 357 | 53.6 ± 3.0 | 10.0% ± 8.3% | 58.5 ± 4.9 | 1.76 ± 0.14 |
| b-PLLA8 | | | | | | | | | |
| PSLA4060- | 0.40 | 16 | 102(1.27) | A | 408 | 83.5 ± 44 | 13.4% ± 6.7% | 44.3 ± 1.3 | 3.73 ± 0.59 |
| b-PLLA16 | | | | | | | | | |
| PSLA4060- | 0.10 | 1 | 138(1.29) | C | — | | Weak film | | |
| b-PLLA1 | | | | | | | | | |
| PSLA4060- | 0.10 | 2 | 138(1.29) | C | — | | Weak film | | |
| b-PLLA2 | | | | | | | | | |
| PSLA4060- | 0.10 | 4 | 138(1.29) | B | — | | Weak film | | |
| b-PLLA4 | | | | | | | | | |
| PSLA4060- | 0.10 | 8 | 138(1.29) | A | 386 | 58.6 ± 4.8 | 2.9% ± 0.7% | 31.5 ± 3.4 | 1.39 ± 0.10 |
| b-PLLA8 | | | | | | | | | |
| PSLA4060- | 0.10 | 16 | 138(1.29) | A | 524 | 85.1 ± 2.4 | 11.9% ± 1.2% | 37.3 ± 10.6 | 3.94 ± 0.55 |
| b-PLLA16 | | | | | | | | | |

*Characterization measurements were skipped for PSLA-b-PLLA without uniform nanofibrous morphologies and/or produce very weak film after phase separation. Mechanical properties and conjugation data were acquired from 3 replicates of nanofibrous films.

### Structure of PSLA-b-PLLA Nanofibers and Improved Mechanical Properties

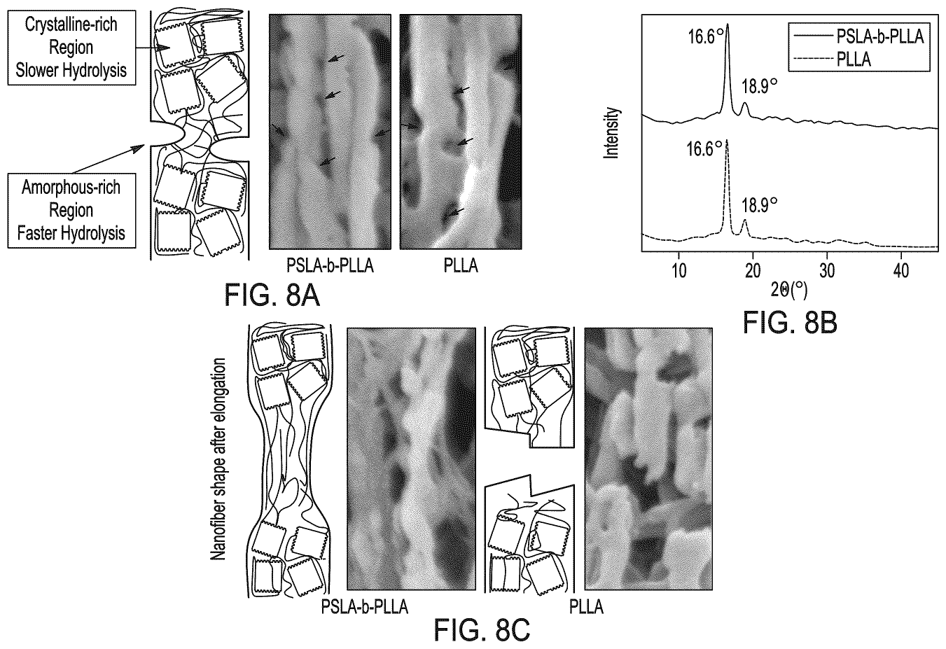

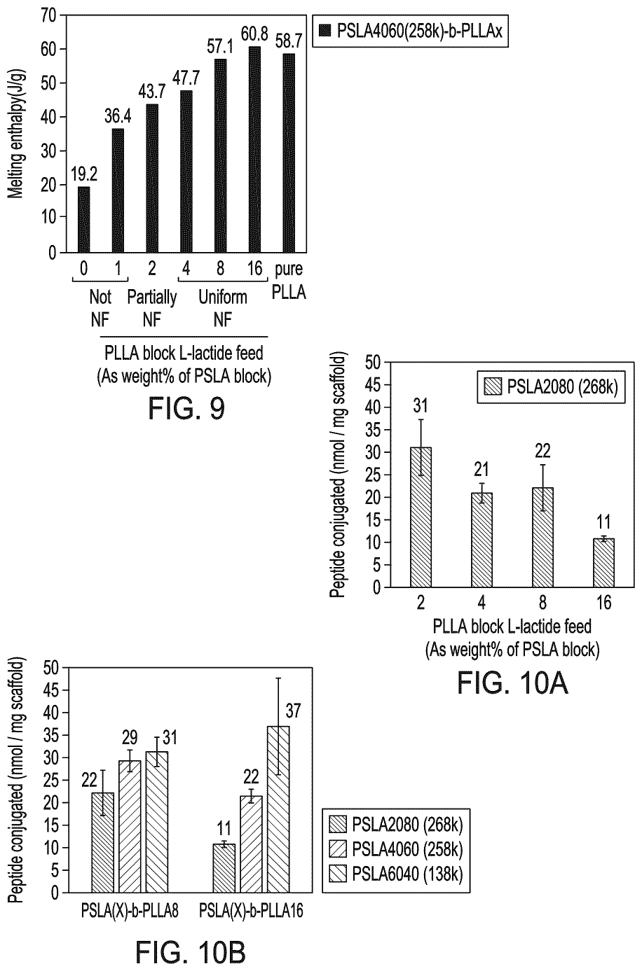

Alkaline treatment of nanofibrous PLLA or PSLA-b-PLLA (composition: PSLA4060(258k)-b-PLLA16) films with NaOH was performed to identify the amorphous region which hydrolyzed faster than the crystalline region. It was found that both PLLA and PSLA-b-PLLA displayed kebab-like structures (diameters changed along fibers) after hydrolysis, meaning the distribution of crystalline regions inside nanofibers was similar (see FIG. 8A). Since PLLA had a higher melting enthalpy (58.7 J/g) compared to PSLA (19.2 J/g) after phase separation (FIG. 9), it was assumed that the crystalline region mainly consisted of the PLLA blocks, and the amorphous region mainly consisted of the PSLA chains. In addition, the X-ray diffraction (XRD) spectrum of PLLA and PSLA-b-PLLA showed identical peaks, which suggested that the crystalline structures of both polymers were the same. These results are shown in FIG. 8B, and demonstrated that the crystalline regions were essentially composed of lactic acid repeating unit.

SEM images of PLLA and PSLA-b-PLLA nanofibers were observed and compared after tensile testing. These are shown in FIG. 8C. PSLA-b-PLLA nanofibers showed thin and kebab-like structures after elongation, while PLLA nanofibers showed fractured shapes. This difference was observed at both the fractured part and the elongated part of nanofibrous films (FIG. 9). Since the crystalline region of PLLA and PSLA-b-PLLA likely consisted of PLLA, it was assumed that the elongation was mainly contributed by the amorphous-rich PSLA region in the PSLA-b-PLLA nanofibers. This was consistent with the observation that PSLA contributed to elongation.

### The Effect of PSLA-b-PLLA Composition on its Conjugation Densities

Peptide conjugation density was measured for various compositions of PSLA-b-PLLA 3D nanofibrous films using a high peptide feeding (around 100 nmol peptide per mg of PSLA-b-PLLA) (Table 2). It was found that decreasing PLLA block length (see FIG. 10A) or increasing the Spiro-la ratio in PSLA chains (see FIG. 10B) increased peptide conjugation density, both due to the increasing conjugation sites per weight of the polymer. Among all compositions of PSLA-b-PLLA nanofibrous films, up to 73.3 nmol/mg of peptide conjugation density was achieved (Table 2).

### Selection of PSLA-b-PLLA Composition

Among all PSLA-b-PLLA compositions studied (Table 2), several candidates with tensile modulus higher than or equal to that of pure PLLA were selected for further testing (Table 3). The polymers in the table were labeled with the molecular weight of each block (the PLLA block was calculated by the difference of total Mn and PSLA block Mn). Among these samples, toughness was calculated as a relative ratio to PLLA, proportional to the energy that the nanofibrous material absorbed before fracture (Table 3). Strain at break, ultimate strength, relative toughness to PLLA, and peptide conjugation density were considered. Among the samples, PSLA2080(268k)-b-PLLA(235k) had the best mechanical properties, with the highest tensile modulus (130 MPa, 1.2× of PLLA), strain at break (36.4%, 12.1times that of PLLA) and 35.1 times the toughness of that of PLLA. PSLA4060(258k)-b-PLLA(361k) had the second highest tensile modulus and strain at break, with 25.4 times the toughness of PLLA, while its peptide conjugation density (21.6 nmol/mg) was 2.0 times that of PSLA2080(268k)-b-PLLA(235k). Considering a balance between physical properties and peptide conjugation density, the composition PSLA4060(258k)-b-PLLA(361k) was selected for 3D scaffold fabrication.

TABLE 3
Selection of PSLA-b-PLLA composition for Scaffolds

| | | | | | | Peptide |
|---|---|---|---|---|---|---|
| | | Tensile | | Ultimate | relative | conjugation |
| | Total | modulus**/ | Strain at | strength**/ | toughness | density*** |
| Candidates* | Mn | MPa | break** | MPa | to PLLA ** | (nmol/mg) |
| PSLA2080(99k)-b- | 268k | 121 ± 13 | 5.8% ± 1.3% | 2.5 ± 0.2 | 2.7 ± 0.6 | 23.5 ± 4.7 |
| PLLA(169k) | | | | | | |
| PSLA2080(172k)-b- | 354k | 111 ± 2 | 16.8% ± 1.3% | 4.6 ± 0.4 | 13.4 ± 0.4 | 13.2 ± 1.4 |
| PLLA(182) | | | | | | |
| PSLA2080(268k)-b- | 342k | 108 ± 12 | 20.4% ± 7.4% | 3.1 ± 0.4 | 13.3 ± 6.1 | 22.1 ± 5.2 |
| PLLA(74k) | | | | | | |
| PSLA2080(268k)-b- | 503k | 130 ± 8 | 36.4% ± 2.2% | 4.8 ± 0.8 | 35.1 ± 2.5 | 10.9 ± 0.6 |
| PLLA(235k) | | | | | | |
| PSLA4060(258k)-b- | 619k | 113 ± 8 | 28.1% ± 4.6% | 4.4 ± 0.4 | 25.4 ± 4.2 | 21.6 ± 1.4 |
| PLLA(361k) | | | | | | |

Standard

| | | | | | | |
|---|---|---|---|---|---|---|
| Pure PLLA | 176K | 110 ± 4 | 3.0% ± 0.4% | 2.3 ± 0.6 | 1 | NA |

*Number average molecular weight (Mn) of PSLA block was obtained from GPC, and the difference of total Mn and PSLA block Mn was used for PLLA block Mn.
**Measured from tensile tests on nanofibrous films. Relative toughness is the ratio of the area below stress-strain curve for each sample compared to PLLA, N = 3.
***Measured from nanofibrous films (5 mm diameter and 0.2 mm thickness) with 0.1 mg P24 peptide feed per film, N = 3.

Morphologies and Degradation Properties of 3D Porous Scaffolds Made from PSLA-b-PLLA

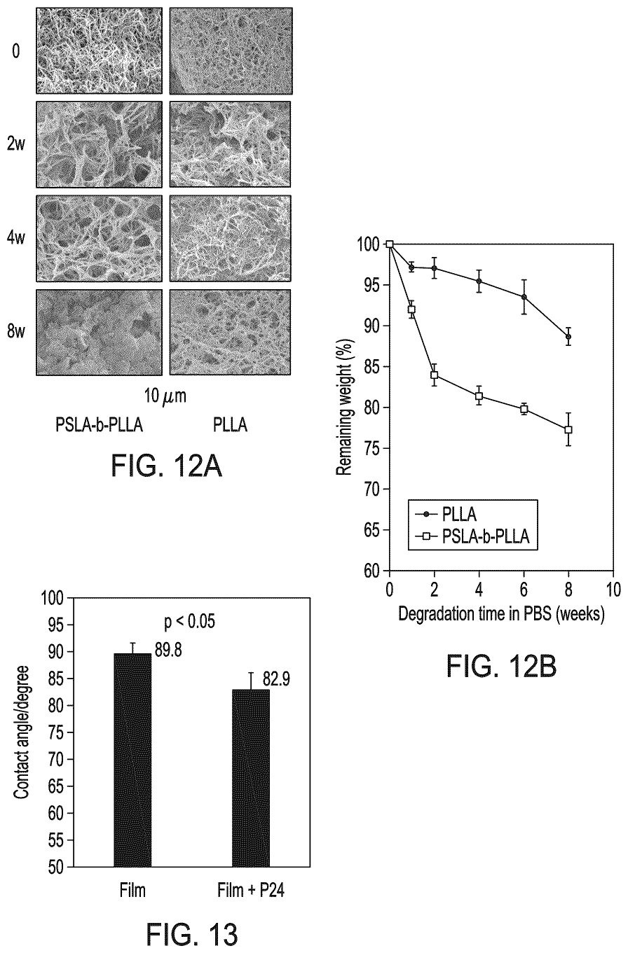

The degradation of PSLA4060(258k)-b-PLLA(361k) 3D nanofibrous scaffolds was compared to that of PLLA scaffolds made from the TIPS-porogen leaching procedure. SEM images showed uniform nanofibrous structures on 3D scaffolds (FIG. 12A). The degradation of PSLA-b-PLLA 3D scaffolds was significantly faster (p<0.01) than PLLA as measured from the first week to the eighth week (FIG. 12B). At the 8^{th} week, PLLA 3D scaffolds lost 11% weight, while PSLA4060(258k)-b-PLLA(361k) lost 23% weight. Nanofibers of PSLA4060(258k)-b-PLLA(361k) deformed faster as indicated in SEM images. At 8 weeks, the fibers of PSLA-b-PLLA showed a merged morphology at a high magnification image, while fibers of PLLA remained mostly separated (FIG. 12A). This difference may be due to the PSLA chains in the block copolymer, which are primarily in the amorphous regions and degrade faster.

### Peptide Conjugation on PSLA-b-PLLA 3D Scaffolds

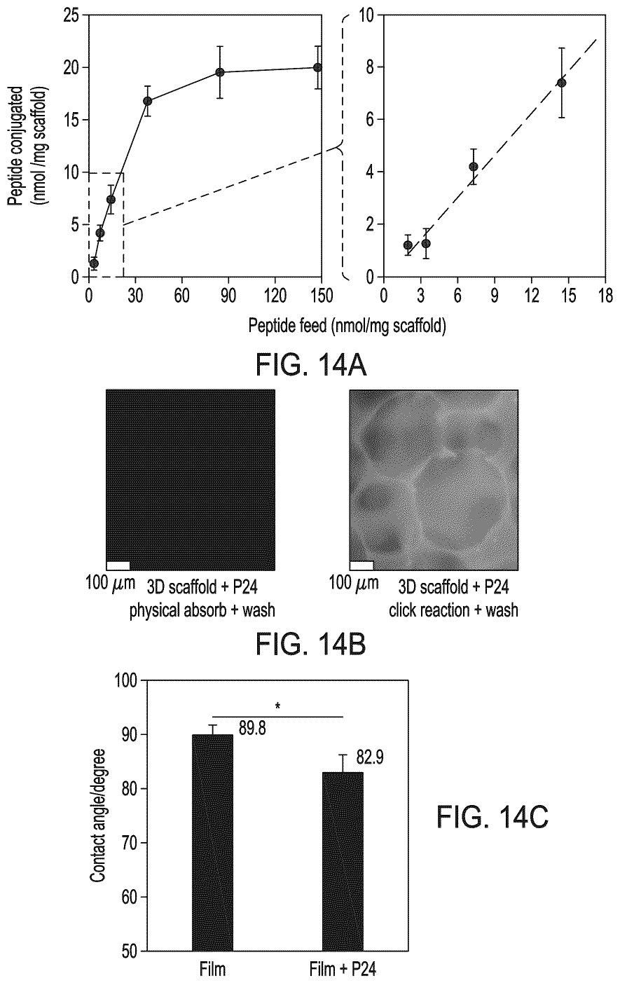

To explore the relationship between peptide feeding and conjugation on 3D scaffolds instead of films, an array of P24 peptide concentrations was used for the click reaction on PSLA-b-PLLA 3D scaffolds (FIG. 14A). When peptide feeding was lower than 15 nmol/mg, the conjugation ratio (conjugated peptide divided by fed peptide) was around 50%, while at a higher feeding amount of peptide, the conjugated peptide showed saturation-like behavior and the amount can no longer increase, likely reached the limit of available surface functional groups. This allowed conjugation of peptides in a controlled manner, especially when the peptide feeding was in the linear range. To visualize peptide conjugation, FITC-labeled peptide was conjugated on 3D scaffold (5 mm diameter, 1 mm thickness) with extensive wash (50 ml PBS, change three times every day for 1 week). Green fluorescence signals were found on the reacted scaffolds after wash, while physical-absorbed samples for the same reaction time did not display the fluorescence signal, suggesting persistent conjugation after click reaction (FIG. 14B). Contact angle was also measured, which showed a significant (p<0.05) decrease after conjugation, suggesting the increase of surface hydrophilicity after peptide modification (FIG. 14C and FIG. 13).

In Vivo Study of Cell-Free PSLA-b-PLLA 3D Porous Scaffold with BMP-2 Derived Peptide Conjugation Using a Mouse Critical-Sized Calvarial Defect Regeneration Model

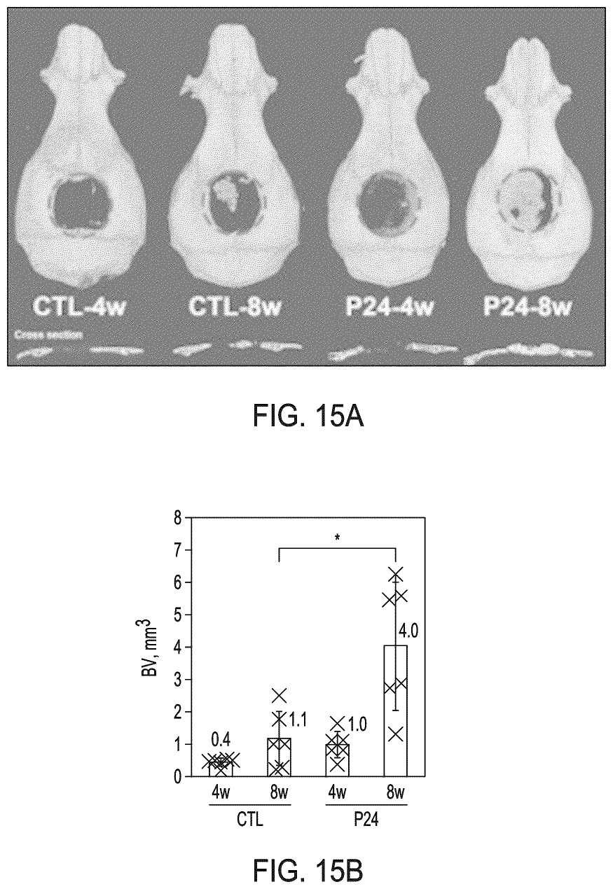

PSLA-b-PLLA 3D nanofibrous scaffolds were fabricated using the TIPS-porogen leaching method and cut into cylinders of 5 mm diameter and 1 mm thickness. A BMP2-derived peptide, P24, was conjugated on PSLA-b-PLLA 3D nanofibrous scaffold at a feeding of 100 μg per scaffold or around 7 nmol/mg of feeding concentration. PSLA-b-PLLA 3D scaffolds with no peptide conjugation were used as controls. Mice (C57BL/6J, male, with ages of 3-6 months) critical-sized calvaria defects with 5-mm diameter were created and cell-free scaffolds were implanted at the defect site. Skull samples were collected 4 weeks and 8 weeks after implantation. The micro-CT images shown in FIG. 15A indicated that both control and peptide-conjugated scaffolds supported bone regeneration as evaluated at 4 weeks to 8 weeks. The scaffolds with P24 peptide regenerated larger volumes of bone compared to control scaffolds at both timepoints (FIG. 15B). The bones had spongy morphologies, suggesting regeneration took place inside the interconnected pores. Quantitative analysis showed a significant difference in bone volume (p<0.05) between P24 and control groups at both 4 weeks and 8 weeks. There was also significant difference (p<0.05) of bone volumes of P24 groups between 4 and 8 weeks. At 4 weeks, the bone volume of the P24 group was 2.5 times that of the control group on average, while at 8 weeks the ratio was 3.6 (FIG. 15B). These results suggested a strong boost of bone regeneration with P24 conjugated PSLA-b-PLLA 3D scaffolds.

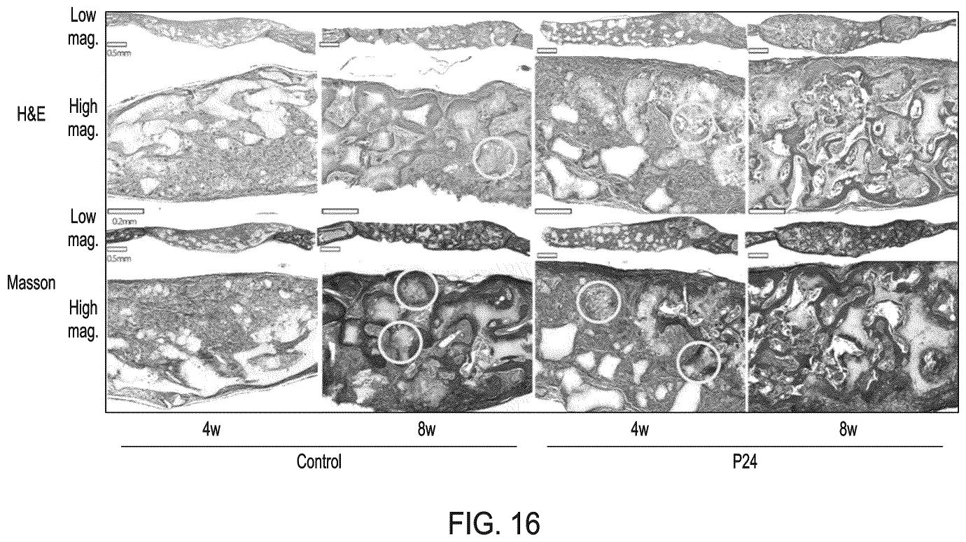

Histological staining was performed, and the results are reproduced in black and white in FIG. 16. The results were consistent with micro-CT quantification, where both control and P24 groups had increased bone formation at 8 weeks after surgery compared to those 4 weeks. At both 4 weeks and 8 weeks after surgery, P24 groups had increased collagen amounts (stained as blue in trichrome staining) and more mature bone (stained as dark red in trichrome staining) than control groups (FIG. 16). The P24 group at 4 weeks showed cartilage-like structures (marked with circles), while the control did not. Cartilage-like structures were found in the control group at 8 weeks, while the P24 group at 8 weeks showed a marrow-like structure surrounded by high volumes of mature bone (stained as purple in H&E and red in trichrome).

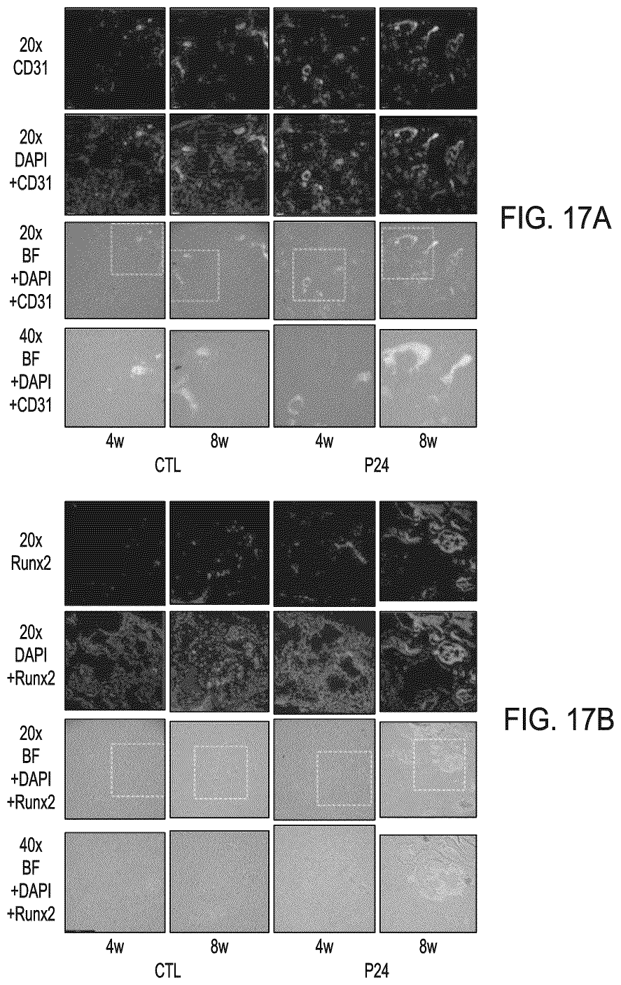

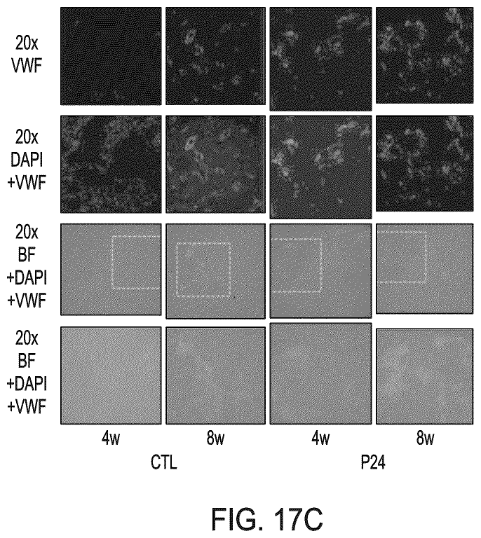

Immunofluorescence (IF) images were acquired from harvested samples 4 and 8 weeks after scaffold implantation, and these results are present in FIG. 17 in black and white. CD31 (A in FIG. 17) and Von Willebrand Factor (VWF) (C in FIG. 17) were used to visualize vascularization and runt-related transcription factor 2 (Runx2) (B in FIG. 17) was used to analyze osteogenic differentiation. At 8 weeks, the control PSLA-b-PLLA scaffolds showed vessel-like structures as well as marrow-like structures, suggesting that the copolymer described herein was biocompatible and supported bone regeneration. At 4 and 8 weeks, P24-conjugated scaffolds showed elevated fluorescence signal for CD31, VWF and Runx2, suggesting that P24 peptide prompted blood vessel formation and osteogenic bone formation.

### DISCUSSION

Although 3D nanofibrous PLLA scaffolds have shown promise in various tissue engineering studies, there remain challenges towards clinical application. Some of the desired scaffold features and properties are conflicting. For example, high porosity is desired in promoting cellular migration, vascularization, and facilitating mass transfer of nutrients and metabolic wastes. However, high porosity usually results in poor mechanical properties. Bioactive molecule incorporation into scaffolds can improve bioactivities to regulate desired cellular behavior, but this could also change degradation and mechanical properties not necessarily in a desired way. These conflicting factors are also true with nanofibrous PLLA 3D scaffolds. It has been demonstrated that PLLA-based copolymers with low L-lactide fractions had a reduced ability to form nanofibrous morphology. Therefore, PLLA should be a major part of the copolymer to form nanofibrous structures. However, PLLA does not have functional groups for conjugating bioactive components, such as peptides, proteins, and polysaccharides. In addition, even pure PLLA does not have ideal mechanical properties in terms of strain at break and toughness.

As demonstrated in Example 1, PLLA nanofibers break at a low elongation of 3% (FIG. 7A through FIG. 7C). The introduction of functional groups might further reduce the mechanical properties of the PLLA scaffolds, enlarging the shortcomings of low toughness. To keep the benefits of PLLA polymer, especially the unique nanofibrous morphology along with biocompatibility and biodegradability, and at the same time improve mechanical properties and introduce functional groups, the copolymers disclosed herein were generated.

Not only did PSLA-b-PLLA inherit the TIPS-induced nanofibrous features of PLLA scaffolds, but it also had better mechanical properties, namely higher toughness, than PLLA, with the ability to covalently conjugate bioactive components, such as peptides. This has been achieved by the two-step TBD, which involved low-temperature copolymerization with L-lactide and a functionalized monomer, Spiro-la (FIG. 1A). This block copolymer design, PSLA-b-PLLA, enables the use of the PSLA chain to provide conjugation sites, and the PLLA block to provide nanofiber-forming TIPS behavior.

The ratios of L-lactide and Spiro-la in the PSLA blocks were controlled by their feeding ratios, the sizes of the PSLA blocks were controlled by TBD concentrations, and the sizes of the PLLA blocks were controlled by the L-lactide-to-PSLA block ratios (FIG. 5A and FIG. 5B, Table 2). The compositions of the products covered 20-60% of Spiro-la for the PSLA block, and high molecular weight (e.g., 619 kg/mol in number average molecular weight) of the whole polymer. Compositions were then selected based on the ability to form PLLA-like nanofibers after TIPS procedures. It was found that a high PLLA block length was generally beneficial for the nanofibrous morphology (FIG. 6A and FIG. 6B).

There was an unexpected improvement of PSLA-b-PLLA over PLLA in its mechanical properties. For porous 3D scaffolds, both stiffness and toughness are desired, where stiffness retains the porous shapes, and toughness prevents fragile fracture of the scaffolds. Pure PLLA is known as a brittle (low toughness) material and tends to fracture under deformation. PSLA-b-PLLA, on the other hand, demonstrated a greatly improved elongation and toughness. Long PSLA chains were found to contribute to the elongation, and both long PLLA blocks and long PSLA chain could improve the stiffness (FIG. 7A through FIG. 7C, Tables 1A-1C and 2). The 3D nanofibrous PSLA-b-PLLA scaffolds were dramatically more resistant to fracture than those made of PLLA. Among a range of PSLA-b-PLLA compositions, nanofibrous films with the best mechanical properties achieved 1.2 times the tensile modulus, 12.1 times the strain at break, 2.1 times the ultimate strength, and 35.1 times the toughness of PLLA nanofibrous films. These mechanical properties make the PSLA-b-PLLA block copolymer a better material for maintaining the outer shape and interconnected pores of the scaffolds required for tissue engineering.

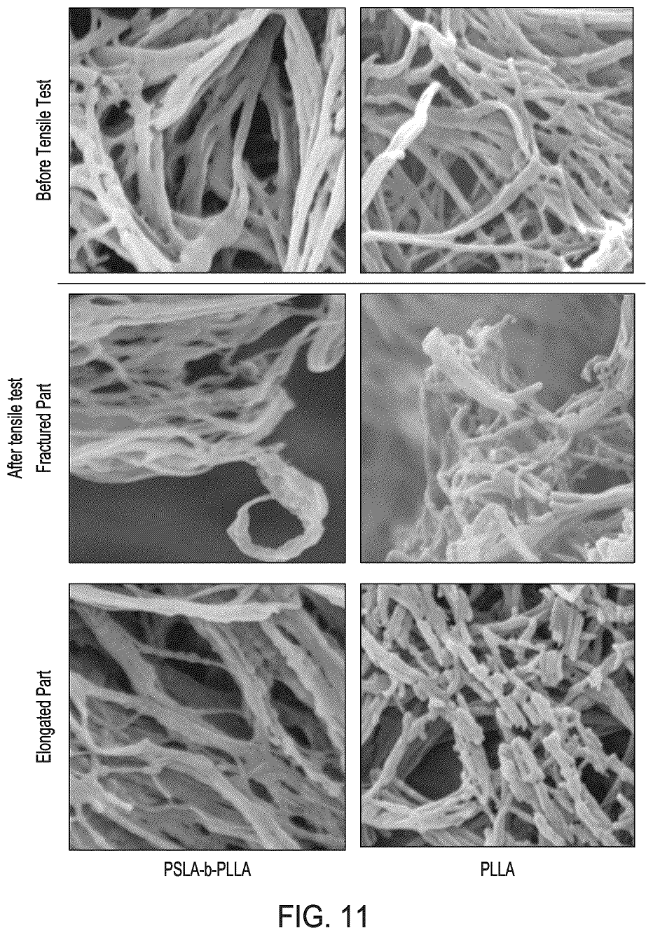

The semi-crystalline PLLA goes through slower and uneven hydrolysis under alkaline treatment, due to the faster degradation of amorphous regions. Therefore, amorphous and crystalline regions can be distinguished by observing the shapes of nanofibers after surface erosion by alkaline. The kebab-like structure of degraded PLLA and PSLA-b-PLLA nanofibers suggested an alternating pattern of the crystalline-rich region and amorphous-rich region of the nanofibers (FIG. 8A through FIG. 8C). It is believed that the PSLA chains mainly presented in the amorphous regions because PSLA is a random copolymer chain and is less likely to fit in highly regular crystalline lattice, and the PLLA blocks mainly presented in the crystalline regions because of its highly regular chain to fit in a crystalline lattice. To understand how the alternating crystalline and amorphous structures improved the mechanical properties, the shape of nanofibers were examined after tensile tests. PSLA-b-PLLA nanofibers showed elongated, aligned, and kebab-like structures after elongation, while PLLA nanofibers showed fractured shapes and random alignments after elongation (FIG. 8A through FIG. 8C and FIG. 11). This result suggested that the PSLA-rich amorphous regions mainly contributed to the high elongation in the PSLA-b-PLLA block copolymer nanofibers. For PSLA-b-PLLA, the PLLA chains were likely primarily crystallized and distributed in the crystalline regions, while the PSLA chains in the amorphous domains were easily deformed leading to high strain at break as well as higher toughness. However, the PLLA segments in the amorphous domains of PLLA homopolymers were likely shorter because they also presented in neighboring crystalline domains. These shorter and more restricted PLLA segments likely resulted in shorter elongation at break as well as lower toughness. The XRD spectrum agreed with this assumption since nanofibrous PLLA and PSLA-b-PLLA showed identical peaks (FIG. 5B).

Apart from mechanical properties, the double bond on each Spiro-la repeating unit allowed covalent surface peptide conjugation, reaching a tunable maximum peptide conjugation density of 73.3 nmol/mg (FIG. 10A and FIG. 10B and Table 2), and provided a linear-like relationship between fed peptide and conjugated peptide at the lower peptide concentrations (FIG. 14A through FIG. 14C). The covalent conjugation of peptides, proteins, polysaccharides, and so forth enables the introduction of bioactivity and/or hydrophilicity. As a biodegradable polyester, the degradation rate of the PSLA-b-PLLA scaffold was also faster, resulting in 2.1 times the weight loss compared to PLLA at 8 weeks (FIG. 12B). This was likely due to the amorphous PSLA since amorphous regions of polyesters are known to degrade faster through an increased water diffusion mechanism.

Synthetic short peptides are flexible in design and suitable for covalent conjugation, and can specifically bind to cell receptors. P24 peptide was covalently conjugated to cell-free PSLA-b-PLLA scaffolds and implanted in mouse critical-sized calvaria defects. Bone volume increased from 4 to 8 weeks in both control PSLA-b-PLLA scaffolds and peptide-conjugated PSLA-b-PLLA scaffolds. Scaffolds with P24 peptide conjugation supported 3.6 times more bone volume regeneration compared to the control scaffold without peptide (FIG. 15A and FIG. 15B). The bone formation displayed the characteristics of endochondral ossification, with early cartilage to later mineralized bone transition based on histological staining (FIG. 16). Further examinations using immunofluorescent (IF) staining demonstrated association of increased vascularization with osteogenesis at later stages of bone regeneration (FIG. 17). The vascularization of P24-conjugated scaffolds was confirmed by the expression of CD31 and VWF markers and osteogenesis by Runx2, together with trichrome and micro-CT analyses. IF staining showed that both markers expressed at 4 and 8 weeks, where improved expressions were found in P24-conjugated scaffolds. These results demonstrated that peptide-conjugated PSLA-b-PLLA 3D nanofibrous scaffolds supported vascularization and enhanced bone regeneration recapitulating endochondral ossification in development.

Chemically incorporating biomolecules on scaffolds can improve biological properties for regeneration, but such structural changes, particularly by copolymerization, frequently lead to undesired changes in physical and mechanical properties, compromising their performance. The block copolymer, PSLA-b-PLLA, achieved a nanofibrous morphology, maintained or improved mechanical properties over those of the homopolymer, and provided the ability to covalently conjugate biomolecules. Thus, PSLA-b-PLLA enables advanced bimolecularly-activated 3D nanofibrous scaffolds for tissue engineering. The synthesis route enables PSLA-b-PLLA block copolymer of controllable compositions and molecular weights to be formed. The prepared nanofibrous PSLA-b-PLLA films achieved up to 1.2 times the tensile modulus, 12.1 times the strain at break, 2.1 times the ultimate strength, and 35.1 times the toughness compared to those of the reference commercial PLLA. Structural analysis suggested that the dramatically improved mechanical properties were related to the kebab-like alternating crystalline-rich and amorphous-rich regions along the nanofibers. While the PLLA-rich crystalline domains and molecular weight of both PLLA chains and PSLA chains contributed to the modulus and ultimate strength of the block polymer nanofibers, the long and extendable PSLA copolymer chains primarily in the amorphous domains contributed to the high elongation at break of the nanofibers. The combined high modulus and high strength attributed to the crystalline domains and molecular weights, and the high extensibility attributed to the PSLA in the amorphous domains, synergistically resulted in the dramatically increased toughness of 35 times that of the reference commercial PLLA. The scaffold maintained its 3D shape and internal pore structures, supported vascularization and osteogenesis in a mouse critical-sized bone defect regeneration model. The covalently attached BMP-2 derived P24 peptide on the PSLA chains of the PSLA-b-PLLA block copolymer nanofibrous scaffold increased 3.6 times bone volume regeneration over the control scaffold without P24 peptide. These results showed that PSLA-b-PLLA nanofibrous 3D scaffolds were mechanically advantageous and biologically enhanced new bone tissue formation because the conjugated peptides remained bioactive after implantation. The scaffold disclosed herein combines stable macroscale shape, microscale inter-connected pore structure, nanoscale fiber size to mimicking matrix collagen protein, and molecularly regulate bone regeneration potential through a comprehensive multiscale design. Moreover, these block copolymer scaffolds have high potential to be biologically functionalized to enhance other types of tissue regeneration.

As illustrated by the results in this example, PSLA-b-PLLA greatly improved the mechanical properties over PLLA or even polymer blends of PLLA and an amorphous polymer. In comparison with PLLA, PSLA-b-PLLA exhibits up to 1.2 times tensile modulus, 12.1 times strain at break, 2.1 times ultimate strength and 35.1 times toughness of PLLA, while being able to conjugate bioactive molecules covalently using click reactions. The degradation rate of PSLA-b-PLLA was also accelerated to facilitate tissue regeneration. PSLA-b-PLLA also exhibited 3.6 times more vascularized bone volume regeneration when covalently conjugated with a bone-morphogenetic-protein-2-derived peptide.

### Example 2

### Synthesis of Diblock Copolymer, PCL-b-PSLA2080

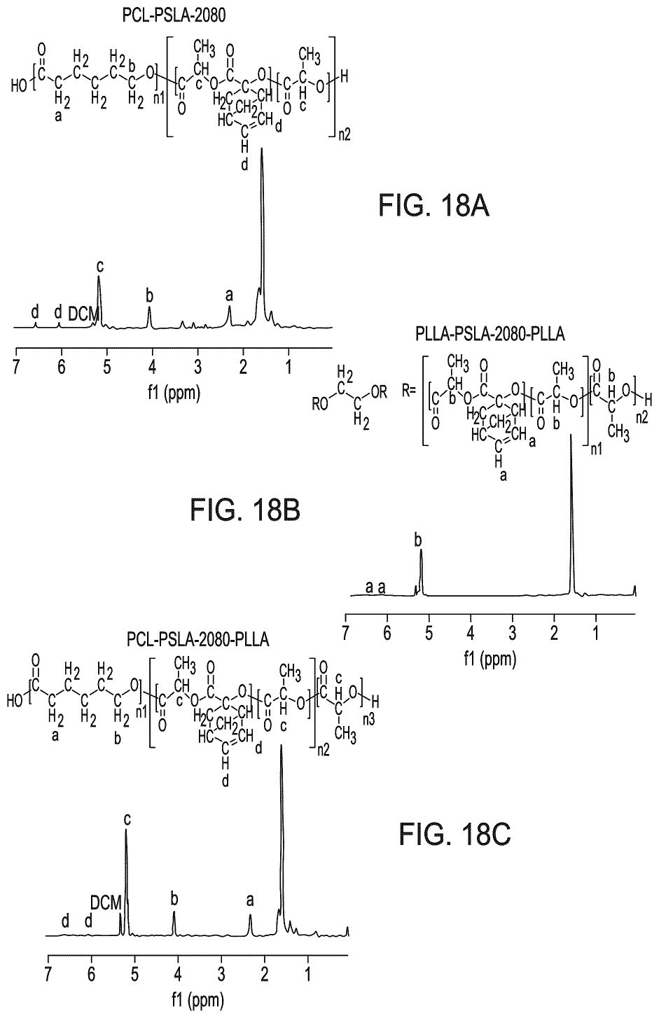

Commercial PCL (Mn=137 kg/mol) was used as the first block. A mixture of PCL:Sprio-la:La with a weight ratio of 1:2:8 was dissolved in DCM (such that the total polymer and monomer concentration was 10 wt %). A TBD solution (0.8 mol % of the sum of the Sprio-la and La monomers) was added, following the procedure described in Example 1. NMR and GPC characterization of the product are shown in FIG. 18A. The block number average molecular weight was calculated by the difference before and after copolymerization. These results are shown in Table 4.

TABLE 4

| Block | Mn (kg/mol) |
|---|---|
| PCL | 137 |
| PSLA2080 | 33 |

### Example 3

### Synthesis of ‘ABA’ Type Triblock Copolymer, PLLA-b-PSLA2080-b-PLLA

In this example, ethylene glycol was used as the initiator. A mixture of ethylene glycol:Sprio-la:La with a mole ratio of 1:40:60 was dissolved in DCM (such that the total polymer and monomer concentration was 10 wt %). A TBD solution with 0.1 mol % of the sum of the monomers was used in the reaction after the container was cooled to −80° C. The reaction conditions and purification of the reaction were identical to those for the synthesis of PSLA in Example 1. A 1:4 weight ratio of purified first step product and La and a TBD solution (0.1 mol % of La) was used for the second step as discussed in Example 1. NMR and GPC characterization of the product are shown in FIG. 18B. The block number average molecular weight was calculated by the difference before and after copolymerization. These results are shown in Table 5.

TABLE 5

| Block | Mn (kg/mol) |
|---|---|
| PSLA2080 | 109 |
| PLLA | 148 |

### Example 4

### Synthesis of ‘ABC’ Type Triblock Copolymer, PCL-b-PSLA2080-b-PLLA

PCL-b-PSLA was synthesized as described in Example 2. A mixture of PCL-b-PSLA and La with a weight ratio of 1:10 was dissolved in DCM (such that the total copolymer and monomer concentration was 10 wt %). A TBD solution with 0.1 mol % of La was used. The reaction conditions and purification procedure were identical to that of PSLA-b-PLLA (Example 1). NMR and GPC characterization of the product are shown in FIG. 18C and Table 6. The third block, PLLA, can be identified by comparing the NMR spectrum or GPC data before (FIG. 18A and Table 6) and after the reaction (FIG. 18C and Table 6).

The block number average molecular weight was calculated by the difference before and after copolymerization. These results are shown in Table 6.

TABLE 6

| Block | Mn/kg*mol⁻¹ |
|---|---|
| PCL | 137 |
| PSLA2080 | 33 |
| PLLA | 52 |

### TIPS Films and Mechanical Properties

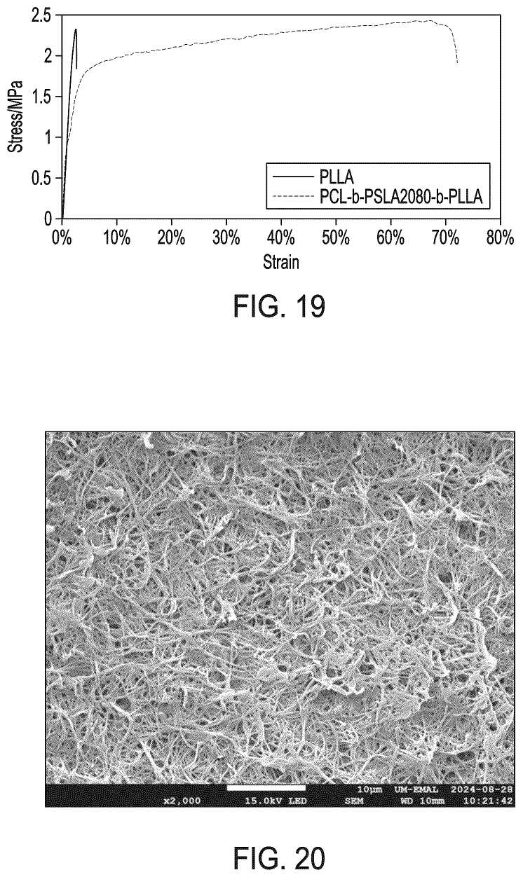

Nanofibrous films were formed with PCL-b-PSLA2080-b-PLLA using the TIPS procedure described in Example 1. The addition of the PCL block in the PSLA-containing triblock copolymer greatly improved the elongation ability and toughness of the films generated through TIPS. Nanofibrous PCL-b-PSLA2080-b-PLLA films achieved 67% strain at break and 55 times of the toughness compared to pure PLLA. This toughness was also higher than any PSLA-b-PLLA films described in the above examples. The nanofibrous morphology and tensile behaviors of nanofibrous PCL-b-PSLA2080-b-PLLA films are shown, respectively in FIG. 19 and FIG. 20.

### Example 5

### Synthesis of Block Copolymers

PSLA-b-PLLA was prepared as described in Example 1. Different PCL-b-PSLA-b-PLLA triblock copolymers were prepared as described in Example 4. The synthesis conditions and/or molecular weights of the various blocks are shown in Table 7.

TABLE 7

| Polymer | | Second block | Third block | Final |
|---|---|---|---|---|
| number | First block | reaction | reaction | composition |
| 1 | PCL (137k) | Spiro-la:l-lactide = 20:80, | Spiro-la:l-lactide = 0:100, | PCL(137k)-b- |
| | | monomer:initiator = 4:1 | monomer:initiator = 16:1 | PSLA2080(178k)-b- |
| | | | | PLLA(551k) |
| 2 | PCL (50k) | Spiro-la:l-lactide = 20:80, | Spiro-la:l-lactide = 0:100, | PCL(50k)-b- |
| | | monomer:initiator = 16:1 | monomer:initiator = 16:1 | PSLA2080(106k)-b- |
| | | | | PLLA(532k) |
| 3 | PCL (50k) | Spiro-la:l-lactide = 40:60, | Spiro-la:l-lactide = 0:100, | PCL(50k)-b- |
| | | monomer:initiator = 12:1 | monomer:initiator = 16:1 | PSLA4060(60k)-b- |
| | | | | PLLA(230k) |
| 4 | PCL (50k) | Spiro-la:l-lactide = 60:40, | Spiro-la:l-lactide = 0:100, | PCL(50k)-b- |
| | | monomer:initiator = 12:1 | monomer:initiator = 16:1 | PSLA6040(54k)-b- |
| | | | | PLLA (562k) |

Different reaction conditions, namely the length of PCL block and the ratio and amount of Spiro-la and L-lactide monomers in PSLA, yielded different polymer compositions. The diblock copolymer PSLA4060(258k)-b-PLLA(361k) described in Example 1 was used a positive control in this Example.

### Electrospinning to Form Fibrous Tubular Scaffolds

PSLA-b-PLLA, PSLA4060(258k)-b-PLLA(361k), and the different PCL-b-PSLA-b-PLLA triblock copolymers (shown in Table 7) were respectively dissolved in DCM to achieve solutions of 4 wt % concentration. Each solution was extruded from a 10 ml syringe fitted with an 18-gauge nozzle at a speed of 1 ml per minute. A 3-mm-diameter steel rod mounted on a 120-rpm rotor served as a collector, with a collector-nozzle distance of 20 cm and a voltage of 20 kV in between. A longer distance of 30 cm may also be used to produce smaller electrospun fiber diameters. After 5 minutes of extrusion, the fiber-coated steel rods were retrieved and dried in a fume hood for 12 hours. The coated fibrous layer was cut and removed from the rods to form tubular scaffolds. Layer thickness ranged from 0.1 mm to 0.3 mm.

### Surface Morphologies and Mechanical Properties of the Tubular Scaffolds

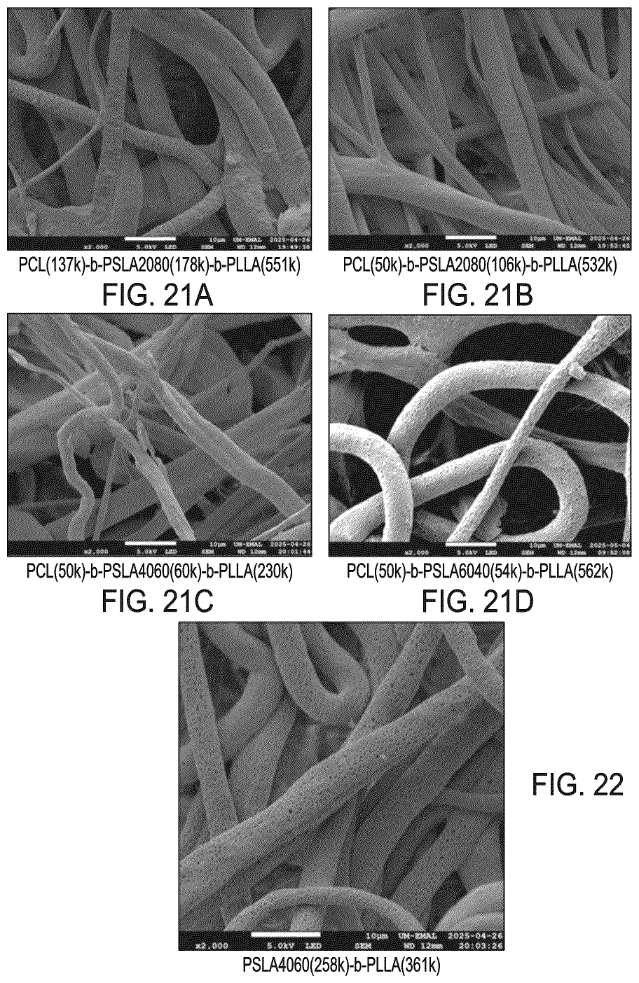

SEM images of the tubular scaffolds fabricated from the various PCL-b-PSLA-b-PLLA triblock copolymers were taken, and are shown in FIG. 21A through FIG. 21D. All of the electrospun fibers, which make up the fibrous layer of the tubular scaffolds, exhibited rough surfaces that were characterized by sub-micrometer-scale pores.

A SEM image was also taken of the tubular scaffold fabricated from PSLA4060(258k)-b-PLLA(361k), which is shown in FIG. 22. These fibers also included sub-micrometer-scale pores (e.g., from about 100 nm to about 1 μm), but had smoother surfaces than the fibers formed from the various PCL-b-PSLA-b-PLLA triblock copolymers.

The mechanical performance of the electrospun tubular scaffolds derived from the various PCL-b-PSLA-b-PLLA/DCM triblock copolymers and from PSLA4060(258k)-b-PLLA(361k) was tested and the results are presented in Table 8. The compliance was calculated from the stress-strain curve at 0-15% strain.

TABLE 8

| | | | | | | Conjugation |
|---|---|---|---|---|---|---|
| | | | Max | Burst | Compliance/% | density/nmol |
| Polymer | Type | Modulus/MPa | elongation | pressure/mmHg | per 100 mmHg | per mg |
| PSLA4060(258k)- | Diblock | 22.0 ± 3.1 | 144% ± 10% | 16149 ± 695 | 3.3 ± 0.3 | 15.6 ± 1.1 |
| b-PLLA(361k) | copolymer | | | | | |
| PCL(137k)-b- | Triblock | 24.7 ± 5.0 | 87% ± 13% | 10153 ± 1168 | 6.2 ± 1.0 | 10.1 ± 3.1 |
| PSLA2080(178k)- | copolymer | | | | | |
| b-PLLA(551k) | | | | | | |
| PCL(50k)-b- | Triblock | 24.8 ± 5.9 | 91% ± 12% | 12011 ± 1795 | 2.9 ± 0.7 | 8.9 ± 1.9 |
| PSLA2080(106k)- | copolymer | | | | | |
| b-PLLA(532k) | | | | | | |
| PCL(50k)-b- | Triblock | 27.5 ± 6.8 | 132% ± 24% | 24466 ± 3173 | 2.1 ± 0.6 | 7.4 ± .3 |
| PSLA4060(60k)- | copolymer | | | | | |
| b-PLLA(230k) | | | | | | |
| PCL(50k)-b- | Triblock | 25.2 ± 9.0 | 162% ± 18% | 10693 ± 1149 | 4.4 ± 0.7 | 16.4 ± 0.2 |
| PSLA6040(54k)- | copolymer | | | | | |
| b-PLLA (562k) | | | | | | |

All scaffolds demonstrated high burst pressures, ranging from 10153 mmHg to 24466 mmHg, significantly exceeding those of human internal mammary arteries or saphenous veins, both of which are a common reference for vascular grafts and are typically at or lower than 3500 mmHg. Many of the compositions, particularly the triblock copolymer with the longest PCL (137k) segment and the diblock copolymer (PSLA4060(258k)-b-PLLA(361k)), exhibited high compliance values, indicating that the mechanical properties are comparable to current commercial products such as GORETEX® graft or DACRON® graft (typically below 2% per 100 mmHg). Such compliance is particularly advantageous in applications where scaffold flexibility is critical, for instance, to reduce the risks of thrombosis or graft detachment.

### Films Formed Via Thermally Induced Phase Separation (TIPS)

Nanofibrous films were formed with the various PCL-b-PSLA-b-PLLA triblock copolymers and with PSLA4060(258k)-b-PLLA(361k) using the TIPS procedure described in Example 1.

### Surface Morphologies and Mechanical Properties of the TIPS Films

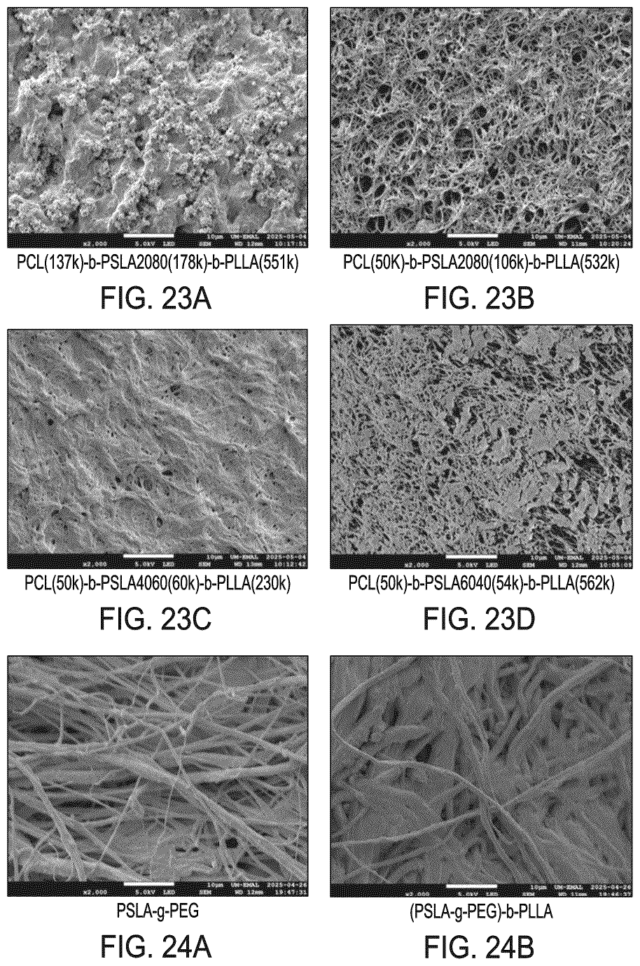

SEM images of the TIPS films fabricated from the various PCL-b-PSLA-b-PLLA triblock copolymers were taken, and are shown in FIG. 23A through FIG. 23D. The composition with the longest PCL block of 137k showed a separation of the nanofibrous area and amorphous area (see FIG. 23A). The results also indicate that the Spiro-la unit percentage in the PSLA block determines surface morphologies, where a large ratio of Spiro-la units resulted in merging fibers and more amorphous-like areas (see FIG. 23D). This is consistent with the results in Example 1. This result suggests that PCL block or PSLA block can be used to alter the surface morphology of PSLA-containing block copolymers under TIPS conditions.

The mechanical performance of the TIPS films derived from some of the PCL-b-PSLA-b-PLLA/DCM triblock copolymers and from PSLA4060(258k)-b-PLLA(361k) was tested and the results are presented in Table 9.

TABLE 9

| | | | Max | Ultimate |
|---|---|---|---|---|
| Polymer | Type | Modulus/MPa | elongation | strength/MPa |
| PSLA4060(258k)-b-PLLA(361k) | Diblock | 113.0 ± 8.0 | 28.1% ± 4.6% | 4.4 ± 0.4 |
| | copolymer | | | |
| PCL(137k)-b-PSLA2080(178k)-b- | Triblock | 395.7 ± 74.6 | 6.9% ± 4.2% | 15.0 ± 8.3 |
| PLLA(551k) | copolymer | | | |
| PCL(50k)-b-PSLA2080(106k)-b- | Triblock | 275.6 ± 11.4 | 14.2% ± 2.8% | 13.9 ± 2.3 |
| PLLA(532k) | copolymer | | | |
| PCL(50k)-b-PSLA4060(60k)-b- | Triblock | 255.8 ± 50.1 | 5.0% ± 4.0% | 9.4 ± 3.1 |
| PLLA(230k) | copolymer | | | |

The properties of the TIPS films made from PCL-b-PSLA-b-PLLA had higher modulus and ultimate strength, but lower elongation compared to the TIPS films made from the diblock copolymer, PSLA4060(258k)-b-PLLA(361k). The differences in the properties may be due to the fact that PCL exhibits difference properties than PLLA under phase separation.

### Example 6

### Synthesis of Graft Copolymers

To graft PEG on PSLA-containing copolymers, PSLA2080(268k) or PSLA4060(258k)-b-PLLA(361k) were used as respective main chains, and PEG(4k)-SH was used as the graft chain (see Table 10). The reaction scheme is illustrated in FIG. 1F. A thiol-ene reaction was conducted in 10 wt % DCM solution with 1 wt % of IRGACURE® 2959 as a catalyst and a main chain functional group:graft chain functional group ratio of 1:2. The solution was exposed to ultraviolet light for 30 minutes, followed by evaporation of the DCM and washing with ethanol 3 times and MilliQ water 3 times to remove excess PEG-SH and catalyst. The products were then freeze-dried and stored in a vacuum container.

TABLE 10

| Polymer | Main chain | Graft chain |
|---|---|---|
| PSLA-g-PEG | PSLA2080(268k) | PEG(4k) |
| (PSLA-g-PEG)-b- | PSLA4060(258k)-b- | PEG(4k) |
| PLLA | PLLA(361k) | |

### Electrospinning to Form Fibrous Tubular Scaffolds

PSLA-g-PEG or (PSLA-g-PEG)-b-PLLA were respectively dissolved in DCM to reach concentrations of 10 wt %. The solutions were respectively extruded from a 10 ml syringe with an 18-gauge nozzle at a speed of 1 ml per minute. A 3-mm-diameter steel rod on a 120-rpm rotor was used as a collector, where the collector-nozzle distance was 5 cm and the voltage in between was 20 kV. After 5 minutes of extrusion, the fiber-coated steel rods were retrieved and dried in a fume hood for about 12 hours. The coated fibrous layers were cut and removed from the rods to acquire the tubular scaffolds.

### Surface Morphologies and Mechanical Properties of the Tubular Scaffolds

SEM images of the tubular scaffolds fabricated from PSLA-g-PEG and (PSLA-g-PEG)-b-PLLA were taken, and are shown, respectively, in FIG. 24A and FIG. 24B. The graft copolymer electrospun fibers were thinner than the fibers formed with the block copolymers under the same voltage and collector-nozzle distance (comparing FIG. 24A and FIG. 24B with FIG. 21A through FIG. 21D).

The mechanical performance of the tubular scaffolds fabricated from PSLA-g-PEG and (PSLA-g-PEG)-b-PLLA was tested and the results are shown in Table 11.

TABLE 11

| | | | Max | Burst | Compliance/% |
|---|---|---|---|---|---|
| Polymer | Type | Modulus/MPa | elongation | pressure/mmHg | per 100 mmHg |
| PSLA-g-PEG | Graft | 18.0 ± 3.8 | 98% ± 27% | 2985 ± 652 | 50.4 ± 15.9 |
| | copolymer | | | | |
| (PSLA-g-PEG)- | Graft | 6.2 ± 0.6 | 123% ± 22% | 6373 ± 653 | 5.9 ± 2.2 |
| b-PLLA | copolymer | | | | |

PSLA-g-PEG tubes have a modulus of 18.0 MPa, but their compliance reaches a value of 50.4% per 100 mmHg, displaying high flexibility. The compliance of (PSLA-g-PEG)-b-PLLA tubes is also higher than the copolymer before grafting, reaching 5.9% (compared to 3.3% before grafting). Both graft copolymers exhibited high burst pressures within the range suitable for vascular grafting, although they were lower than the tubes formed with the triblock copolymers. The different properties observed for the tubular scaffolds formed with graft copolymers indicate that grafting is a powerful and effective way to change the properties of PSLA-containing copolymers.

### Films Formed Via Thermally Induced Phase Separation (TIPS)

Nanofibrous films were formed with PSLA-g-PEG and (PSLA-g-PEG)-b-PLLA using the TIPS procedure described in Example 1.

### Surface Morphologies and Mechanical Properties of the TIPS Films

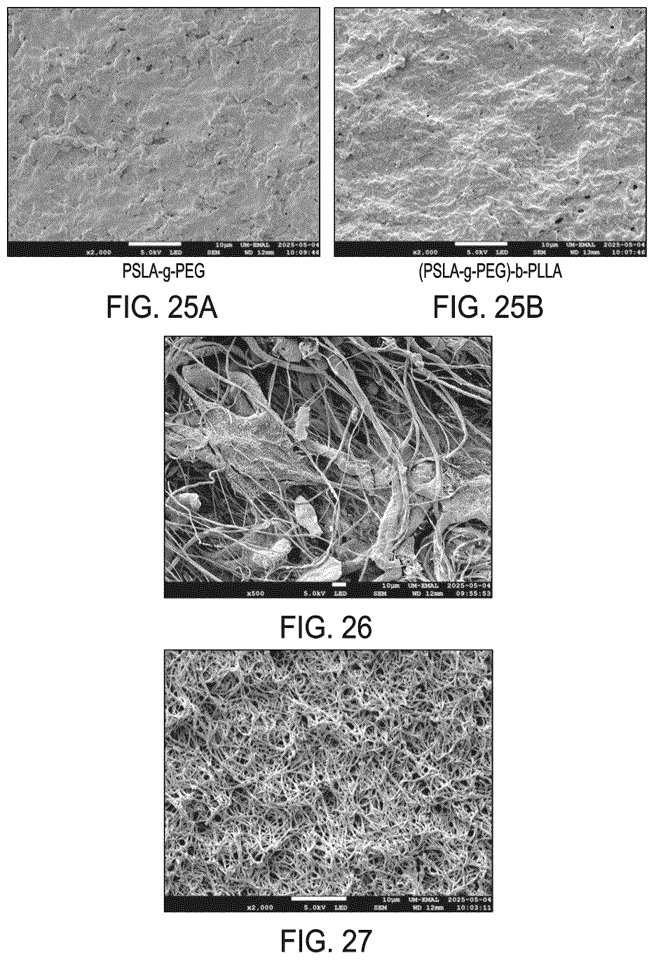

SEM images of the TIPS films fabricated from PSLA-g-PEG and (PSLA-g-PEG)-b-PLLA were taken, and are shown in FIG. 25A and FIG. 25B, respectively. The introduction of the PEG segments altered the surface morphology after TIPS was performed to either smooth or nanofibrous depending on the amount of PEG. For the films shown in FIG. 25A and FIG. 25B, the PEG amount was high, which lead to a smooth surface instead of a nanofibrous surface.

The contact angle of the films was also tested. These results are shown in Table 12.

TABLE 12

| | Contact angle | Contact angle |
|---|---|---|
| Polymer | before grafting/° | after grafting/° |
| PSLA2080→PSLA-g-PEG | 103.7 ± 0.2 | 72.1 ± 0.5 |
| PSLA4060-b-PLLA→ | 94.5 ± 2.7 | 71.5 ± 0.7 |
| (PSLA-g-PEG)-b-PLLA | | |

Since PEG is a hydrophilic polymer, the copolymer grafted with PEG displayed a reduced contact angle.

The mechanical performance of the TIPS films derived from PSLA-g-PEG and (PSLA-g-PEG)-b-PLLA was tested and the results are presented in Table 13.

TABLE 13

| | | | | Ultimate |
|---|---|---|---|---|
| | | Modulus/ | Max | strength/ |
| Polymer | Type | MPa | elongation | MPa |
| PSLA-g-PEG | Graft | 349.1 ± | 17.3% ± | 12.4 ± |
| | copolymer | 21.0 | 7.2% | 5.6 |
| (PSLA-g- | Graft | 1211.7 ± | 4.0% ± | 40.4 ± |
| PEG)-b-PLLA | copolymer | 22.0 | 0.6% | 1.5 |

The PEG-grafted PSLA copolymer had a max elongation of 17.3%, while the PEG-grafted diblock copolymer PSLA-b-PLLA had a maximum elongation of 4.0% with a high modulus of 1.21 GPa. The large range of mechanical properties indicates that grafting to PSLA-containing copolymers is a viable strategy for customization in tissue engineering applications.

### Example 7

### Synthesis of Star-Shaped Copolymers

Star-shaped-PCL was used as a core for star-shaped copolymer. The star-shaped PCL was synthesized by a Tin(II) 2-ethylhexanoate catalyzed ring-opening polymerization of caprolactone with a 16-arm PAMAM as initiator. The PSLA block was added by using a 2:8 weight ratio of Spiro-la and L-lactide monomers at 12 times the total weight of the star-shaped PCL. The monomers and star-shaped-PCL were incorporated into a 10 wt % DCM solution with 0.1 mol % TBD as a catalyst. The reaction was carried out at −80° C. for about 48 hours, followed by the purification procedure set forth in Example 1. This process formed ss-PCL-b-PSLA.

The PLLA block was added by using L-lactide at 16 times the total weight of the ss-PCL-b-PSLA. The L-lactide and ss-PCL-b-PSLA were incorporated into a 10 wt % DCM solution with 0.1 mol % TBD as the catalyst. The reaction is carried out at −80° C. for about 48 hours, followed by purification procedure set forth in Example 1. This process formed ss-PCL-b-PSLA-b-PLLA. The total molecular weight of the ssPCL-b-PSLA was 35,000, while the total molecular weight of the produced ssPCL-b-PSLA-b-PLLA was 498,000.

### Electrospinning to Form Fibrous Tubular Scaffolds

ssPCL-b-PSLA-b-PLLA was dissolved in DCM to reach a concentration of 10 wt %. The solution was extruded from a 10 ml syringe with an 18-gauge nozzle at a speed of 1 ml per minute. A 3-mm-diameter steel rod on a 120-rpm rotor was used as a collector, where the collector-nozzle distance was 5 cm and the voltage in between was 20 kV. After 5 minutes of extrusion, the fiber-coated steel rod was retrieved and dried in a fume hood for about 12 hours. The coated fibrous layer was cut and removed from the rod to acquire the tubular scaffold.

### Surface Morphologies and Mechanical Properties of the Tubular Scaffolds

A SEM image of the tubular scaffold fabricated from ssPCL-b-PSLA-b-PLLA was taken, and is in FIG. 26. The electrospun fibers of the ss-PCL-b-PSLA-b-PLLA tubular scaffold displayed distinct surface morphologies from the tubular scaffolds formed with the block or graft copolymers. The morphology of the ss-PCL-b-PSLA-b-PLLA tubular scaffold was neither smooth with pores nor rough with pores, but rather was a combination of rough fibers and porous sheets.

The mechanical performance of the tubular scaffold fabricated from ss-PCL-b-PSLA-b-PLLA was tested and the results are shown in Table 14.

TABLE 14

| | | | | | | Conjugation |
|---|---|---|---|---|---|---|
| | | | Max | Burst | Compliance/% | density/nmol |
| Polymer | Type | Modulus/MPa | elongation | pressure/mmHg | per 100 mmHg | per mg |
| SsPCL-b- | Star- | 17.8 ± 2.5 | 85% ± 13% | 6276 ± 930 | 5.3 ± 1.3 | 10.2 ± 0.7 |
| PSLA2080(35k)- | shaped | | | | | |
| b-PLLA (total | copolymer | | | | | |
| Mw = 494k) | | | | | | |

The electrospun tubular scaffold of ss-PCL-b-PSLA-b-PLLA was significantly different than the electrospun tubular scaffolds of the triblock copolymer, PCL-b-PSLA-b-PLLA. The 6373 mmHg burst pressure of the ss-PCL-b-PSLA-b-PLLA tubular scaffold was much lower than any of the PCL-b-PSLA-b-PLLA tubular scaffolds. The ss-PCL-b-PSLA-b-PLLA tubular scaffold exhibited a high compliance of 5.3% per 100 mmHg, which was near the high end of the compliance range exhibited by the PCL-b-PSLA-b-PLLA tubular scaffolds.

### Films Formed Via Thermally Induced Phase Separation (TIPS)

Nanofibrous films were formed with PSLA-g-PEG and (PSLA-g-PEG)-b-PLLA using the TIPS procedure described in Example 1.

### Surface Morphologies and Mechanical Properties of the TIPS Films

A SEM image of the ss-PCL-b-PSLA-b-PLLA TIPS film was taken, and is shown in FIG. 27. As depicted, the surface morphology of the ss-PCL-b-PSLA-b-PLLA TIPS film was nanofibrous, which was similar to that of the films formed, vis TIPS, with the linear block copolymers.

The mechanical performance of the TIPS films derived from PSLA-g-PEG and (PSLA-g-PEG)-b-PLLA was tested and the results are presented in Table 15.

TABLE 15

| | | | Max | Ultimate |
|---|---|---|---|---|
| Polymer | Type | Modulus/MPa | elongation | strength/MPa |
| SsPCL-b- | Star- | 73.3 ± | 33.6% ± | 3.0 ± |
| PSLA2080(35k)- | shaped | 10.9 | 2.6% | 0.8 |
| b-PLLA (total | copolymer | | | |
| Mw = 494k) | | | | |

TIPS Films made of ss-PCL-b-PSLA-b-PLLA had a relatively lower modulus (73.3 MPa) and higher elongation (33.6%) than the block and graft copolymers.

### Peptide Conjugation of Examples 5 and 7

The peptide conjugation ability of the tubular scaffolds formed with the various block copolymers is shown in Table 8 and the peptide conjugation ability of the tubular scaffold formed with the star-shaped copolymer is shown in Table 14. The peptide conjugation ability was measured as described in Example 1. The deblock and triblock copolymers exhibited a similar trend, where the increased Spiro-la ratio increased the peptide conjugation ability. The introduction of the PCL block reduced peptide conjugation as none of the triblock PCL-b-PSLA-b-PLLA tubular scaffolds reached the same level as the diblock tubular scaffolds PSLA-b-PLLA.

For the star-shaped triblock copolymer, ssPCL-b-PSLA-b-PLLA, tubular scaffold, the use of low spiro-la ratio (in PSLA2080) yielded a similar conjugation ability as the PSLA4060 or PSLA6040 in the triblock copolymer tubular scaffolds. The structure of star-shaped copolymer may have exposed more of the existing functional groups.

### Example 8

In this example, heparin modified with cysteine was attached to PCL(137k)-b-PSLA2080(178k)-b-PLLA(551k) (Example 5) and PSLA4060(258k)-b-PLLA(361k) (Example 5). The attachment was performed in an emulsion of 10 wt % copolymer/DCM solution and an equal volume of heparin/1% PVA solution with equal weight of heparin and copolymer. IRGACURE® 2959 was dissolved in the PVA solution as a photo-initiator. The reaction was carried out under UV while stirring for 30 minutes. The DCM was then evaporated, and the aqueous solution was washed with MilliQ water three times, followed by freeze drying. The resulting powder of the heparin modified copolymers was exposed to the electrospinning process as described in Example 5 to generate heparin modified electrospun tubes or to the TIPS process as described in Example 5 to generate heparin modified films.

The contact angle of a control PCL(137k)-b-PSLA2080(178k)-b-PLLA(551k) TIPS film (from Example 5) and the heparin modified PCL(137k)-b-PSLA2080(178k)-b-PLLA(551k) TIPS film was tested. These results are shown in Table 16.

TABLE 16

| | Contact angle: | Contact angle: |
|---|---|---|
| Polymer | Control/° | heparin-modified/° |
| PCL-b-PSLA-b-PLLA | 105.5 ± 2.1 | 89.3 ± 0.2 |

The heparin modification increased the surface hydrophilicity of the TIPS film.

A degradation study was performed as described in Example 1 using several electrospun tubes: PLLA without modification; PSLA4060(258k)-b-PLLA(361k) without modification; PSLA4060(258k)-b-PLLA(361k) with heparin modification; PCL(137k)-b-PSLA2080(178k)-b-PLLA(551k) without modification; and PCL(137k)-b-PSLA2080(178k)-b-PLLA(551k) with heparin modification. The results are shown in Table 17.

TABLE 17

| | | Electrospun tube |
|---|---|---|
| | | weight loss |
| Polymer | Modification | (2 weeks) |
| PLLA | NA | 2.8% |
| PSLA-b-PLLA | NA | 21.9% |
| PSLA-b-PLLA | heparin | 44.2% |
| PCL-b-PSLA-b-PLLA | NA | 10.1% |
| PCL-b-PSLA-b-PLLA | heparin | 11.7% |

These results indicate that the heparin modification increased the degradation speed, with the greatest increase observed for the heparin modified diblock copolymer PSLA4060(258k)-b-PLLA(361k). The variation in the degradation results suggests that the copolymer can be designed for a particular degradation speed according to the application, e.g., vascular scaffolds.

The results in this example illustrate that heparin conjugation can increase surface hydrophilicity and enhance the degradation rate of the tubular scaffold, thereby improving its performance as a biodegradable scaffold for vascular tissue engineering.

### Example 10

In this example, nanofibrous hollow microspheres (HMS or NF-HMS) were prepared with the diblock copolymer, PSLA4060(258k)-b-PLLA(361k). PSLA4060(258k)-b-PLLA(361k) was dissolved in THF at 60° C. to reach a concentration of 2 wt %. A 100 ml beaker was used to hold 15 ml of PSLA-b-PLLA solution, and a mechanical shaker (IKA RW 16 Basic Overhead Mixer) was used to stir the solution at a speed of 6. Glycerol—preheated at 60° C. with a volume of 45 ml—was added gradually to the beaker (containing the PSLA-b-PLLA solution) under stirring over 10 seconds, and stirring was maintained for 10 more seconds afterwards. The solution was then quickly poured into a 1 L beaker with 200 mL of liquid nitrogen and held for 10 minutes. Ice was then added to fill the beaker, and the beaker was placed at room temperature overnight with magnetic stirring. The resulting HMS suspension was sieved using 30-micron and 60-micron sieves to control the HMS diameter.

Peptides were conjugated to the HMS to observe osteochondral defect regeneration in a rat temporomandibular joint. DDR2 peptides or TGF-beta1 peptides were conjugated on the HMS scaffold using a click reaction to form DDR2P-NF-HMS or TGFB1P-NF-HMS. More specifically, the HMS were added to a beaker at a concentration of 4 million/ml and a volume of 0.25 ml. A 0.4 ml of the respective peptide solution (with a concentration between 0.1 mg/ml and 10 mg/ml), and 0.65 ml of a 1 wt % IRGACURE® 2959/methanol solution were added to the microspheres. The solution was placed under a UV lamp for 15 minutes. After the reaction, the suspension was collected by centrifuging at 200 g relative centrifugal force for 3 minutes and removing the supernatant. A PBS solution of 50 ml was used to wash each million HMS three times, each time followed by centrifuging and supernatant removal.

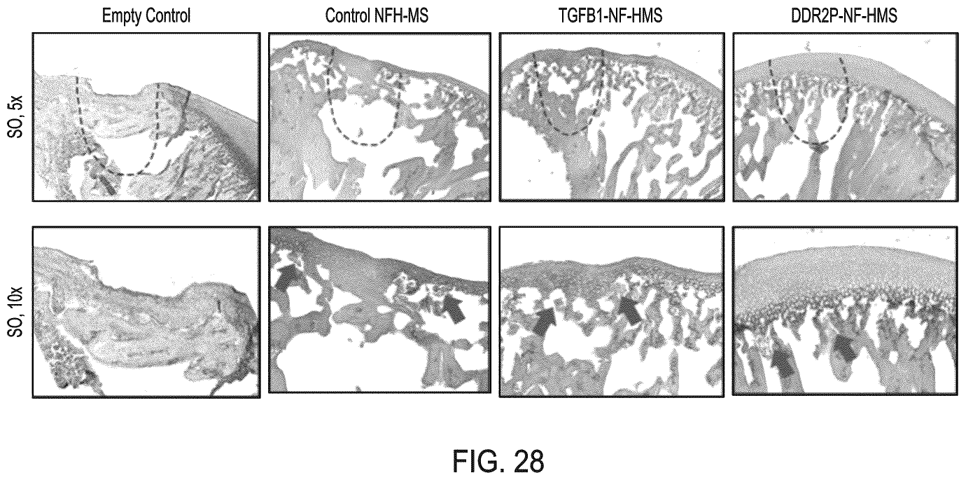

A critical-sized full-thickness rat TMJ condyle defects were created (3 mm in diameter and 4 mm in depth). The DDR2P-NF-HMS, TGFB1P-NF-HMS, and the control HMS (no conjugation) were respectively injected into the defects. An empty control had nothing injected therein. The specimens were collected 2 months later to examine the TMJ condyle tissue regeneration. Safranin-O/fast green staining was performed on the regenerated fibrocartilage. The results are reproduced, in black and white, in FIG. 28.

Dashed lines in the low magnification images in FIG. 28 indicate positions of originally created defects. Arrows point to incompletely degraded scaffold particles in the high magnification images in FIG. 28. These results illustrate that 1) the empty defect did not repair (with only fibrous scar tissue) and is a critical size defect, 2) the control HMS resulted in some fibrocartilage repair but was at the lowest level among the three scaffold groups; 3) either DDR2P-NF-HMS or TGFB1P-NF-HMS improved fibrocartilage repair over the control HMS, and 4) DDR2P-NF-HMS resulted in clearly the best fibrocartilage regeneration outcome among the 3 scaffold groups in terms of neo fibrocartilage thickness, cell morphology, and tissue organization.

### Example 11

Two-layer tubular scaffolds were fabricated using a two-step procedure. The first layer can be fabricated using a mold with a center rod and fructose spheres as a porogen. The fructose spheres were added into the mold and dried. The mold was then be removed, leaving the rod and the partially annealed sugar spheres exposed. The structure was then soaked in a PSLA4060(258k)-b-PLLA(361k)/THF solution and exposed to the TIPS procedure described in Example 1. After TIPS, the structure was soaked in hexane to wash away the THF. The resulting polymer-fructose-rod structure was then used as the collector for electrospun PSLA4060(258k)-b-PLLA(361k). The electrospinning process was performed as described in Example 5. After the electrospinning, the structure was washed with DI water to remove the porogen, and the rod was extracted.

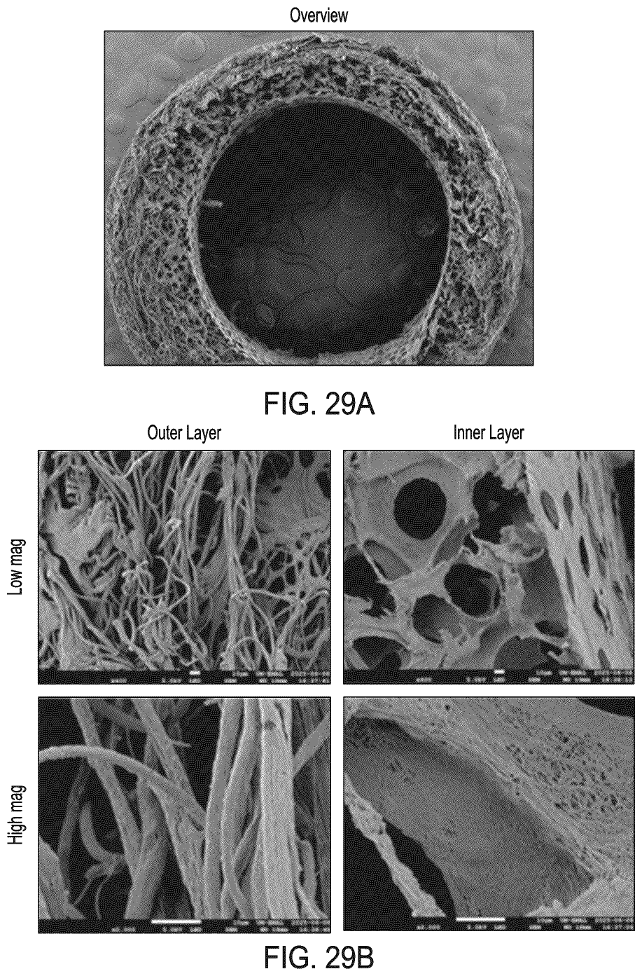

SEM images were taken, and are shown in FIG. 29A (overview) and FIG. 29B (low and high magnification images of the outer and inner layers). As depicted, this procedure yielded a two-layer tube, with electrospun fibers in the outer layer and porous nanofibrous surface in the inner layer.

Certain aspects of the apparatus disclosed herein are expressed in the following clauses. The present disclosure is not intended to be limited to such clauses, unless expressly recited in the claims.
Clause 1. A block copolymer, comprising: a first block including a random copolymer of a first monomer:

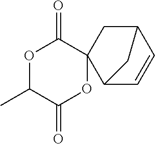

and a second monomer; and a second block including a homopolymer of a third monomer or a second random copolymer, wherein the third monomer is any monomer other than the first monomer or the second random copolymer is any random copolymer other than the random copolymer of the first block.
Clause 2. The block copolymer as defined in clause 1, further comprising a third block including a second homopolymer of a fourth monomer, wherein the fourth monomer is any monomer other than the first monomer.
Clause 3. The block copolymer as defined in clause 2, wherein: the second block is poly(caprolactone); and the third block comprises a polylactide selected from the group consisting of poly(L-lactide), poly(D-lactide), and stereocomplexes thereof.
Clause 4. The block copolymer as defined in clause 1, wherein: the second monomer is L-lactide; and the second block is crystalline or semi-crystalline, and is selected from the group consisting of poly(L-lactide), poly(D-lactide), poly(ε-caprolactone), poly(glycerol sebacate), poly(glycolic acid), poly(3-hydroxybutyrate), poly(3-hydroxyvalerate), poly(ethylene terephthalate), mixtures thereof, and copolymers thereof.
Clause 5. The block copolymer as defined in clause 1 or clause 4, wherein a weight ratio of the first monomer to the second monomer in the first block ranges from 1:99 to 99:1.
Clause 6. The block copolymer as defined in one of clause 1, clause 4, or clause 5, further comprising a homopolymer chain grafted to the first block, wherein one of: the homopolymer chain is a biodegradable polymer selected from the group consisting of poly(L-lactide), polyglycolic acid, poly(D, L-lactide), polyanhydrides, poly(ortho ethers), poly(ε-caprolactone), poly(glycerol sebacate), poly(hydroxy butyrate), poly(propylene fumarate), polyphosphoesters, polyphosphazenes, polycarbonates, polyurethane, (polytrimethylene carbonate), collagen, gelatin, elastin, alginate, chitin, chitosan, and pectin, or the homopolymer chain is a non-degradable polymer selected from the group consisting of polyethylene glycol, polyvinyl alcohol, polyethylene terephthalate, polystyrene, a silicone polymer, a polyurethane, polyetherether ketone, a polyamide, and polycarbonate.
Clause 7. A composition, comprising: a structure selected from the group consisting of a scaffold, a film, and a microsphere, wherein the structure is at least partially composed of the block copolymer of one of clause 1 through clause 6.
Clause 8. The composition as defined in clause 7, further comprising a biologically functional molecule attached to the random copolymer of the block copolymer.
Clause 9. A medical device, comprising: a core structure; and a coating positioned on at least a portion of the core structure, wherein the coating is composed of the block copolymer of one of clause 1 through clause 6.
Clause 10. The medical device as defined in clause 9, further comprising a biologically functional molecule attached to the random copolymer of the block copolymer.
Clause 11. A graft copolymer, comprising: a main chain; and at least one side chain covalently attached to the main chain, wherein at least one of the main chain or the side chain includes a random copolymer of a first monomer

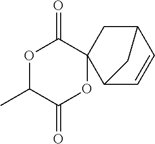

and a second monomer that is different than the first monomer.
Clause 12. The graft copolymer as defined in clause 11, wherein: the main chain is a homopolymer; and the side chain is the random copolymer or a block copolymer including the random copolymer as one block.
Clause 13. The graft copolymer as defined in clause 11, wherein: the main chain is the random copolymer or a block copolymer including the random copolymer as one block; and the side chain is a polymer selected from the group consisting of a homopolymer, a copolymer, and a mixture of homopolymer and copolymer.
Clause 14. The graft copolymer as defined in clause 11, wherein: the main chain is a block copolymer including the random copolymer as one block; and the side chain is selected from the group consisting of polyhydroxyalkanoates, poly(L-lactide), poly(D, L-lactide), poly(glycerol sebacate), polyglycolic acid), poly(ε-caprolactone), poly(3-hydroxybutyrate), poly(3-hydroxyvalerate), poly(propylene fumarate), polyphosphoesters, polyphosphazenes, polycarbonates, polyethylene glycol, polyvinyl alcohol, polyurethanes, polyanhydrides, poly(ortho ethers), collagen, gelatin, elastin, alginate, chitin, chitosan, and pectin.
Clause 15. A composition, comprising: a structure selected from the group consisting of a scaffold, a film, and a microsphere, wherein the structure is at least partially composed of the graft copolymer of one of clause 11 through clause 14.
Clause 16. The composition as defined in clause 15, further comprising a biologically functional molecule attached to the random copolymer of the graft copolymer.
Clause 17. A medical device, comprising: a core structure; and a coating positioned on at least a portion of the core structure, wherein the coating is composed of the graft copolymer of one of clause 11 through clause 14.
Clause 18. The medical device as defined in clause 17, further comprising a biologically functional molecule attached to the random copolymer of the graft copolymer.
Clause 19. A star-shaped copolymer, comprising: a core having from 2 to 128 polymerization initiating functional groups; and arms extending from at least some of the polymerization initiating functional groups, the arms including a random copolymer of a first monomer:

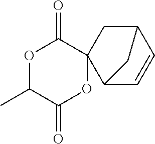

and a second monomer that is different from the first monomer.
Clause 20. The star-shaped copolymer as defined in clause 19, wherein the core is selected from the group consisting of pentaerythritol, N,N,N′,N′-tetra(2,3-dihydroxpropyl)ethane-1,2-diamine, a poly(amidoamine) dendrimer, and a hyperbranched aliphatic polyester.
Clause 21. The star-shaped copolymer as defined in one of clause 19 or clause 20, wherein the arms include a block copolymer, wherein the block copolymer includes, in any order, the random copolymer as one block and a homopolymer or another random copolymer as another block.
Clause 22. The star-shaped copolymer as defined in one of clause 19 through clause 21, further comprising a homopolymer attached to the random copolymer in each of the arms.
Clause 23. The star-shaped copolymer as defined in clause 22, wherein: the core is a poly(amidoamine) dendrimer modified with caprolactone; and the homopolymer is poly(L-lactic acid).
Clause 24. A composition, comprising: a structure selected from the group consisting of a scaffold, a film, and a microsphere, wherein the structure is at least partially composed of the star-shaped copolymer of any of clause 19 through clause 23.
Clause 25. The composition as defined in clause 24, further comprising a biologically functional molecule attached to the random copolymer of the star-shaped copolymer.
Clause 26. A medical device, comprising: a core structure; and a coating positioned on at least a portion of the core structure, wherein the coating is composed of the star-shaped copolymer of any of clause 19 through clause 23.
Clause 27. The medical device as defined in clause 26, further comprising a biologically functional molecule attached to the random copolymer of the star-shaped copolymer.
Clause 28. A method, comprising: incorporating a random copolymer including a first monomer:

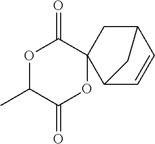

and a second monomer into a block copolymer or a graft copolymer or a star-shaped copolymer.
Clause 29. The method as defined in clause 28, wherein: prior to incorporating the random copolymer into the block copolymer, the random copolymer is formed via cold polymerization between the first monomer and the second monomer; and incorporating the random copolymer into the block copolymer involves polymerizing a third monomer in the presence of the random copolymer.
Clause 30. The method as defined in clause 29, further comprising grafting at least one additional side chain to the random copolymer.
Clause 31. The method as defined in clause 28, wherein incorporating the random copolymer into the graft copolymer involves one of: i) covalently linking a main chain and a side chain, wherein the main chain includes the random copolymer and the side chain is selected from the group consisting of a polymer containing one or more thiol groups per structural unit, a synthetic polymer with a terminal thiol group, a natural compound with thiol functionality or a thiol-modified derivative, a peptide including at least one cysteine residue, a polypeptide including at least one cysteine residue, a thiol-containing compound, an inorganic compound with a thiol group, and an organosilane compound with a thiol group; or ii) performing cold polymerization of the first and second monomers in the presence of a hydroxyl-group-containing polymer, thereby growing side chains of the random copolymer from activation sites of the hydroxyl-group-containing polymer; or iii) initiating polymerization of a third monomer at a double bond of the random copolymer.
Clause 32. The method as defined in clause 28, wherein incorporating the random copolymer into the star-shaped copolymer involves copolymerizing the first monomer and the second monomer in the presence of a star-shaped initiator or a star-shaped polymer.
Clause 33. The method as defined in any of clause 28 through clause 32, further comprising electrospinning the block copolymer, the graft copolymer, or the star-shaped copolymer.
Clause 34. A tubular scaffold, comprising: an inner layer having a nanofibrous and porous structure; a hollow portion defined by the inner layer; and an outer layer positioned on the inner layer, the outer layer including electrospun fibers; wherein at least one of the inner layer and the outer layer is formed of the block copolymer of clause 1, the graft copolymer of clause 11, or the star-shaped copolymer of clause 28.

The PSM2 copolymers disclosed herein satisfy multiple criteria for tissue engineering with tunable mechanical properties, degradation rate, and conjugation densities. They can be utilized to impart specific biomolecular signals and mechanical properties potentially for various other tissue engineering applications.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range, as if such value or sub-range were explicitly recited. For example, a range from about 1 nm to about 1000 nm should be interpreted to include not only the explicitly recited limits of from about 1 nm to about 1000 nm, but also to include individual values, such as 25 nm, 34.5 nm, 68 nm, etc., and sub-ranges, such as from about 30 nm to about 65 nm, from about 50 nm to about 85 nm, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A block copolymer, comprising:
a first block including a random copolymer of a first monomer: 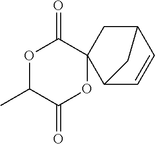
and a second monomer; and
a second block including a homopolymer of a third monomer or a second random copolymer, wherein the third monomer is any monomer other than the first monomer or the second random copolymer is any random copolymer other than the random copolymer of the first block.

2. The block copolymer as defined in claim 1, further comprising a third block including a second homopolymer of a fourth monomer, wherein the fourth monomer is any monomer other than the first monomer.

3. The block copolymer as defined in claim 1, wherein a weight ratio of the first monomer to the second monomer in the first block ranges from 1:99 to 99:1.

4. The block copolymer as defined in claim 1, further comprising a homopolymer chain grafted to the first block, wherein one of:
the homopolymer chain is a biodegradable polymer selected from the group consisting of poly(L-lactide), polyglycolic acid, poly(D, L-lactide), polyanhydrides, poly(ortho ethers), poly(ε-caprolactone), poly(glycerol sebacate), poly(hydroxy butyrate), poly(propylene fumarate), polyphosphoesters, polyphosphazenes, polycarbonates, polyurethane, poly(trimethylene carbonate), collagen, gelatin, elastin, alginate, chitin, chitosan, and pectin; or
the homopolymer chain is a non-degradable polymer selected from the group consisting of polyethylene glycol, polyvinyl alcohol, polyethylene terephthalate, polystyrene, a silicone polymer, a polyurethane, polyetherether ketone, a polyamide, and polycarbonate.

5. A composition, comprising:
a structure selected from the group consisting of a scaffold, a film, and a microsphere, wherein the structure is at least partially composed of the block copolymer of claim 1.

6. The composition as defined in claim 5, further comprising a biologically functional molecule attached to the random copolymer of the block copolymer.

7. A medical device, comprising:
a core structure; and
a coating positioned on at least a portion of the core structure, wherein the coating is composed of the block copolymer of claim 1.

8. A graft copolymer, comprising:
a main chain; and
at least one side chain covalently attached to the main chain,
wherein at least one of the main chain or the side chain includes a random copolymer of a first monomer 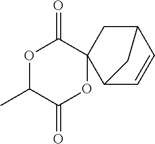
and a second monomer that is different than the first monomer.

9. The graft copolymer as defined in claim 8, wherein:
the main chain is a homopolymer; and
the side chain is the random copolymer or a block copolymer including the random copolymer as one block.

10. The graft copolymer as defined in claim 8, wherein:
the main chain is the random copolymer or a block copolymer including the random copolymer as one block; and
the side chain is a polymer selected from the group consisting of a homopolymer, a copolymer, and a mixture of homopolymer and copolymer.

11. The graft copolymer as defined in claim 8, wherein:
the main chain is a block copolymer including the random copolymer as one block; and
the side chain is selected from the group consisting of polyhydroxyalkanoates, poly(L-lactide), poly(D, L-lactide), poly(glycerol sebacate), polyglycolic acid), poly(ε-caprolactone), poly(3-hydroxybutyrate), poly(3-hydroxyvalerate), poly(propylene fumarate), polyphosphoesters, polyphosphazenes, polycarbonates, polyethylene glycol, polyvinyl alcohol, polyurethanes, polyanhydrides, poly(ortho ethers), collagen, gelatin, elastin, alginate, chitin, chitosan, and pectin.

12. A composition, comprising:
a structure selected from the group consisting of a scaffold, a film, and a microsphere, wherein the structure is at least partially composed of the graft copolymer of claim 8.

13. The composition as defined in claim 12, further comprising a biologically functional molecule attached to the random copolymer of the graft copolymer.

14. A medical device, comprising:
a core structure; and
a coating positioned on at least a portion of the core structure, wherein the coating is composed of the graft copolymer of claim 8.

15. A star-shaped copolymer, comprising:
a core having from 2 to 128 polymerization initiating functional groups; and
arms extending from at least some of the polymerization initiating functional groups, the arms including a random copolymer of a first monomer: 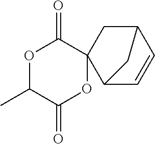
and a second monomer that is different from the first monomer.

16. The star-shaped copolymer as defined in claim 15, wherein the core is selected from the group consisting of pentaerythritol, N,N,N′,N′-tetra(2,3-dihydroxpropyl)ethane-1,2-diamine, a poly(amidoamine) dendrimer, and a hyperbranched aliphatic polyester.

17. The star-shaped copolymer as defined in claim 15, wherein the arms include a block copolymer, wherein the block copolymer includes, in any order, the random copolymer as one block and a homopolymer or another random copolymer as another block.

18. A composition, comprising:
a structure selected from the group consisting of a scaffold, a film, and a microsphere, wherein the structure is at least partially composed of the star-shaped copolymer of claim 15.

19. The composition as defined in claim 18, further comprising a biologically functional molecule attached to the random copolymer of the star-shaped copolymer.

20. A medical device, comprising:
a core structure; and
a coating positioned on at least a portion of the core structure, wherein the coating is composed of the star-shaped copolymer of claim 15.

21. A method, comprising:
incorporating a random copolymer including a first monomer: 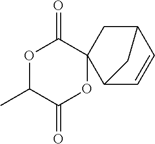
and a second monomer into a block copolymer or a graft copolymer or a star-shaped copolymer.

22. The method as defined in claim 21, wherein:
prior to incorporating the random copolymer into the block copolymer, the random copolymer is formed via cold polymerization between the first monomer and the second monomer; and
incorporating the random copolymer into the block copolymer involves polymerizing a third monomer in the presence of the random copolymer.

23. The method as defined in claim 21, wherein incorporating the random copolymer into the graft copolymer involves one of:
i) covalently linking a main chain and a side chain, wherein the main chain includes the random copolymer and the side chain is selected from the group consisting of a polymer containing one or more thiol groups per structural unit, a synthetic polymer with a terminal thiol group, a natural compound with thiol functionality or a thiol-modified derivative, a peptide including at least one cysteine residue, a polypeptide including at least one cysteine residue, a thiol-containing compound, an inorganic compound with a thiol group, and an organosilane compound with a thiol group; or
ii) performing cold polymerization of the first and second monomers in the presence of a hydroxyl-group-containing polymer, thereby growing side chains of the random copolymer from activation sites of the hydroxyl-group-containing polymer; or
iii) initiating polymerization of a third monomer at a double bond of the random copolymer.

24. The method as defined in claim 21, wherein incorporating the random copolymer into the star-shaped copolymer involves copolymerizing the first monomer and the second monomer in the presence of a star-shaped initiator or a star-shaped polymer.

25. The method as defined in claim 21, further comprising electrospinning the block copolymer, the graft copolymer, or the star-shaped copolymer.
